(19) United States
(12) Patent Application Publication
(10) Pub. No.: US 2025/0352948 A1
(43) Pub. Date: Nov. 20, 2025

(54) SOLVENT-BASED PROCESSES FOR FUNCTIONALIZED MATERIALS

(71) Applicant: X Development LLC, Mountain View, CA (US)

(72) Inventors: Chaokun Gong, Sunnyvale, CA (US); Jeremy Aaron Willman, Redwood City, CA (US); Zoanne Zweber, San Francisco, CA (US); Jacques Gagne, Los Gatos, CA (US)

(21) Appl. No.: 19/209,691

(22) Filed: May 15, 2025

Related U.S. Application Data
(60) Provisional application No. 63/648,102, filed on May 15, 2024.

(51) Int. Cl. B01D 53/62; B01D 53/81; B01J 20/26; B01J 20/28; B01J 20/32

(52) U.S. Cl. CPC B01D 53/62; B01D 53/81; B01J 20/265; B01J 20/28004; B01J 20/28016; B01J 20/28061; B01J 20/28071; B01J 20/28073; B01J 20/28076; B01J 20/28085; B01J 20/3204; B01J 20/3219; B01J 20/327; B01J 20/3272; B01J 20/3293; B01D 2253/202; B01D 2257/504; B01D 2258/06

(57) ABSTRACT

Methods of producing functionalized materials are provided. Porous particles are introduced to a functionalization mixture including a volatile solvent. The functionalization mixture includes an adsorbing moiety including polyethylenimine, an interaction moiety including a silane moiety, a polymer, a crosslinking agent, a chelating agent, or an antioxidant. Porous particles are characterized by a porosity distribution between 100 and 200 nanometers and a diameter distribution between 0.8 and 3 millimeters. Functionalized particles are created through deposition of the functionalization mixture on a surface of a porous particle to form a surface modification layer. Compositions and functionalized materials are also provided.

### CROSS REFERENCE TO RELATED PATENT APPLICATIONS

This application claims priority to U.S. Provisional Patent Application No. 63/648,102, entitled “SOLVENT-BASED PROCESSES FOR FUNCTIONALIZED MATERIALS,” filed May 15, 2024, which is hereby incorporated by reference.

### FIELD OF THE DISCLOSURE

The disclosure relates to a functionalized material, which may optionally be employed as a sorbent, as well as methods of making such materials and systems of using such materials. The processes, methods, and systems herein can be used for the separation of carbon dioxide from fluid streams.

### BACKGROUND

Atmospheric carbon concentrations have risen in correlation with industrialized activity for decades. Carbon dioxide is a primary contributor to the total carbon concentration. Concern over global climate warming has led to interest in capturing carbon dioxide emissions.

### SUMMARY

In general, the disclosure relates to functionalized materials, method of making and using thereof, and systems that can be configured to use such materials. In particular embodiments, the functionalized material can be used to capture and remove carbon dioxide from gaseous environments. In some embodiments, the functionalized material can exhibit lifetime improvement. In some embodiments, the functionalized material can include an oxygen barrier, a linking moiety (e.g., provided by way of a crosslinking agent), a chelating agent, an antioxidant, or a combination of any of these.

The functionalized material may be formed by a solvent-based process. In some embodiments, the process includes the use of one or more volatile solvents (e.g., to prepare a functionalization mixture, which in turn can be used to form a functionalized material). Introducing the functionalization mixture to a particle may include: mixing the one or more reagents in at least one volatile solvent form a mixture and then spraying the mixture on at least a portion of the surface of at least one of the plurality of porous particles.

One aspect disclosed herein is a method including: introducing a plurality of porous particles to a functionalization mixture comprising at least one volatile solvent, where the functionalization mixture comprises one or more reagents. In some embodiments, the one or more reagents is selected from the group consisting of: a first reagent comprising at least one adsorbing moiety, a second reagent comprising at least one interaction moiety, and a third reagent comprising one or more of a polymer, a crosslinking agent, a chelating agent, and an antioxidant. In some embodiments, the at least one adsorbing moiety comprises polyethylenimine. In some embodiments, the at least one interaction moiety comprises a silane moiety. In some embodiments, the method further includes creating a plurality of functionalized particles through deposition of the functionalization mixture on at least a portion of a surface of at least one porous particle in the plurality of porous particles to form a surface modification layer on the surface of the at least one porous particle in the plurality of porous particles. In some embodiments, the plurality of porous particles is characterized by (i) a distribution of porosities within a range of between 100 nanometers and 200 nanometers, and (ii) a distribution of diameters within a range of between 0.8 millimeters and 3 millimeters.

Another aspect of the present disclosure provides a functionalized material comprising a plurality of porous particles. In some embodiments, the functionalized material further includes a surface modification layer disposed on at least a portion of a surface of the at least one porous particle. In some embodiments, the surface modification layer comprises at least one adsorbing moiety, at least one interaction moiety, a polymer, a crosslinking agent, a chelating agent, or an antioxidant. In some embodiments, the at least one adsorbing moiety comprises polyethylenimine, and the at least one interaction moiety comprises a silane moiety. In some embodiments, the material adsorbs atmospheric CO₂ under a first condition and reversibly desorbs adsorbed CO₂ under a second condition. In some embodiments, the functionalized material has a methanol emission threshold of less than 0.5% (wt/wt) of methanol to the plurality of functionalized particles. Alternatively or additionally, in some embodiments, the functionalized material has a hydration threshold of less than 10% (wt/wt) of water to the plurality of functionalized particles. In some embodiments, the plurality of porous particles is characterized by (i) a distribution of porosities within a range of between 100 nanometers and 200 nanometers, and (ii) a distribution of diameters within a range of between 0.8 millimeters and 3 millimeters.

Particular implementations of the subject matter described in this specification can be implemented so as to realize one or more of the following technical advantages.

One method of making the functionalized sorbent is using a solvent-based, batch processes at an industrial scale for reducing the cost of production, preserving the functionality of the sorbent material, and reducing the environmental impact of the product.

The details of one or more embodiments are set forth in the accompanying drawings and the description below. Other features and advantages will be apparent from the description and drawings, and from the claims.

As used herein, the terms “top,” “bottom,” “upper,” “lower,” “above,” and “below” are used to provide a relative relationship between structures. The use of these terms does not indicate or require that a particular structure must be located at a particular location in the apparatus.

### DESCRIPTION OF DRAWINGS

FIGS. 1A-IG are non-limiting schematic illustrations of a functionalized material, in accordance with some embodiments of the present disclosure. Provided are functionalized materials having (A) a functional group 106A, (B) a functional group 106B, (C) a functional group 106C, (D) a functional group 106D, (E) a functional group 106E, (F) a functional group 106F, and (G) a functional group 106G.

FIGS. 2A-2K are chemical illustrations of non-limiting, exemplary compounds, amine moieties, and silane moieties, in accordance with some embodiments of the present disclosure. Provided are illustrations of (A) an aminosilane compound 206, (B, C) non-limiting amine moieties, (D-G) non-limiting aminosilane compounds, and (H-K) non-limiting polyamine compounds.

FIGS. 2L-M are chemical illustrations of non-limiting, exemplary crosslinking agents, in accordance with some embodiments of the present disclosure. Provided are illustrations of (L) a dihaloalkane or (M) an epoxide compound.

FIGS. 3A-3D are non-limiting flow chart diagrams showing the steps of producing a functionalized material, in accordance with some embodiments of the present disclosure.

FIGS. 4A-4B are schematic illustrations of (A) an example dip-coating method using a double cone mixing and drying system and (B) an example drying method using a double cone mixing and drying system, in accordance with some embodiments of the present disclosure.

FIG. 5 is a schematic illustration of an example Nutsche filter mixing/filtration/drying system for producing functionalized particles from particles, in accordance with some embodiments of the present disclosure.

FIG. 6 is a schematic illustration of an example bag dip-coating system for producing functionalized particles from particles, in accordance with some embodiments of the present disclosure.

FIG. 7 is a schematic illustration of an example paddle dryer for producing functionalized particles from particles, in accordance with some embodiments of the present disclosure.

FIG. 8 is a schematic illustration of an example ribbon dryer for producing functionalized particles from particles, in accordance with some embodiments of the present disclosure.

FIGS. 9A-9B are schematic illustrations of (A) an example drying method using a conveyor dryer and (B) operation of an example drying method in continuous mode, in accordance with some embodiments of the present disclosure.

FIGS. 10A-10B are schematic illustrations of (A) an exploded view and an assembled view of a non-limiting sample holder for testing sample CO₂ adsorption and (B) a non-limiting experimental setup for testing sample adsorption of CO₂, in accordance with some embodiments of the present disclosure.

FIGS. 11A-11B are schematic illustrations of non-limiting, exemplary implementations of a carbon dioxide extraction system, in accordance with some embodiments of the present disclosure.

FIG. 12 is a schematic illustration of a non-limiting, exemplary implementation of an integrated power and carbon dioxide extraction system, in accordance with some embodiments of the present disclosure.

FIG. 13 is a line chart depicting CO₂ uptake over a plurality of cycles by a non-limiting functionalized material including a silica substrate, in accordance with some embodiments of the present disclosure. Provided are the testing cycle number (x-axis) and uptake at each cycle (y-axis).

In the figures, like references indicate like elements.

### DETAILED DESCRIPTION

Amorphous silica is used as a porous structure for functionalization to achieve carbon capture. In some embodiments, silica substrates with amine functionalization, e.g., one or more amine-containing groups covalently bonded on surfaces, achieve reversible capture of carbon dioxide from gaseous mixtures (e.g., the atmosphere). In some embodiments, other porous substrates are employed (e.g., MOFs, resins, or any described herein) to provide a functionalized material (e.g., a functionalized porous material) that has been functionalized with an adsorbing moiety (e.g., an amine moiety provided by a compound, such as an amine, an aminosilane, a polyamine, a monoamine, or a combination thereof). In certain embodiments, the functionalized material can be used as a sorbent.

Described herein is a functionalized material (e.g., a functionalized porous material) that has been functionalized with an adsorbing moiety (e.g., an amine moiety provided by a compound, such as an amine, an aminosilane, a polyamine, a monoamine, or a combination thereof). In some embodiments, functionalization further comprises an interaction moiety (e.g., a silane moiety provided by a compound, such as a silane, an aminosilane, and the like). Such moieties (e.g., amine moieties and/or silane moieties) can be provided any compound and any useful combination of two or more compounds (e.g., one or more of amines, aminosilanes, polyamines, monoamines, or any combination of any of these).

One aspect of the present disclosure provides a functionalized material comprising a plurality of porous particles. In some embodiments, the functionalized material further includes a surface modification layer disposed on at least a portion of a surface of the at least one porous particle. In some embodiments, the surface modification layer comprises at least one adsorbing moiety, at least one interaction moiety, a polymer, a crosslinking agent, a chelating agent, or an antioxidant. In some embodiments, the at least one adsorbing moiety comprises polyethylenimine, and the at least one interaction moiety comprises a silane moiety. In some embodiments, the material adsorbs atmospheric CO₂ under a first condition and reversibly desorbs adsorbed CO₂ under a second condition. In some embodiments, the functionalized material has a methanol emission threshold of less than 0.5% (wt/wt) of methanol to the plurality of functionalized particles. Alternatively or additionally, in some embodiments, the functionalized material has a hydration threshold of less than 10% (wt/wt) of water to the plurality of functionalized particles.

One aspect disclosed herein is a method including: introducing a plurality of porous particles to a functionalization mixture comprising at least one volatile solvent, where the functionalization mixture comprises one or more reagents. In some embodiments, the one or more reagents is selected from the group consisting of: a first reagent comprising at least one adsorbing moiety, a second reagent comprising at least one interaction moiety, and a third reagent comprising one or more of a polymer, a crosslinking agent, a chelating agent, and an antioxidant. In some embodiments, the at least one adsorbing moiety comprises polyethylenimine. In some embodiments, the at least one interaction moiety comprises a silane moiety. In some embodiments, the method further includes creating a plurality of functionalized particles through deposition of the functionalization mixture on at least a portion of a surface of at least one porous particle in the plurality of porous particles to form a surface modification layer on the surface of the at least one porous particle in the plurality of porous particles.

In some embodiments, the plurality of porous particles is characterized by (i) a distribution of porosities within a range of between 100 nanometers and 200 nanometers, and (ii) a distribution of diameters within a range of between 0.8 millimeters and 3 millimeters. In some embodiments, other ranges of porosities and/or diameter are contemplated, as disclosed elsewhere herein (see, for example, the section entitled “Substrate,” below).

One or more adsorbing moieties and/or interaction moieties can be provided by way of a functionalization mixture. The functionalization mixture can have any useful combination of reagents to provide adsorbing moieties and/or interaction moieties. In addition to reagents, the functionalization mixture can include one or more solvents. In some embodiments, the one or more solvents include a volatile solvent or a mixture including at least one volatile solvents (e.g., two, three, four, or more volatile solvents).

As used herein, the term “volatile solvent” refers to any liquid or mixture of liquids capable of readily evaporating under target conditions due to its vapor pressure and/or boiling point. In some embodiments, and without being limited to any one theory of operation, a volatile solvent evaporates under ambient or controlled conditions due to its relatively high vapor pressure and/or low boiling point. In some embodiments, a volatile solvent exhibits a vapor pressure greater than about 0.3 kilopascals (kPa) at 20° C. and/or a boiling point less than about 150° C. at atmospheric pressure. In some embodiments, a volatile solvent exhibits a vapor pressure greater than approximately 0.1 kPa, greater than approximately 0.5 kPa, greater than approximately 1 kPa, or greater than approximately 5 kPa at 20° C., 25° C., or 40° C. In some embodiments, a volatile solvent exhibits a vapor pressure of no more than 10 kPa, no more than 5 kPa, or no more than 1 kPa at 20° C., 25° C., or 40° C. In some embodiments, a volatile solvent exhibits a vapor pressure of from 0.1 to 2 kPa, from 1 to 5 kPa, or from 3 to 10 kPa at 20° C., 25° C., or 40° C. In some embodiments, a volatile solvent exhibits a vapor pressure that falls between another range no lower than 0.1 kPa and ending no higher than 10 kPa at 20° C., 25° C., or 40° C. In some embodiments, a volatile solvent exhibits a vapor pressure greater than approximately 1.3 kPa at 25° C., or greater than approximately 5.0 kPa at 40° C. Alternatively or additionally, in some embodiments, a volatile solvent comprises a boiling point less than approximately 150° C. at 1 atmosphere (101.3 kPa), less than approximately 120° C. at 80 kPa, or less than approximately 90° C. at 50 kPa. In some embodiments, a solvent is volatile if it facilitates significant evaporation over a practical time scale during use, such as drying or curing within 5 to 60 minutes under ambient or elevated temperature conditions (e.g., 20-80° C.).

In some embodiments, volatile solvents include single-component or multi-component systems and are selected based on their physicochemical properties in combination with the intended application. Examples include, but are not limited to, alcohols (e.g., methanol, ethanol, isopropanol), ketones (e.g., acetone, methyl ethyl ketone, methyl isobutyl ketone), ethers (e.g., diethyl ether, tetrahydrofuran), esters (e.g., ethyl acetate, butyl acetate), aliphatic hydrocarbons (e.g., hexane, heptane), aromatic hydrocarbons (e.g., toluene, xylene), halogenated solvents (e.g., dichloromethane, chloroform), and low molecular weight siloxanes (e.g., octamethylcyclotetrasiloxane). In some embodiments, the classification of a solvent as “volatile” depends on one or both of its evaporation characteristics and its functional role in a given formulation, such as facilitating uniform film formation, solubilizing active components, or controlling drying time.

Any useful volatile solvent can be employed. In some embodiments, the volatile solvent is a non-aqueous solvent, a polar organic solvent, or a non-polar organic solvent. In some embodiments, the volatile solvent has a boiling point from about 30° C. to about 100° C. (e.g., at standard pressure, such as 1 atm or 100 kPa). In some embodiments, the volatile solvent has a vapor pressure from about 1.5 kPa to about 65 kPa (e.g., at standard temperature, such as 20° C. or 25° C.).

In some embodiments, the volatile solvent is an alcohol (e.g., having an aliphatic group and one or more hydroxyl groups). In some embodiments, the alcohol is an optionally substituted C₁₋₆, C₁₋₅, C₁₋₄, C₁₋₃, or C₁₋₂ alcohol that may be linear or branched, optionally cyclic, and/or saturated or unsaturated, in which optional substituents can be any described herein for alkyl. Non-limiting examples of alcohols include methanol, ethanol, 1-propanol, isopropanol, 1-butanol, 2-butanol, isobutanol, tert-butanol, 1-pentanol, 2-methylbutan-1-ol, 3-methylbutan-1-ol, 2,2-dimethylpropan-1-ol, 2-pentanol, 3-methylbutan-2-ol, 3-pentanol, 2-methylbutan-2-ol, or a combination of any of these. In some embodiments, the alcohol is an alkenol (e.g., including an alkenyl group and having one or more hydroxyl groups, such as an optionally substituted C2-6, C₂₋₅, C₂₋₄, C₂₋₃, or C₂₋₂ alcohol that may be linear or branched and optionally cyclic, in which optional substituents can be any described herein for alkyl). In some embodiments, the alcohol is acetone, ether, ethyl acetate, methyl acetate, or tetrahydrofuran (THF).

In some embodiments, the volatile solvent is an alkane. In some embodiments, the alkane is an optionally substituted C₁₋₁₂, C₁₋₁₁, C₁₋₁₀, C₁₋₉, C₁₋₈, C₁₋₇, C₁₋₆, C₁₋₅, C₁₋₄, C₁₋₃, or C₁₋₂ alkane that may be linear or branched, and optionally cyclic, in which optional substituents can be any described herein for alkyl. Non-limiting examples of alkanes include n-butane, isobutane (methylpropane), n-pentane, cyclopentane, 2-methtylbutane, 2,2-dimethylpropane, n-hexane, cyclohexane, 2-methylpentane, 3-methylpentane, 2,3-dimethylbutane, 2,2-dimethylbutane, n-heptane, cyclopentane, 2-methylhexane, 3-methylhexane, 2,2-dimethylpentane, 2,3-dimethylpentane, 2,4-dimethylpentane, 3,3-dimethylpentane, 3-ethylpentane, 2,2,3-trimethylbutane, n-octane, cyclooctane, 2-methylheptane, 3-methylheptane, 4-methylheptane, 3-ethylhexane, 2,2-dimethylhexane, 2,3-dimethylhexane, 2,4-dimethylhexane, 2,5-dimethylhexane, 3,3-dimethylhexane, 3,4-dimethylhexane, 3-ethyl-2-methylpentane, 3-ethyl-3-methylpentane, 2,2,3-trimethylpentane, 2,2,4-trimethylpentane, 2,3,3-trimethylpentane, 2,3,4-trimethylpentane, 2,2,3,3-tetramethylbutane, stereoisomers thereof, or a combination of any of these.

In some embodiments, the volatile solvent is an aliphatic hydrocarbon. Non-limiting examples of aliphatic hydrocarbon include alkanes (e.g., an optionally substituted C₁₋₁₂, C₁₋₁₁, C₁₋₁₀, C₁₋₉, C₁₋₈, C₁₋₇, C₁₋₆, C₁₋₅, C₁₋₄, C₁₋₃, or C₁₋₂ alkane that may be linear or branched, and optionally cyclic, in which optional substituents can be any described herein for alkyl; such as n-pentane, n-hexane, cyclohexane, heptane, and the like), alkene (e.g., an optionally substituted C₂₋₁₂, C₂₋₁₁, C₂₋₁₀, C₂₋₉, C₂₋₈, C₂₋₇, C₂₋₆, C₂₋₅, C₂₋₄, or C₂₋₃ alkene that may be linear or branched, and optionally cyclic, in which optional substituents can be any described herein for alkyl; such as ethylene and the like), alkynes (e.g., an optionally substituted C₂₋₁₂, C₂₋₁₁, C₂₋₁₀, C₂₋₉, C₂₋₈, C₂₋₇, C₂₋₆, C₂₋₈, C₂₋₄, or C₂₋₃ alkyne that may be linear or branched, and optionally cyclic, in which optional substituents can be any described herein for alkyl; such as acetylene and the like), aromatics (e.g., an optionally substituted C₅₋₁₂, C₅₋₁₁, C₅₋₁₀, C₅₋₉, C₅₋₈, C₅₋₇, or C₅₋₆ aromatic that may be linear or branched, and optionally cyclic, in which optional substituents can be any described herein for alkyl; such as benzene, toluene, and the like), and the like.

In some embodiments, the volatile solvent comprises a solvent mixture. In some embodiments, the solvent mixture includes two or more volatile solvents (e.g., three, four, or more volatile solvents). In some embodiments, the solvent mixture includes a first volatile solvent (e.g., any described herein) and a second volatile solvent (e.g., any described herein), in which the first and second volatile solvents are different. In some embodiments, the solvent mixture includes at least one alcohol (e.g., any described herein) and at least one alkane (e.g., any described herein). Any useful ratio of first and second volatile solvents can be present. In some embodiments, the solvent mixture is from about 10:1 to about 1:10 of a first volatile solvent (e.g., any described herein) to a second volatile solvent (e.g., any described herein). In some embodiments, the solvent mixture includes a ratio from about 10:1 to about 1:10 of an alcohol (e.g., any described herein) to an aliphatic hydrocarbon (e.g., any described herein). Without wishing to be limited by mechanism or theory, a volatile solvent can be employed to extend physical lifetime (e.g., by using a volatile solvent that can be removed without excessive mechanical agitation, thereby preserving the structural integrity of the porous structure for the porous particles). A volatile solvent may shorten the drying time and thereby lower the energy cost to remove the solvent mixture from the porous particles. In some embodiments, a volatile solvent can be recycled for additional uses reducing the environmental impact of the porous particles. The polarity of the volatile solvent facilitates introducing the amines into the pores of porous particles thereby reducing the overall reaction times and may increase the adsorption capacity of the functionalized porous particles. In an example embodiment, a solvent mixture including hexane and TPA can introduce the amines into the pores more efficiently due to the polarity of solvent mixture as compared to an aqueous solvent mixture.

In some embodiments, the plurality of porous particles is introduced to the functionalization mixture at a ratio in a range from 1:1 to 1:5 (wt/wt) of the porous particles to the functionalization mixture.

In some embodiments, a functionalization mixture further includes one or more reagents to enhance lifetime improvement. For example and without limitation, in some embodiments, to enhance lifetime improvement, the adsorbing moiety and/or the interaction moiety is crosslinked by use of a crosslinking agent and/or is protected from oxidation by use of an oxygen barrier (e.g., provided by way of a polymer coating), an antioxidant, a chelating agent, or a combination of any of these. In some embodiments, any one or more of these reagents are present in the functionalization mixture.

Further embodiments for solvents and/or reagents, including but not limited to antioxidants, crosslinkers, chelators, and/or polymer coatings, contemplated for use in the present disclosure are further disclosed below and in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

### I. Example Functionalized Materials

The present disclosure relates to a functionalized material having one or more functional groups. For example and without limitation, an initial material or substrate can be functionalized to include one or more functional groups (e.g., one or more amine groups) configured to capture carbon dioxide (CO₂). As used herein and without limitation, a monofunctional molecule possesses one functional group (e.g., one reactive group), and a multivalent molecule possesses a plurality of functional groups (e.g., a plurality of reactive groups). In some embodiments, the multivalent molecule can include a difunctional (e.g., or bifunctional) molecule possessing two functional groups (e.g., two reactive groups), a trifunctional molecule possessing three functional groups (e.g., three reactive groups), and so forth. In some non-limiting embodiments, the material can have any useful structure (e.g., as a particle), any useful substructure (e.g., one or more pores), and any useful composition (e.g., silica or others described herein). In some non-limiting embodiments, amorphous silica is used as a porous substrate for functionalization to achieve carbon capture. Silica substrates with amine functionalization, e.g., one or more amine-containing moieties covalently bonded on a surface, may achieve reversible capture of carbon dioxide from gaseous mixtures (e.g., the atmosphere). Other substrates and moieties are also described herein, which can provide functionalized material for carbon capture.

Disclosed herein is a functionalized material (e.g., functionalized porous silica) having a surface modification layer (e.g., provided by use of at least one volatile solvent) and methods of producing such materials. Also disclosed herein is a functionalized material including any useful moiety in the surface modification layer (e.g., an adsorbing moiety, an interaction moiety, a linking moiety, or combinations of these) and/or including a protective polymer coating (e.g., as an oxygen barrier). In turn, the functionalized material can be used for reversibly capturing (e.g., adsorbing) carbon dioxide (CO₂). In use, the functionalized material can be provided in any useful format (e.g., as a layer of beads or powder) over or through which gaseous mixtures including CO₂ are flowed. Gas exiting the layer of functionalized material has a lower concentration of CO₂ than the entering gas. During carbon capture adsorption and desorption processes, the functionalized material can experience mechanical attrition through handling, use, and transport through the capture and regeneration processes. Providing a protective polymer coating on the functionalized material can decrease friability and attrition of the sorbents, leading to longer product life and reduced production of fines. Furthermore, when the protective polymer coating also serves as an oxygen barrier, then the functionalized material can have an extended chemical lifetime due to reduced oxidation by oxygen or other oxidative species.

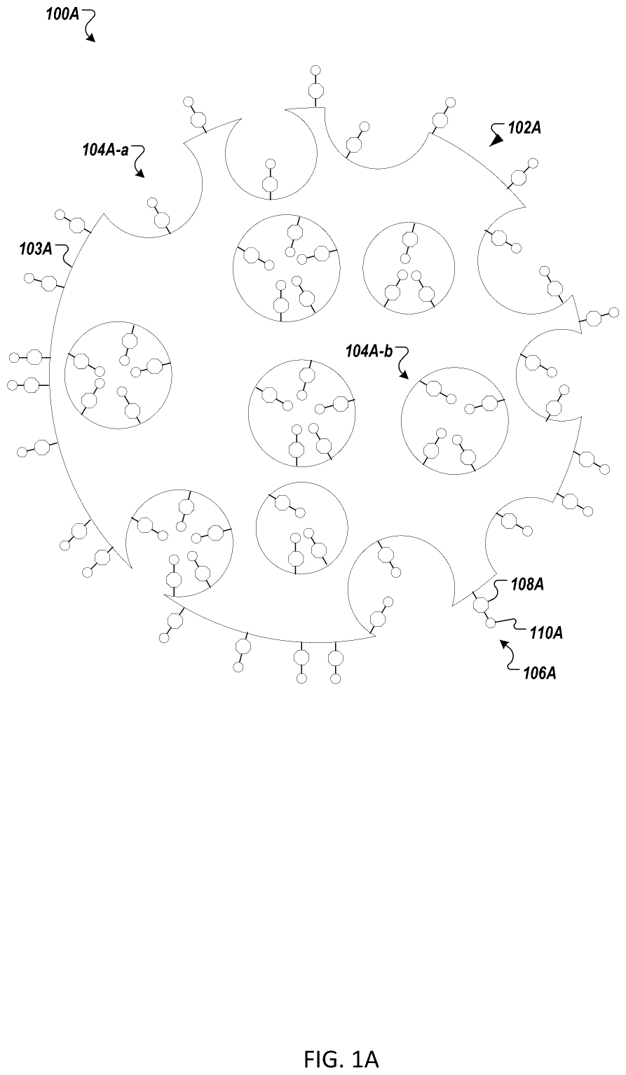

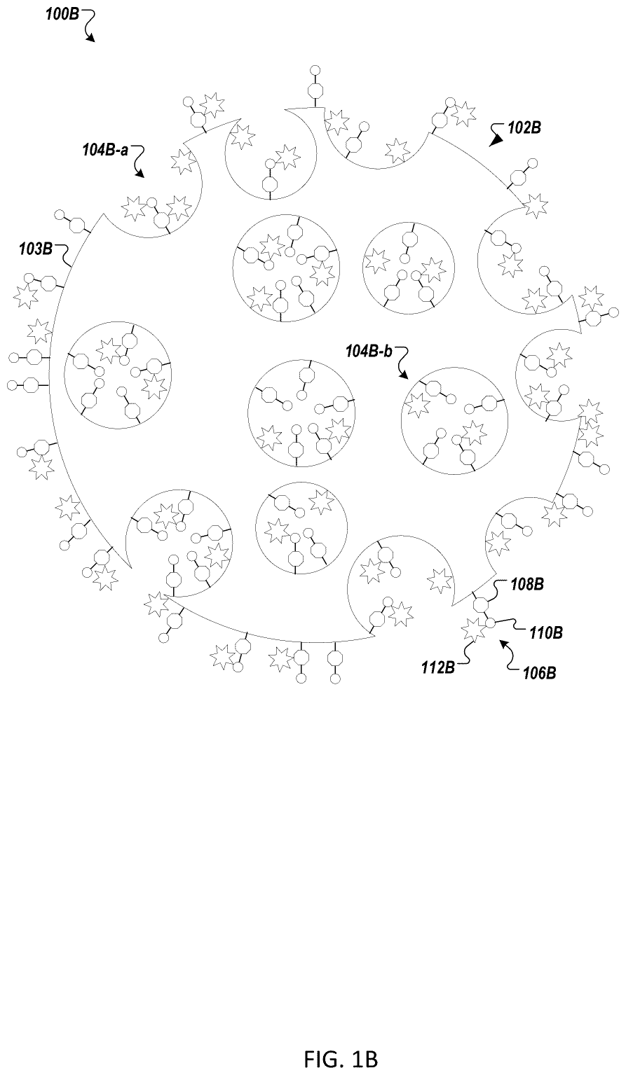

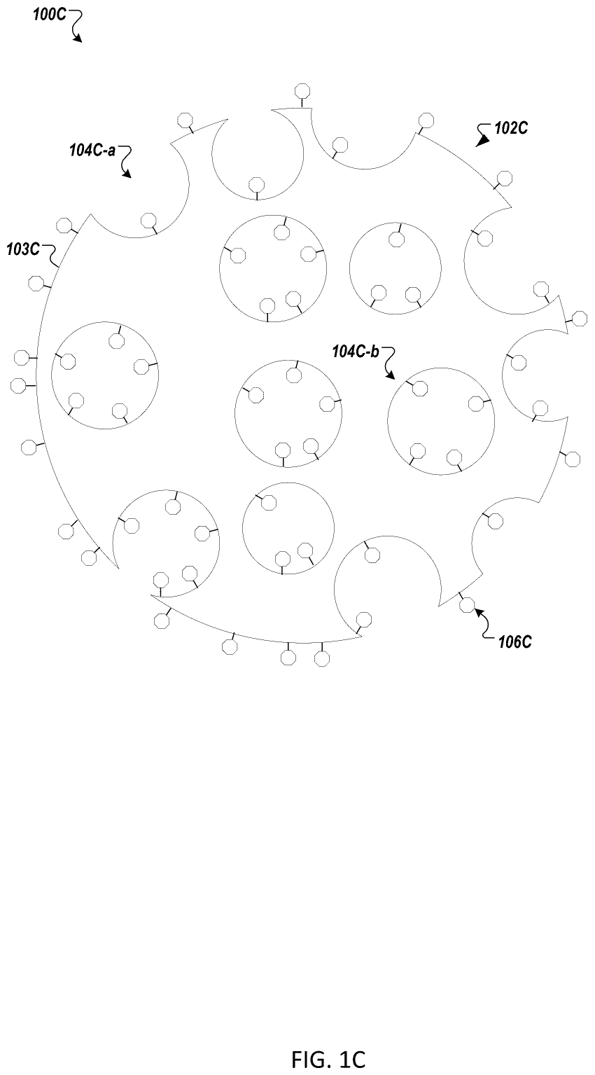

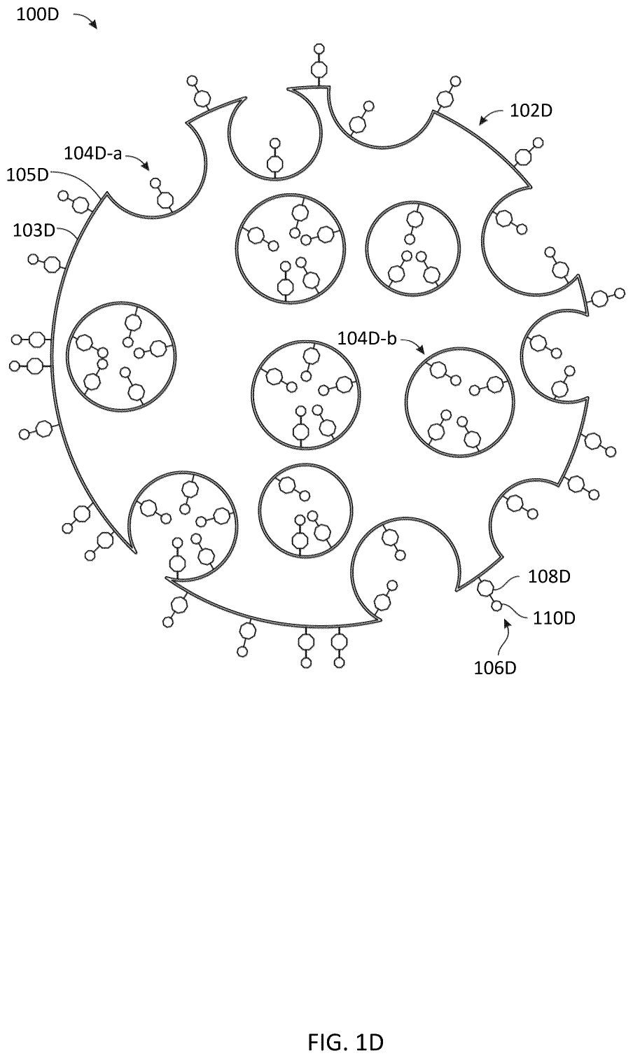

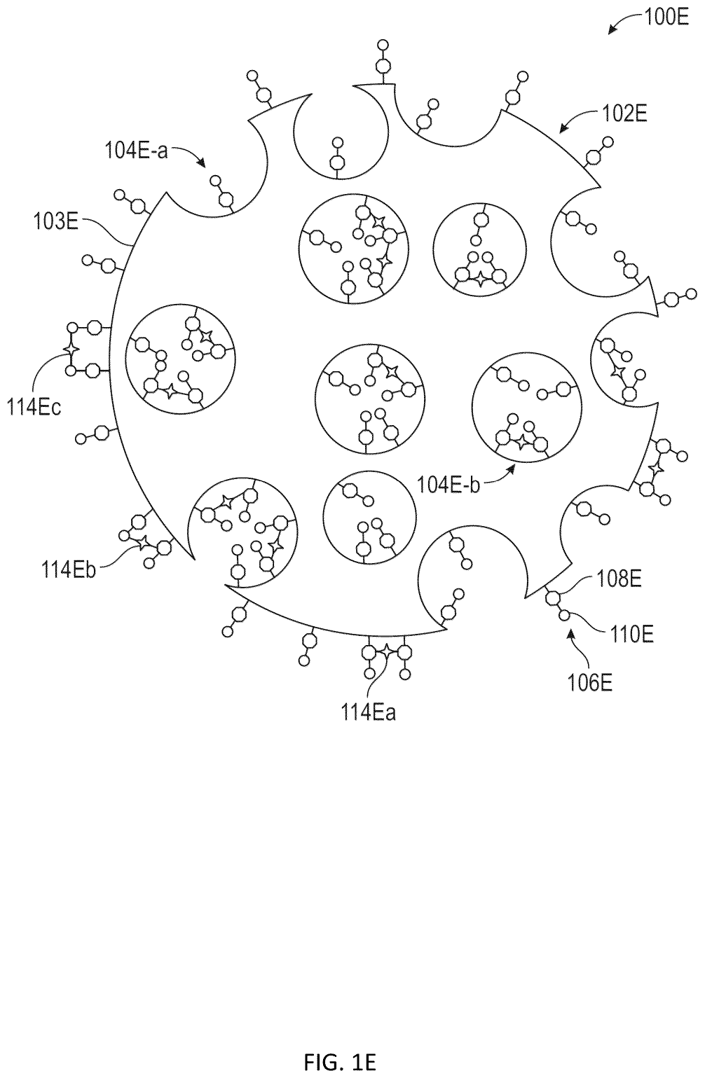

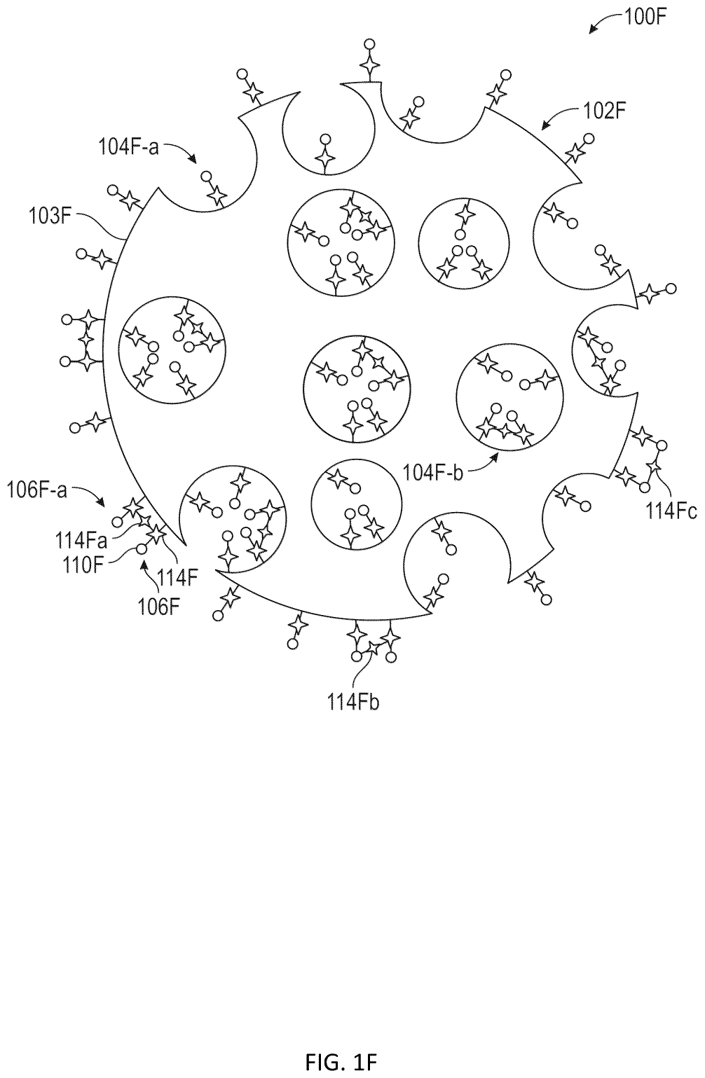

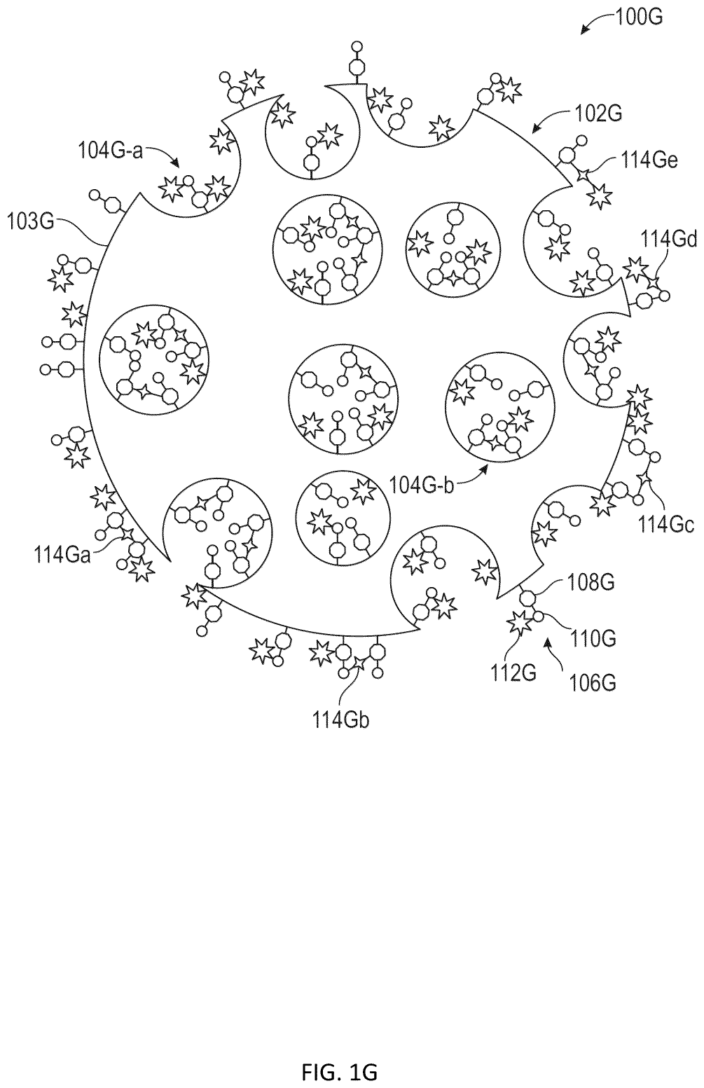

For example, FIG. 1A provides a non-limiting functionalized material 100A including a substrate 102A having a plurality of pores 104A-a, 104A-b. In turn, surface 103A of the substrate 102A includes a functional portion 106A that in turn includes, in some embodiments, an adsorbing moiety 110A (e.g., a CO₂ adsorbing moiety) and an interaction moiety 108A (e.g., a silane-containing interaction moiety). In some embodiments, the functional portion 106A further includes other moieties, groups, or molecules to provide an adsorbing material for use as a sorbent. In some embodiments, such moieties, groups, or molecules include an amine group (e.g., —NR^{N1}R^{N2}, as described herein, which present in the form of amines, aminosilanes, polyamines, and the like), polymers (e.g., hydrophobic polymers or polyamines), antioxidants, and the like. Furthermore, in some embodiments, such moieties, groups, or molecules form interactions (e.g., covalent and/or non-covalent interactions) between themselves or between itself and the substrate surface.

In some embodiments a surface modification layer is disposed on at least a portion of the surface 103A. The surface modification layer includes an adsorbing moiety having one or more amine moieties (e.g., any described herein). As illustrated in FIG. 1A, in some embodiments, the surface modification layer includes any useful combination of an adsorbing moiety 110A (e.g., a CO₂ adsorbing moiety) and an interaction moiety 108A. In some embodiments, the material is configured to adsorb atmospheric CO₂ under a first condition and reversibly desorb adsorbed CO₂ under a second condition. In some embodiments, the surface modification layer is disposed in proximity to the surface 103A of the substrate 102A.

In some embodiments, the functional portion comprises any number of moieties to facilitate capture of CO₂. Furthermore, in some embodiments, such moieties are provided by any number of compounds. For example, FIG. 1B provides a non-limiting functionalized material 100B including a substrate 102B having a plurality of pores 104B-a, 104B-b. In turn, the surface 103B of the substrate 102B includes, in some embodiments, a functional portion 106B. In some embodiments, the functional portion 106B in turn includes a first adsorbing moiety 110B (e.g., a first CO₂ adsorbing moiety), a second adsorbing moiety 112B (e.g., a second CO₂ adsorbing moiety), and an interaction moiety 108B (e.g., a silane-containing interaction moiety).

In some embodiments, the moieties of the functionalized material are provided in any useful manner. In some embodiments, the substrate surface is functionalized by use of a first CO₂ adsorbing compound (e.g., including an aminosilane) and a second CO₂ adsorbing compound (e.g., a polyamine). In turn, in some embodiments, the first CO₂ adsorbing compound includes a first adsorbing moiety (e.g., moiety 110B in FIG. 1B), and the second CO₂ adsorbing compound includes a second adsorbing moiety (e.g., moiety 112B in FIG. 1B).

In some embodiments, when the first CO₂ adsorbing compound is an aminosilane, the aminosilane includes a silane moiety as a non-limiting interaction moiety (e.g., interaction moiety 108B in FIG. 1B) and an amine moiety as a non-limiting first adsorbing moiety (e.g., first adsorbing moiety 110B in FIG. 1B). In some embodiments, the aminosilane is covalently bonded to the exterior surface of the substrate (e.g., surface 102B in FIG. 1B) and within the pores (e.g., pores 104B-a, 104B-b in FIG. 1B). Other examples of adsorbing compounds include any compounds described herein (e.g., any aminosilanes or other compounds including one or more amine moieties). In some embodiments, together an aminosilane and a polyamine form a network and provide the stable CO₂ adsorbing function.

In some embodiments the second adsorbing moiety is provided by any useful second adsorbing compound. Examples of such adsorbing compounds include any compounds described herein (e.g., any compounds including one or more amine moieties). Any useful combination of second and first adsorbing compounds is employed in some embodiments, and such combinations of compounds interact in any useful manner to provide a functionalized network or coating disposed over a surface of a substrate. In turn, in some embodiments, such a network or coating are characterized by any useful combination of adsorbing moieties and interaction moieties.

In some embodiments, the second adsorbing moiety is provided with or without a second interaction moiety. In some embodiments, the second interaction moiety provides direct or indirect attachment to the substrate surface. For example and without limitation, in some embodiments, a polyamine include a plurality of amine moieties and at least one linker disposed between at least two amine moieties (e.g., -(R^{A}-L)ₙ-, in which R^{A} is an amine moiety, L is a linker, and n is an integer). In some embodiments, the amine moiety R^{A} acts as an adsorbing moiety. Depending on other components present in the functionalized material, either the amine moiety R^{A} or the linker L acts as an interaction moiety in some embodiments. For example, in some embodiments, the amine moiety R^{A} of a polyamine interact with other amine moieties or silane moieties by way of hydrogen bonding or ionic interactions.

In some embodiments, the second adsorbing compound is a polyamine that includes an amine moiety as a non-limiting second adsorbing moiety (e.g., second adsorbing moiety 112B in FIG. 1B). In some embodiments, the second adsorbing moiety is represented by a certain functional group (e.g., an amine group of —NR^{N1}R^{N2} or —NR^{N1}— as described herein) or a certain compound having certain functional groups (e.g., a compound including one or more amine groups of —NR^{N1}R^{N2} or —NR^{N1}— as described herein). Other examples of adsorbing compounds include any compounds described herein (e.g., any polyamines or other compounds including one, two, or more amine moieties).

In some embodiments, the second adsorbing moiety interacts with other functional groups, moieties, or compounds in the functionalization material in various ways. For example and without limitation, in some embodiments the second adsorbing moiety interacts with the first adsorbing moiety, the interaction moiety, the surface of the substrate, or another second adsorbing moiety. In some embodiments, such interactions include covalent and/or non-covalent bonding interactions (e.g., any described herein). In some embodiments, the second adsorbing moiety interacts with the first adsorbing moiety. In some embodiments, the second adsorbing moiety interacts with the interaction moiety.

In some embodiments, the second adsorbing moiety comprises a polyamine or amine moieties from a polyamine. In some embodiments, when the first adsorbing moiety is an aminosilane, the polyamine interacts with amine moieties of the aminosilane or interaction moieties of the aminosilane. In some embodiments, amine moieties of aminosilane and polyamine interact with silanol groups of aminosilane through hydrogen bonding and ionic interactions to form a functional group, thereby forming a complex network over the substrate surface. Using FIG. 1B as a reference, in some embodiments a functional group 106B includes amine moieties 110B of aminosilane and amine moieties 112B of polyamine that interact with silanol groups 108B of aminosilane.

FIG. 1C provides a non-limiting functionalized material 100C including a substrate 102C having a plurality of pores 104C-a, 104C-b, in accordance with some embodiments of the present disclosure. In turn, a surface 103C of the substrate 102C includes a functional portion 106C, which in turn includes at least one adsorbing moiety (e.g., a first CO₂ adsorbing moiety). In some embodiments, a plurality of adsorbing moieties is provided. For instance, a polyamine (e.g., such as polyethylenimine (PEI)) having a plurality of adsorbing moieties is reacted with the substrate. In some embodiments, the polyamine is characterized by a high interaction surface area that facilitates 1- or 2-D van der Waals interactions with the surfaces of the substrate. In some embodiments, the polyamine is introduced to the substrate and forms a surface modification layer for reversibly binding CO₂ from atmospheric gases. In some embodiments, a polyamine (e.g., PEI having a larger molecular weight such as, e.g., greater than about 800 Da or from about 800 Da to 1 MDa (or 1,000,000 Da)) is used (as compared to short chain amine functionalization). In some embodiments, and without being limited to any one theory of operation, the polyamine is less volatile compared to short chain amine functionalization.

Further embodiments for adsorbing moieties, including but not limited to polyamines and amine moieties, contemplated for use in the present disclosure are further disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

Using FIG. 1C as a reference, in some embodiments the functional group 106C includes a polyamine group. In some embodiments the polyamine group includes one or more primary, secondary, or tertiary amine groups; repeat units of ethylamine or propylamine; or more than one amine groups connected through various linkers (e.g., alkylene groups); or linear or branched polyamines. In some embodiments, the polyamine group has an increased interaction surface area compared to short chain amine-containing compounds due to the increased number of amine groups in the polymeric chain. In some embodiments, the polyamine group is bonded to the substrate 102C through van der Waals interactions, hydrogen bonding, and/or ionic interactions.

Using FIG. 1D as a reference, in some embodiments, a polymer coating 105D is disposed on the surface 103D having a plurality of pores 104D-a, 104D-b. In some embodiments, the polymer, or mixture of polymers, increases the mechanical characteristics of the functionalized material 100D. One example of the polymer which makes up the polymer coating is polyvinyl alcohol (PVA), a water-soluble synthetic polymer having the formula [CH2CH(OH)]n. PVA is readily available from commercial sources and has low toxicity for safe handling during application. In some embodiments, the PVA has a molecular weight (MW) in a range from 10,000 to 200,000 (e.g., in a range from 10,000 to 23,000). Further embodiments for polymer coatings contemplated for use in the present disclosure are further disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

In some embodiments, the polymer can be introduced (e.g., to a solvent, such as one or more volatile solvents) in a (wt/wt) percentage from about 1% to 20% (wt/wt) of the polymer to the substrate (e.g., from about 1% to 5%, 1% to 10%, 1% to 15%, 3% to 5%, 3% to 10%, 3% to 15%, 3% to 20%, 5% to 10%, 5% to 15%, 5% to 20%, 7% to 10%, 7% to 15%, 7% to 20%, 10% to 15%, 10% to 20%, 1 3% to 15%, 13% to 20%, or 15% to 20% (wt/wt)).

In some embodiments, the solvent medium includes at least one volatile solvent (e.g., any described herein, including two, three, four, or more volatile solvents). In some embodiments, the solvent medium includes an alcohol, an aliphatic hydrocarbon, an alkane, or a combination thereof (e.g., a combination of an alcohol and an alkane). In some embodiments, the solvent medium includes water. In some embodiments, the solvent medium includes an organic solvent selected from toluene, hexane, cyclohexane, and tetrahydrofuran. In some embodiments, the solvent medium includes methanol, cyclohexane, hexane, ethanol, water, or a combination thereof. In some embodiments, the solvent comprises isopropyl alcohol. In some embodiments, the solvent comprises one or more of: toluene, hexane, cyclohexane, and tetrahydrofuran, and one or more of: methanol, cyclohexane, hexane, ethanol, water, and isopropyl alcohol. In some embodiments, the solvent comprises hexane and isopropyl alcohol. In some embodiments, the solvent comprises any combination of one or more solvents disclosed herein, as will be apparent to one skilled in the art.

In some embodiments, the plurality of porous particles is introduced to the functionalization mixture comprising at least one volatile solvent in an amount (wt/wt percentage) of at least 1%, at least 2%, at least 3%, at least 5%, at least 8%, at least 10%, at least 12%, at least 15%, at least 18%, at least 20%, at least 25%, at least 30%, at least 40%, or at least 50% of porous particles to solvent. In some embodiments, the plurality of porous particles is introduced to the functionalization mixture comprising at least one volatile solvent in an amount (wt/wt percentage) of no more than 80%, no more than 50%, no more than 30%, no more than 20%, no more than 15%, no more than 10%, no more than 5%, or no more than 2% of porous particles to solvent. In some embodiments, the plurality of porous particles is introduced to the functionalization mixture comprising at least one volatile solvent in an amount (wt/wt percentage) of from 1% to 20%, from 1% to 8%, from 5% to 25%, from 10% to 20%, from 12% to 30%, from 25% to 50%, or from 40% to 80% of porous particles to solvent. In some embodiments, the plurality of porous particles is introduced to the functionalization mixture comprising at least one volatile solvent in an amount (wt/wt percentage) that falls within another range starting no lower than 1% and ending no higher than 80% of porous particles to solvent. For instance, Example 1 illustrates the plurality of porous particles introduced to the functionalization mixture in an amount of 4.85 g (80 mmol) of silica particles to 40 mL solvent.

In some implementations, the functionalized material includes one or more chelating agents. In some implementations, the functionalized material includes one or more antioxidants. Further embodiments for chelating agents and/or antioxidants contemplated for use in the present disclosure are further disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

As seen in FIG. 1E, in some embodiments, the surface modification layer includes a linking moiety 114E. In general and without limitation, in some embodiments, the linking moiety 114E forms interactions between one or more of the adsorbing moieties, the interaction moieties, the substrate, and/or a combination thereof. In the example of FIG. 1E, in some embodiments, the linking moiety 114Ea forms interactions between the interaction moieties 108E of multiple functional groups 106E, e.g., between the interaction moieties 108E that are each provided on two different functional groups 106E. In such examples, the linking moiety 114Ea is considered difunctional, e.g., comprising two interaction sites. In other examples, the linking moiety 114Eb forms interactions between the interaction moiety 108E and the adsorbing moiety 110E of multiple functional groups 106E, e.g., between the interaction moiety 108E of a first functional group and the adsorbing moiety 110E of a second functional group. In yet other examples, the linking moiety 114Ec forms interactions between the adsorbing moieties 110E of multiple functional groups 106E, e.g., between the adsorbing moieties 110E that are each provided on two different functional groups 106E. Further embodiments for adsorbing moieties contemplated for use in the present disclosure are further disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

In some embodiments, when a second adsorbing moiety is present, then linking moieties also interact with the second adsorbing moiety. As shown in FIG. 1G, in some embodiments, a portion of the functional groups 106G and/or second adsorbing moieties 112G are crosslinked by the linking moiety 114G. FIG. 1G illustrates the functional group 106G crosslinked to a functional group by a linking moiety 114Ga. In some examples, the linking moiety 114Ga forms interactions between the interaction moieties 108G of multiple functional groups 106G. In other examples, the linking moiety 114Gd forms interactions between the interaction moieties 108G and adsorbing moieties 110G of multiple functional groups 106G. In yet other examples, the linking moiety 114Gc forms interactions between adsorbing moieties 110G of multiple functional groups 106G. In other examples, the linking moiety 114Gd forms interactions between first adsorbing moieties 110G and second adsorbing moieties 112G. In yet other examples, the linking moiety 114Ge forms interactions between interaction moieties 108D and second adsorbing moieties 112G.

As also described herein, in some embodiments, the functional portion includes an interaction moiety that interacts with at least a portion of the surface of a substrate.

In use, in some embodiments, the functionalized material is provided as a layer (e.g., a layer of beads or powder) or a bed over which or through which a gaseous mixture including CO₂ is flowed. In some embodiments, such a material is considered a “sorbent” or “adsorbent,” in which these terms are used interchangeably unless otherwise specified. Gas exiting the sorbent has a lower concentration of CO₂ than the entering gas. In some embodiments, the functionalized material reversibly adsorbs CO₂ over a number of cycles, e.g., a number of adsorption and desorption steps, in which a cycle includes at least one adsorption step and at least one desorption step. In some embodiments, higher cycle counts are used to characterize materials having longer product lifetimes when used in CO₂ capture applications. In some non-limiting implementations, the functionalized material reversibly adsorbs CO₂ over 100 cycles (e.g., over 500 cycles, over 1000 cycles, over 2000 cycles, or over 3000 cycles). Here and throughout the specification, reference to a measurable value such as an amount, a temporal duration, and the like, the recitation of the value encompasses the precise value, approximately the value, and within ±10% of the value. For example, here 100 cycles include precisely 100 cycles, approximately 100 cycles, and within ±10% of 100 cycles.

In some embodiments, CO₂ adsorbed to the functionalized material is released (e.g., desorbed) under some conditions. As one example, reducing the gas pressure surrounding the functionalized material desorbs captured CO₂. As another example, reducing the partial pressure of CO₂ surrounding the functionalized material desorbs captured CO₂ (e.g., by purging with N₂ or another gas). One or more of these approaches facilitates recapture of the adsorbed CO₂ in a secondary environment. In some implementations, the functionalized material is exposed to a reduced gas pressure of less than 5 psi (e.g., less than 3 psi, 1.5 psi, 1 psi, or 0.1 psi).

As a second example, increasing the temperature of the functionalized material destabilizes bonding between an amine group and CO₂, thereby desorbing the CO₂ from the functionalized material. In some embodiments, the functionalized material desorbs CO₂ at temperatures above 60° C. (e.g., above 60° C., 70° C., 80° C., or 90° C.). In some embodiments, increasing the temperature and decreasing gas pressure concurrently increase the rate at which the CO₂ desorbs from the functionalized material.

Indeed, in some embodiments, release of gas from a sorbent includes any useful process. In one example, a swing process is employed. In some embodiments, such swing processes include application of temperature change, pressure change, and/or vacuum change to release the gas from the sorbent composition. In some embodiments, swing processes include Temperature Swing Adsorption (TSA), Pressure Swing Adsorption (PSA), and Vacuum Swing Adsorption (VSA), or any combination of these. In some embodiments, the released gas is provided as outputs, and such outputs are generated by exposing the sorbent to a temperature swing adsorption process, pressure swing adsorption, vacuum swing adsorption process, or any combination of any of these.

i. Substrate.

In some embodiments the functionalized material includes any useful substrate. In some embodiments the substrate is in the form of a plurality of porous particles. In some embodiments, the substrate has a porous surface upon which a functional portion is disposed. In some embodiments, the substrate comprises a porous substrate, such as a porous ceramic (e.g., a porous metal oxide, a porous metalloid oxide, or combinations thereof or mixed forms thereof), a porous metal-organic substrate, or a porous polymeric substrate. In some embodiments, the substrate comprises a porous ceramic/metal oxide together with porous silica (e.g., including porous alumina, calcium silicate, sodium aluminosilicate). Yet other non-limiting examples of substrates include porous silica or silicate (e.g., amorphous silica, calcium silicate, sodium aluminosilicate), porous alumina (e.g., including sodium aluminosilicate), metal-organic framework (MOF), or resin (e.g., as described herein). In some embodiments, the substrate is provided in any form (e.g., precipitated, sol-gel, fumed, calcined, agglomerated, or granulated forms, which in turn can be provided as a powder, a granule, and the like). In some embodiments the substrate is sourced from standard industrial sources or is synthesized. In some embodiments, the substrate is water-stable and/or resistant to corrosion and oxidation.

The dimension of the substrate can vary based on the application and/or the source. Depending on the shape of the substrate, a dimension of the substrate can include a length, width, height, cross-sectional dimension, circumference, radius (e.g., external or internal radius), diameter, or another metric to indicate a size of the substrate.

In some embodiments, the substrate comprises a plurality of porous particles, in which the plurality of porous particles is characterized by a certain effective average particle size and/or by a certain distribution of sizes. For example and without limitation, in some embodiments the plurality of porous particles has an effective average particle size in which at least 50% of the porous particles therein are of a specified size. For example and without limitation, in some embodiments the plurality of porous particles exhibits a distribution of sizes that is from about 25 micrometers (μm) to 3 millimeter (mm) or from 25 μm to 4 mm. Thus, in some embodiments where the plurality of porous particles exhibits a distribution of sizes, at least 60 percent, at least 70 percent, at least 80 percent, at least 90 percent, at least 95 percent, at least 99 percent, or all of the porous particles have a sieve diameter that is within the upper and lower bounds of the specified distribution.

In some embodiments, the plurality of porous particles exhibits a distribution of sieve diameters, with an average sieve diameter that is in a range from 25 μm to 4 mm (e.g., from 45 to 800 μm, 50 to 500 μm, 60 to 300 μm, 45 to 150 μm, 70 to 80 μm, 25 μm to 3 mm, 25 μm to 2 mm, 25 μm to 1 mm, 50 μm to 4 mm, 50 μm to 3 mm, 50 μm to 2 mm, 50 μm to 1 mm, 100 μm to 4 mm, 100 μm to 3 mm, 100 μm to 2 mm, 100 μm to 1 mm, 200 μm to 4 mm, 200 μm to 3 mm, 200 μm to 2 mm, 200 μm to 1 mm, 250 μm to 4 mm, 250 μm to 3 mm, 250 μm to 2 mm, 250 μm to 1 mm, 500 μm to 4 mm, 500 μm to 3 mm, 500 μm to 2 mm, 500 μm to 1.5 mm, 1 to 2 mm, 1 to 2.5 mm, 1 to 3 mm, or 1 to 4 mm). In some embodiments, the plurality of porous particles exhibits a distribution of sieve diameters, with an average sieve diameter that is in a range from 25 μm to 4 mm. In some embodiments, the plurality of porous particles exhibits a distribution of sieve diameters, with an average sieve diameter that is in a range from 0.8 millimeters (mm) to 4 millimeters (mm) (e.g., greater than 0.8 mm and less than 4 mm). In some embodiments, the plurality of porous particles exhibits a distribution of sieve diameters, with an average sieve diameter that is in a range from 0.8 mm to 3 mm (e.g., greater than 0.8 mm and less than 3 mm). In some implementations, the average sieve diameter of the plurality of porous particles is less than 500 μm (e.g., less than 400 μm, less than 350 μm, less than 300 μm, less than 200 μm, or less than 100 μm). In some embodiments, the substrate (e.g., porous silica particles) has an average sieve diameter of at least 0.5 mm. In some embodiments, a sieve diameter refers to a diameter of a particle.

In some embodiments, the sieve diameter of the plurality of porous substrate particles is a measure of central tendency determined over the sieve diameter of the plurality of porous particles. As used herein, the term sieve diameter is the smallest mesh size through which a particle can pass. As used herein, the term “measure of central tendency” refers to a central or representative value for a distribution of values. Non-limiting examples of measures of central tendency include a mean, arithmetic mean, weighted mean, midrange, midhinge, trimean, geometric mean, geometric median, Winsorized mean, median, and mode of the distribution of values. For instance, in some embodiments, the sieve diameter of the plurality of porous particles is an average sieve diameter of the plurality of porous particles used for generating the functionalized crosslinked particles.

In some embodiments, the plurality of porous particles comprises a distribution of sieve diameters.

In some embodiments, the sieve diameter, or the measure of central tendency (e.g., mean) thereof, for the plurality of porous particles (substrate) is at least 1 μm, at least 5 μm, at least 10 μm, at least 15 μm, at least 20 μm, at least 25 μm, at least 50 μm, at least 80 μm, at least 100 μm, at least 200 μm (0.2 millimeters (mm)), at least 0.3 mm, at least 0.4 mm, at least 0.5 mm, at least 0.6 mm, at least 0.7 mm, at least 1 mm, at least 1.5 mm, at least 2 mm, at least 2.5 mm, at least 3 mm, at least 3.5 mm, at least 4 mm, at least 5, at least 10 mm, or at least 20 mm. In some embodiments, the sieve diameter, or the measure of central tendency (e.g., mean) thereof, of the plurality of porous particles is no more than 50 mm, no more than 20 mm, no more than 10 mm, no more than 5 mm, no more than 4 mm, no more than 3.5 mm, no more than 3 mm, no more than 2.5 mm, no more than 2 mm, no more than 1.5 mm, no more than 1 mm, no more than 0.5 mm, no more than 0.3 mm, no more than 0.2 mm, no more than 100 μm, no more than 50 μm, no more than 30 μm, no more than 20 μm, no more than 10 μm, or no more than 5 μm. In some embodiments, the sieve diameter, or the measure of central tendency (e.g., mean) thereof, for the plurality of porous particles is from 1 μm to 10 μm, from 1 μm to 50 μm, from 5 μm to 100 μm, from 80 μm to 0.3 mm, from 0.2 mm to 1 mm, from 0.5 mm to 2 mm, from 1 mm to 4 mm, from 0.4 mm to 4 mm, from 3 mm to 5 mm, from 4 mm to 10 mm, or from 8 mm to 50 mm. In some embodiments, the sieve diameter, or the measure of central tendency (e.g., mean) thereof, for the plurality of porous particles falls within another range starting no lower than 0.2 mm and ending no higher than 10 mm. In some embodiments, the sieve diameter, or the measure of central tendency (e.g., mean) thereof, for the plurality of porous particles falls within another range starting no lower than 1 μm and ending no higher than 50 mm.

In some embodiments, the sieve diameter of the porous particles (substrate) varies based on the application and/or the source. In some embodiments, the porous particles (substrate) have an average sieve diameter in the range from 0.25 mm to 4.0 mm (e.g., 0.25 mm to 1.5 mm, 0.5 mm to 1.5 mm, 0.5 mm to 1.0 mm, 1.0 mm to 2.0 mm, 1.5 to 2.0 mm, 0.5 mm to 4.0 mm, 1.0 mm to 4.0 mm, or 2.0 mm to 4.0 mm). In some embodiments, the porous particles have a distribution of sieve diameters having an average (e.g., mean) diameter ranging from 1 mm to 1.2 mm. In some embodiments, the distribution of sieve diameters for the plurality of porous particles comprises sieve diameters of from 0.2 mm to 1 mm, from 0.5 mm to 2 mm, from 1 mm to 4 mm, from 0.4 mm to 4 mm, from 3 mm to 5 mm, from 0.2 mm to 5 mm, from 1 mm to 8 mm, from 0.3 mm to 5 mm, from 0.2 mm to 10 mm, or from 4 mm to 10 mm. In some embodiments, the distribution of sieve diameters for the plurality of porous particles falls within another range starting no lower than 0.2 mm and ending no higher than 10 mm.

The width of the distribution around the average can affect adsorption performance of the substrate (e.g., plurality of porous particles). In some non-limiting implementations, the width of the distribution is in a range from 5 to 50 μm around the average (e.g., from 10 to 40 μm or 20 to 30 μm). In some examples, the width of the distribution is in a range from 50 μm to 2 mm around the average (e.g., from 75 μm to 1.5 mm, 100 μm to 1.25 mm, 200 μm to 1 mm, 300 to 800 μm, 500 μm to 2 mm, 500 μm to 1.5 mm, 500 μm to 1 mm, 1 to 2 mm, 1.2 to 1.8 mm, 1.4 to 2 mm, or 1.5 to 2 mm). In some embodiments, the width of the distribution is at least 25 μm, at least 50 μm, at least 100 μm, at least 200 μm, at least 300 μm, at least 400 μm, at least 500 μm, at least 800 μm, at least 1 mm, at least 2 mm, or at least 3 mm. In some embodiments, the width of the distribution is no more than 5 mm, no more than 3 mm, no more than 2 mm, no more than 1 mm, no more than 500 μm, no more than 200 μm, or no more than 100 μm. In some embodiments, the width of the distribution is from 25 μm to 200 μm, from 100 μm to 500 μm, from 100 μm to 1 mm, from 500 μm to 2 mm, from 1 mm to 3 mm, or from 2 mm to 5 mm. In some embodiments, the width of the distribution falls within another range starting no lower than 2 μm and ending no higher than 10 mm.

In some embodiments, the width of the distribution is alternatively described using D₉₀, D₅₀, and/or D₁₀ values. These values signify a percentage of the total distribution of sizes for material within a sample, up to and including the value. For example, a D₉₀ value of 500 μm indicates that 90% of the material (e.g., the plurality of porous particles) within a sample has a size of 500 μm or smaller. In some embodiments, the functionalized material (e.g., the plurality of functionalized crosslinked particles) has a D₁₀ value of 30 μm or a D₋₉₀ value of 150 μm. In some embodiments, the functionalized material has a D₁₀ value of 100 μm or a D₉₀ value of 500 μm, a D₁₀ value of 150 μm or a D₉₀ value of 1000 μm, a D₁₀ value of 400 μm or a D₉₀ value of 1500 μm, a D₁₀ value of 500 μm or a D₉₀ value of 2000 μm, or a D₁₀ value of 1000 μm or a D₉₀ value of 3000 μm. In some embodiments, the functionalized material has a D₅₀ value of 1000 μm, 1100 μm, 1200 μm, 1300 μm, 1400 μm, or 1500 μm. In some embodiments, the plurality of porous substrate particles comprises a D90 for any of the sieve diameters disclosed herein, and/or any of the measures of central tendency or distributions thereof. For instance, in some embodiments, the plurality of porous substrate particles comprises a D90 of 2 mm, indicating that 90% of the porous substrate particles have a sieve diameter of 2 mm or smaller. In some embodiments, the plurality of porous substrate particles comprises a D50 for any of the diameters disclosed herein, and/or any of the measures of central tendency or distributions thereof. In some embodiments, the plurality of porous substrate particles comprises a D10 for any of the sieve diameters disclosed herein, and/or any of the measures of central tendency or distributions thereof.

In general and without wishing to be bound by theory, a smaller particle size with high porosity or high pore volume and BET surface area can facilitate better functionalized material synthesis results, which in turn can enable higher CO₂ capture capacity due to relatively higher surface area leading to higher amine coating concentrations. Such types of smaller particles could permit faster adsorption inside of the particle as the gas diffusion path may be shorter. If gas diffusion to the particle surface rate is not limited, then a smaller particle size may be beneficial to gas adsorption. Smaller particle size (e.g., having a small average diameter, radius, or width) could reduce the adsorption process energy cost for a fluidization process.

Yet other particle effects for smaller particle sizes can include smaller interparticle volume, slower interparticle gas kinetics (e.g., due to longer interparticle diffusion length), faster intraparticle gas kinetics (e.g., due to shorter intraparticle diffusion length), higher packed bed back pressure, higher packing density, and/or higher external surface area. Particle effects for larger particle sizes can include larger interparticle volume, faster interparticle gas kinetics (e.g., due to shorter interparticle diffusion length), slower intraparticle gas kinetics (e.g., due to longer intraparticle diffusion length), lower packed bed back pressure, lower packing density, and/or lower external surface area. A skilled artisan could adapt such sizes and effects to provide a certain adsorbent for particular uses.

In some embodiments the substrate (e.g., plurality of porous particles) is characterized by the presence of one or more pores. As seen in FIG. 1A, pores 104 can be considered openings that extend from the exterior surface of the substrate into the interior of the particles. In some embodiments, the presence of such pores increase the surface area of the substrate. Pore dimension varies from pore to pore, and can vary within an individual pore, see, e.g., pores 104A-a, 104A-b. Furthermore, depending on pore shape, a pore dimension can be a length, width, height, cross-sectional dimension, circumference, radius (e.g., external or internal radius), diameter, or another metric to indicate pore size. In some embodiments, one or more pores in the plurality of pores are discrete, that is, the one or more pores in the plurality of pores are not interconnected with other pores in the plurality of pores. In some embodiments, the plurality of pores comprises discrete (e.g., not interconnected) pores. In some embodiments, the plurality of pores consists of discrete (e.g., not interconnected) pores.

In some embodiments, the pore size of the pores is in a range from 60 angstroms (Å) to 700 angstroms (Å) (e.g., from 60 to 400 Å, 60 to 300 Å, 80 to 300 Å, 100 to 700 Å, 100 to 500 Å, 100 to 200 Å, 150 to 250 Å, 200 to 700 Å, 300 to 700 Å, 300 to 500 Å, or 500 to 700 A). In some embodiments, the pores have an average pore size or a mean pore size that is from about 60 Å 100 to about 400 Å. In some embodiments, the pores have an average pore size or a mean pore size that is at least 30 Å, at least 50 Å, at least 100 Å, at least 200 Å, at least 300 Å, at least 500 Å, at least 1000 Å, at least 2000 Å, or at least 3000 Å. In some embodiments, the pores have an average pore size or a mean pore size that is no more than 5000 Å, no more than 2000 Å, no more than 1000 Å, no more than 500 Å, no more than 300 Å, no more than 100 Å, or no more than 50 Å. In some embodiments, the pores have an average pore size or mean pore size that is from about 50 Å to about 300 Å. In some embodiments, the pores have an average pore size or mean pore size that falls within another range starting no lower than 30 Å and ending no higher than 5000 Å. In some implementations, the dimension (e.g., a diameter, cross-sectional length, etc.) of the pore(s) is greater than 90 Å (e.g., greater than 100 Å, 120 Å, or 150 Å). Without wishing to be limited by theory, a larger diameter of the pore could increase adsorption and desorption rates and could facilitate higher filling of the pores with amine moieties without pore-clogging, which in turn could reduce adsorption and desorption efficiency.

In some embodiments, the substrate is characterized by a porosity of 1 to 200 nm and/or an average pore size of 30 to 80 nm. In some embodiments, a dimension (e.g., a diameter, a cross-sectional length, etc.) of the pore(s) is in a range from 1 to 200 nm (e.g., 1 to 180 nm, 1 to 160 nm, 1 to 120 nm, 1 to 100 nm, 1 to 70 nm, 1 to 30 nm, 1 to 20 nm, 10 to 200 nm, 10 to 180 nm, 10 to 160 nm, 10 to 120 nm, 10 to 100 nm, 10 to 70 nm, 10 to 50 nm, 30 to 200 nm, 30 to 180 nm, 30 to 160 nm, 30 to 120 nm, 30 to 100 nm, 30 to 90 nm, 30 to 70 nm, 70 to 200 nm, 70 to 180 nm, 70 to 160 nm, or 70 to 120 nm). In some embodiments, an average dimension (e.g., an average diameter) of the pore(s) is in a range from 30 to 80 nm, 20 to 100 nm, or 20 to 70 nm). In some embodiments, a dimension (e.g., a diameter, a cross-sectional length, etc.) of the pore(s) is at least 0.5 nm, at least 1 nm, at least 2 nm, at least 5 nm, at least 10 nm, at least 20 nm, at least 30 nm, at least 50 nm, at least 80 nm, at least 100 nm, at least 200 nm, or at least 500 nm. In some embodiments, a dimension (e.g., a diameter, a cross-sectional length, etc.) of the pore(s) is no more than 1000 nm, no more than 500 nm, no more than 200 nm, no more than 100 nm, no more than 50 nm, no more than 30 nm, no more than 10 nm, or no more than 1 nm. In some embodiments, a dimension (e.g., a diameter, a cross-sectional length, etc.) of the pore(s) is from 40 nm to 200 nm. In some embodiments, a dimension (e.g., a diameter, a cross-sectional length, etc.) of the pore(s) is from 100 nm to 200 nm. In some embodiments, a dimension (e.g., a diameter, a cross-sectional length, etc.) of the pore(s) falls within another range starting no lower than 0.5 nm and ending no higher than 1000 nm.

In some embodiments, the substrate (e.g., the plurality of porous particles) is characterized by a plurality of pores of different sizes. For example and without limitation, smaller pores in the range of 1 to 30 nm can contribute to relatively higher surface areas, which can allow for more surface anchoring with amine moieties to improve stability of the coating or surface functionalization layer. Larger pores in the range of 30 to 90 nm can contribute to relatively larger pore volumes that allow for larger volumes of active amine moieties to be contained within the pores to improve the CO₂ uptake. The largest pores in the range of 70 to 200 nm can provide open channels that contribute to relatively higher gas diffusion rates for improved CO₂ adsorption kinetics. Without wishing to be limited by mechanism, a substrate (e.g., a silica substrate) that possesses significant porosity in these three ranges may be employed as substrates for amine-coated sorbents. In some non-limiting embodiments, a substrate having reduced porosity in one or two of these ranges may suffer from relatively decreased performance in the corresponding function but may still function as substrates for amine-coated sorbents.

In some embodiments, a substrate (e.g., plurality of porous particles) is characterized by a plurality of pores, where each pore is characterized by a pore dimension, where at least one pore dimension is in a first range of about 1 to 30 nm, a second range of about 30 to 90 nm, and/or a third range of about 70 to 200 nm. Such ranges can be any other ranges of pore dimensions described herein.

Pores can have any useful shape (e.g., cylindrical, spherical, tubular, and the like), configuration, distribution, and arrangement (e.g., hexagonal, cubic, and the like). In some embodiments, the pores have an irregularly round cross-sectional shape, or a hexagonal cross-sectional shape, though this is not limiting. Pores may also be characterized by pore size distributions, which can be determined in any useful manner (e.g., using mercury, nitrogen, argon, helium, etc. in porosimetry or using Brunauer-Emmett-Teller (BET) analysis with appropriate methods such as the Barrett Joyner Halenda (BJH) or Non-Local Density Functional Theory (NLDFT) models). Generally, BET surface area refers to a technique for determining the surface area of particles. Samples are introduced to a probe gas that physically adsorbs to the surface of the sample. The volume of probe gas adsorbed is measured to determine the quantity of gas required to cover the surface of the sample. The BET theory is then applied to the adsorption data to generate a specific surface area, reported in units of area per mass of sample (m²/g). See, for example, “BET Specific Surface Area,” available on the Internet at particletechlabs.com/analytical-testing/bet-specific-surface-area.

Pore size distribution profiles can include those for non-limiting sorbents with only narrow pores having high surface areas but relatively lower pore volumes and gas kinetics, non-limiting sorbents with only moderately sized pores having high pore volumes and moderate surface areas and gas kinetics, non-limiting sorbents with only large pores having fast gas kinetics and high pore volumes but relatively lower surface areas, and non-limiting sorbents with pores in a plurality of ranges having high surface areas, pore volumes, and channels for gas diffusion allowing for stable surface coating, relatively higher concentrations of active amines, and fast gas kinetics.

The pores can have any useful configuration. In some embodiments, pores may be provided on a surface of the substrate. Such pores may or may not be interconnected. For example and without limitation, pores could extend into the central volume of the substrate and form interconnected channels. Without wishing to be limited by theory, the pores can create a volume within the substrate in which gases may flow for enhanced capture of such gases. Furthermore, such pores may create additional (e.g., and accessible) surface area for functionalization.

In some embodiments, pores are characterized by pore volume, total surface area, accessible surface area, porosity, and the like. Without wishing to be limited theory, increased total volume of the pores could allow more amine moieties to be grafted or into the pores and, thus increase the adsorption potential of the functionalized material. In some embodiments, the pore volume, or the measure of central tendency (e.g., mean) thereof, for the plurality of porous substrate particles is at least 0.1 mL/g, at least 0.2 mL/g, at least 0.5 mL/g, at least 0.1 mL/g, at least 1 mL/g, at least 1.2 mL/g, at least 1.5 mL/g, at least 2 mL/g, at least 2.5 mL/g, at least 3 mL/g, at least 3.5 mL/g, at least 4 mL/g, at least 4.5 mL/g, at least 5 mL/g, or at least 8 mL/g. In some embodiments, the pore volume, or the measure of central tendency (e.g., mean) thereof, for the plurality of porous substrate particles is no more than 10 mL/g, no more than 5 mL/g, no more than 3 mL/g, no more than 2 mL/g, no more than 1.5 mL/g, no more than 1 mL/g, no more than 0.5 mL/g, no more than 0.3 mL/g, or no more than 0.2 mL/g. In some embodiments, the pore volume, or the measure of central tendency (e.g., mean) thereof, for the plurality of porous substrate particles is from 0.1 mL/g to 0.8 mL/g, from 0.5 mL/g to 1.5 mL/g, from 0.8 mL/g to 3 mL/g, from 1 mL/g to 4 mL/g, from 3 mL/g to 10 mL/g, from 0.5 mL/g to 5 mL/g, or from 0.1 mL/g to 10 mL/g. In some embodiments, the pore volume, or the measure of central tendency (e.g., mean) thereof, for the plurality of porous substrate particles falls within another range starting no lower than 0.1 mL/g and ending no higher than 10 mL/g.

Total surface area (e.g., BET surface area) can be used to characterize the substrate. The total surface area of the substrate includes the surface area of not only the outer surface but also the surface area within the pores. In some embodiments, the total surface area is greater than 100 m² per dry gram (m²/g) of substrate. In some implementations, the total surface area is greater than 300 m²/g (e.g., greater than 200 m²/g, 400 m²/g, 500 m²/g, or 800 m²/g). In some implementations, the total surface area is greater than 1200 m²/g (e.g., greater than 200 m²/g, 400 m²/g, 500 m²/g, or 800 m²/g). In some implementations, the total surface area is greater than 2000 m²/g (e.g., greater than 2500 m²/g, 3000 m²/g, 4000 m²/g, 5000 m²/g, or 6000 m²/g). In some examples, the total surface area is in a range from 100 to 1200 m²/g (e.g., from 200 to 1200 m²/g, 400 to 1200 m²/g, 500 to 1200 m²/g, 700 to 1200 m²/g, 800 to 1200 m²/g, 1000 to 1200 m²/g, 100 to 1000 m²/g, 100 to 800 m²/g, 100 to 500 m²/g, 100 to 400 m²/g, 100 to 900 m²/g, 200 to 900 m²/g, 400 to 900 m²/g, 500 to 1000 m²/g, or 500 to 800 m²/g). In some examples, the total surface area is in a range from 1000 to 12000 m²/g (e.g., from 1000 to 11000 m²/g, 1000 to 10000 m²/g, 1000 to 9000 m²/g, 1000 to 8000 m²/g, 1000 to 7000 m²/g, 1000 to 6000 m²/g, 1000 to 5000 m²/g, 1000 to 4000 m²/g, 2000 to 12000 m²/g, 2000 to 11000 m²/g, 2000 to 10000 m²/g, 2000 to 9000 m²/g, 2000 to 8000 m²/g, 2000 to 7000 m²/g, 2000 to 6000 m²/g, 2000 to 5000 m²/g, 2000 to 4000 m²/g, 3000 to 12000 m²/g, 3000 to 11000 m²/g, 3000 to 10000 m²/g, 3000 to 9000 m²/g, 3000 to 8000 m²/g, 3000 to 7000 m²/g, 3000 to 6000 m²/g, 3000 to 5000 m²/g, 3000 to 4000 m²/g, 4000 to 12000 m²/g, 4000 to 11000 m²/g, 4000 to 10000 m²/g, 4000 to 9000 m²/g, 4000 to 8000 m²/g, 4000 to 7000 m²/g, 4000 to 6000 m²/g, or 4000 to 5000 m²/g). In some examples, the total surface area is in a range from 100 to 12000 m²/g (e.g., including ranges therebetween, such as any described herein).

Without wishing to be limited by theory, higher total surface area could increase the available area for functionalization (e.g., by way of interactions between a silane moiety and a surface of the substrate) and/or increase the adsorption potential of the functionalized material. Surface area can be determined in any useful manner, e.g., by using the BET model or other methodologies described herein.

Any useful combination of features may be present in a substrate. In some embodiments, the substrate comprises a greatest dimension (e.g., an average greatest dimension) of at least 70 μm and a plurality of pores, where the plurality of pores is characterized by a volume that is greater than 0.8 mL/g and by a size (e.g., an average size) of at least 90 Å. In some embodiments, the substrate comprises a greatest dimension (e.g., an average greatest dimension) in a range from 0.5 to 2 mm and a plurality of pores, where the plurality of pores is characterized by a volume greater than 0.5 ml/g and a size in a range from 20 to 1000 Å. Other combinations of features are possible.

In some embodiments, the substrate comprises silica (e.g., silicon dioxide). Any methods or compounds herein can be used to functionalize a silica substrate to provide a functionalized silica. For example and without limitation, in some embodiments the functionalized silica has amine moieties that are bound to the silica surface (e.g., by way of siloxane bonds, other covalent bonds, or even non-covalent bonds).

In some embodiments the silica is in any useful form, such as beads (e.g., microbeads, nanobeads, or combinations thereof), powders (e.g., micropowders, nanopowders, or combinations thereof; or from micrometer size to millimeter size), particles (e.g., microparticles, nanoparticles, or combinations thereof), and the like. Furthermore, in some embodiments the silica includes any useful type, such as amorphous or non-crystalline silica (e.g., precipitated, sol-gel, fumed, calcined, agglomerated, or other forms of silica) or silicates (e.g., calcium silicate, sodium aluminosilicate, and the like). In some embodiments, the silica includes one or more pores (e.g., as in porous silica). Furthermore, within such a substrate, pores can have any useful shape, configuration, distribution, and arrangement (e.g., hexagonal arrangement of pores in MCM-41, which in turn can be spherical or any other shape). In some embodiments, the substrate can be bead-shaped, though this is not limiting. Silica can be obtained or provided in any useful manner, such as by employing synthetic methods or by sourcing from standard industrial sources.

In some non-limiting embodiments, the substrate 102A, 102B, 102C is a silica substrate. In some non-limiting embodiments, the substrate 102A, 102B, 102C is composed of amorphous silica, e.g., non-crystalline silica.

In some embodiments, metal organic frameworks (MOF) substrates are used as a porous structure for functionalization to achieve carbon capture. In some embodiments, the substrate comprises a MOF. Any methods or compounds herein are used to functionalize a MOF substrate to provide a functionalized MOF.

In some embodiments, the substrate comprises a resin (e.g., an ion-exchange resin). Any methods or compounds herein are used to functionalize a resin substrate to provide a functionalized resin. For example and without limitation, in some embodiments a functionalized resin features amine moieties that are bound to acidic reactive sites present on the surface, thereby allowing for CO₂ uptake. In some embodiments the amine moiety is provided by any compound described herein (e.g., a polyamine) for increased carbon capture (e.g., >1 mol CO₂/kg or from 1 to 3 mol CO₂/kg).

Further embodiments for example substrate materials contemplated for use in the present disclosure, including but not limited to silicas, metal organic frameworks (MOFs), and/or resins, are further disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

ii. Functional Portion.

In some embodiments, the functional portion includes any combination of moieties, groups, or compounds to facilitate adsorption of desired gases by the sorbent. In some embodiments, the functional portion includes an adsorbing moiety and an interaction moiety. Whereas the adsorbing moiety is configured to adsorb a desired gas, the interaction moiety is configured to attach (directly or indirectly) the adsorbing moiety to the substrate surface. Optionally, the interaction moiety is further configured to stabilize the functional portion, such as by forming bonds with the adsorbing moiety and/or the substrate surface. In another optional embodiment, the interaction moiety further provides an additional adsorbing moiety to enhance adsorption of the sorbent. In some embodiments, the functional portion includes any useful combination of one or more adsorbing moieties (e.g., one or more amine moieties) with one or more interaction moieties (e.g., one or more silane moieties). In some embodiments, when a plurality of amine moieties is present (e.g., when a first amine moiety and a second amine moiety are present), such moieties react with or bind to carbon dioxide.

As seen in FIGS. 1A-1G, in some embodiments, a surface 103A-G of the substrate 102A-G is functionalized to provide a functional portion 106A-G.

In some embodiments, any useful combination of moieties is present. For example, in some embodiments, the functional portion includes a combination of one or more adsorbing moieties, a combination of one or more interaction moieties, a combination of an adsorbing moiety with an interaction moiety, and a combination of one or more adsorbing moieties with one or more interaction moieties.

In some embodiments, the functional portion is provided in any useful manner. For example, in some embodiments, a compound having both the adsorbing moiety and the interaction moiety is provided to a substrate. A non-limiting example of such a compound includes an aminosilane comprising an amino moiety (e.g., as the adsorbing moiety) and a silane moiety (e.g., as the interaction moiety). In some embodiments, the compound has a long-chain multi-amine containing moiety. In some embodiments, the compound has a silane moiety, which is chemically bonded to a surface of each of the particles (e.g., porous silica particles) serving as the substrate.

a. Aminosilanes

In some embodiments, the compound is an aminosilane. For example and without limitation, the substrate surface (e.g., a silica substrate surface) is functionalized with an aminosilane compound including a silane moiety bonded to an amine moiety. In turn, in some embodiments, the surface includes a functional group having the silane moiety and the amine moiety. As used herein, such moieties also include reacted forms of these moieties (e.g., a reacted form of a silane moiety upon reacting with a surface of the substrate) that may be present upon forming one or more bonds, as would be understood by a skilled artisan.

In some embodiments, the aminosilane include at least one silane moiety (e.g., one, two, three, or more silane moieties) and at least one amine moiety (e.g., one, two, three, or more amine moieties). Non-limiting examples of aminosilane compounds, silane moieties, and amine moieties are described herein.

In some embodiments, the aminosilane compound includes one, two, three, or more silane moieties. In some embodiments, the silane moiety includes a trialkoxysilane (e.g., —SiR^{S1}R^{S2}R^{S3}, in which each of R^{S1}, R^{S2}, and R^{S3} is, independently, alkoxy; such as trimethoxysilane or triethoxysilane), a dialkoxysilane (e.g., —SiR^{S1}R^{S2}R^{S3}, in which each of R^{S1} and R^{S2} is, independently, alkoxy, and R^{S3} is a leaving group or a reactive group, such as any described herein), a dialkoxysilanol group (e.g., —Si(OR)₂OH, in which each R is independently alkyl), a hydrosilane group (e.g., —SiH₃), a monoalkylsilane group (e.g., —SiR^{S1}R^{S2}R^{S3}, in which R^{S1} is alkyl, and each of R^{S2} and R^{S3} is independently a leaving group or a reactive group, such as any described herein; in which non-limiting examples of monoalkylsilane is alkyldialkoxysilane or alkyldihalosilane), a dialkylsilane group (e.g., —SiR^{S1}R^{S2}R^{S3}, in which each of R^{S1} and R^{S2} is independently alkyl, and R^{S3} is a reactive group or a leaving group, such as any described herein; in which non-limiting examples of dialkylsilane includes dialkylalkoxysilane or dialkylhalosilane), a trihalosilane group (e.g., —SiZ₃, in which each Z is independently halo, such as trichlorosilane), or a silanetriol (e.g., —Si(OH)₃). In some embodiments, higher numbers (e.g., three or more) of silane moieties in the aminosilane compound increase the covalent bond stability with the substrate as higher numbers of siloxane bonds between the silane moieties and the substrate surface can increase. Additionally, in some embodiments, a silane group forms up to three siloxane bonds (Si—O—Si) to the surface, which increases stability. In some embodiments, the number of siloxane bonds that are formed by silane moiety depends on the composition of the side groups (e.g., one or more of X¹, X², and/or X³) capable of forming siloxane bonds (e.g., —OMe, —OEt, —Cl, —OH, or a combination of any of these).

In some embodiments, the aminosilane compound includes one, two, three, or more amine moieties. In some embodiments, the amine moiety includes a primary amine (e.g., —NH₂), a secondary amine (e.g., —NHR^{N1}, in which R^{N1} is any R^{S1} described herein that is not hydrogen), a tertiary amine (e.g., —NR^{N1}R^{N2}, in which each of R^{N1} and R^{N2} is respectively any R^{S1} and R^{S2} described herein that is not hydrogen), or an aminoalkyl group (e.g., -Ak-NR^{N1}R^{N2}, in which Ak is optionally substituted alkylene and each of R^{N1} and R^{N2} is respectively any R^{S1} and R^{S2} described herein). In some embodiments, each of R^{N1} and R^{N2} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl. In some embodiments, each of R^{N1}, R^{N2}, and R is, independently, H, optionally substituted aliphatic, optionally substituted heteroaliphatic, optionally substituted aromatic, or optionally substituted heteroaromatic.

In some embodiments, the amine moiety includes more than one amine group connected through various linkers (e.g., any described herein for L). For instance, in some embodiments, the amine moiety includes a terminal amine group (e.g., —NR^{N1}R^{N2}), one or more internal amine groups (e.g., —NR^{N3}—), and a linker (e.g., -L-) disposed between the terminal and internal amine groups, where R^{N1}, R^{N2}, and R^{N3} are respectively any R^{S1}, R^{S2}, and R^{S3} described herein. Non-limiting examples of amine moieties include an aminoalkylamino group (e.g., —NR^{N3}-Ak-NR^{N1}R^{N2}, in which Ak is optionally substituted alkylene and each of R^{N1}, R^{N2} and R^{N3} is respectively any R^{S1}, R^{S2}, and R^{S3} described herein) or an aminoalkylaminoalkyl group (e.g., -Ak-NR^{N3}-Ak-NR^{N1}R^{N2}, in which each Ak is independently optionally substituted alkylene and each of R^{N1}, R^{N2}, and R^{N3} is respectively any R^{S1}, R^{S2}, and R^{S3} described herein described herein). In some embodiments, each of R^{N1}, R^{N2}, and R^{N3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR³, in which each R is independently an optionally substituted alkyl), or trialkoxylsilyloxy (e.g., —OSi[OR]₃, in which each R is independently an optionally substituted alkyl. In some embodiments, each of R^{N1}, R^{N2}, R^{N3}, and R is, independently, H, optionally substituted aliphatic, optionally substituted heteroaliphatic, optionally substituted aromatic, or optionally substituted heteroaromatic.

Higher numbers (e.g., three or more) of amine moieties in the aminosilane compound can increase the adsorption ability of a sorbent. In some embodiments, amine moieties may interact with other moieties and groups to stabilize stability of the functional group.

In some embodiments, an amine moiety (e.g., which can be amine groups) of one aminosilane can interact with a neighboring aminosilane (e.g., with silane moieties or side groups within a silane moiety of the neighboring aminosilane). Alternatively, an amine moiety of one aminosilane may not interact with a neighboring aminosilane (e.g., may not interact with silane moieties or side groups within a silane moiety of the neighboring aminosilane). In yet another embodiment, an amine moiety of one aminosilane may interact with other groups, moieties, or compounds (e.g., present in another compound, such as a polyamine or another type of aminosilane). In some embodiments, an amine moiety (e.g., which can be an amine group) of aminosilane can interact with a polyamine (e.g., an amine moiety of a polyamine).

The aminosilane compound can have any useful structure. In one non-limiting example, the aminosilane includes a structure having formula (I):

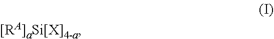

wherein each R^{A} is, independently, an amine moiety comprising at least one amine group; each X is, independently, a side group, a reactive group, or a leaving group; and a is an integer from 1 to 4.

The amine moiety (e.g., R^{A}) can include one or more amine groups. In one instance, the amine group can be —NR^{N1}R^{N2} or —NR^{N1}—, in which each of R^{N1} and R^{N2} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl). In some embodiments, each of R^{N1}, R^{N2}, and R is, independently, H, optionally substituted aliphatic, optionally substituted heteroaliphatic, optionally substituted aromatic, or optionally substituted heteroaromatic.

In some embodiments, the amine moiety (e.g., R^{A}) includes one, two, three, or more amine groups. In other embodiments, the amine moiety includes a terminal amine group (e.g., as —NR^{N1}R^{N2}) and/or an internal amine group (e.g., as —NR^{N1}—).

Non-limiting examples of amine moieties (e.g., R^{A}) include —NR^{N1}R^{N2}, -L-NR^{N1}R^{N2}, —NR^{N3}-L-NR^{N1}R^{N2}, -L²-NR^{N3}-L¹-NR^{N1}R^{N2}, -L³-NR^{N4}-L²-NR^{N3}-L¹-NR^{N1}R^{N2}, -L²-SiR^{S1}R^{S2}-L¹-NR^{N1}R^{N2}, and L³-SiR^{S1}R^{S2}-L²-NR^{N3}L¹-NR^{N1}R^{N2}, in which each of R^{N1}, R^{N2}, R^{S1}, and R^{S2} can be any described herein; in which each of R^{N3} and R^{N4} can be any described herein for R^{N1} and R^{N2}; and in which each L, L¹, L², or L³ is independently a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{N1}, R^{N2}, R^{N3}, R^{N4}, R^{S1}, and R^{S2} is, independently, H, optionally substituted aliphatic, or optionally substituted alkyl. Other examples of R^{N1}, R^{N2}, and R^{N3} are described herein.

The aminosilane can include a reactive group, a leaving group, or another group (e.g., X). Non-limiting examples of such groups include H, halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), or optionally substituted alkanoyloxy. In some embodiments, X is, independently, H, optionally substituted aliphatic, optionally substituted heteroaliphatic, optionally substituted aromatic, or optionally substituted heteroaromatic.

In one non-limiting example, the aminosilane includes a structure having formula (Ia):

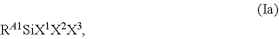

wherein R^{A1} is an amine moiety comprising at least one amine group; and each of X¹, X², and X³ is, independently, a side group, a reactive group, or a leaving group. Each of R^{A1}, X¹, X², and X³ can be any described herein for R^{A} and X, respectively.

In another non-limiting example, the aminosilane includes a structure having formula (Ib)-(Ie):

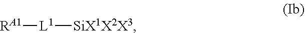

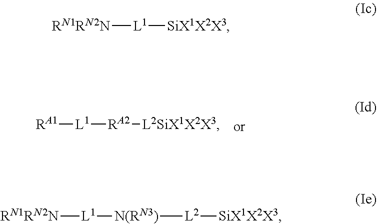

wherein each R^{A1} or R^{A2} is, independently, an amine moiety comprising at least one amine group; each of R^{N1}, R^{N2}, and R^{N3} can be any described herein; each of X¹, X², and X³ is, independently, a side group, a reactive group, or a leaving group; and each of L1 and L² is a linker. Each of R^{A1}, R^{A2}, X¹, X², X³, L¹, and L² can be any described herein for R^{A}, X, and L, respectively. In some embodiments, each of X¹, X², and X³ is, independently, H, halo, optionally substituted alkyl (e.g., optionally substituted C₁₋₃ alkyl), or optionally substituted alkoxy (e.g., optionally substituted C₁₋₃ alkoxy). In other embodiments, each of X¹, X², and X³ is, independently, optionally substituted alkoxy (e.g., optionally substituted C₁₋₃ alkoxy). In yet other embodiments, L is optionally substituted alkylene (e.g., optionally substituted C₁₋₁₂, C₁₋₁₀, C₁₋₈, or C₁₋₆ alkylene).

In yet another non-limiting example, the aminosilane includes a structure having formula (If):

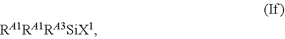

wherein each R^{A1}, R^{A2}, or R^{A3} is, independently, an amine moiety comprising at least one amine group; and X¹ is a side group, a reactive group, or a leaving group. Each of R^{A1}, R^{A2}, R^{A3}, and X¹ can be any described herein for R^{A} and X, respectively.

In some examples, the aminosilane includes a structure of formula (II):

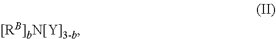

wherein each R^{B} is, independently, a silane moiety comprising at least one silane group; each Y is, independently, H, optionally substituted alkyl, or optionally substituted aryl; and b is an integer from 1 to 3. In some embodiments, each Y is, independently, H, optionally substituted aliphatic, optionally substituted heteroaliphatic, optionally substituted aromatic, or optionally substituted heteroaromatic.

The silane moiety (e.g., R^{B}) can include one or more silane groups. In one instance, the silane group can be —SiR^{S1}R^{S2}R^{S3} or —SiR^{S1}R^{S2}—, in which each of R^{S1}, R^{S2}, and R^{S3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSi^{R3}, in which each R is independently an optionally substituted alkyl), or trialkoxylsilyloxy (e.g., —OSi[OR]3, in which each R is independently an optionally substituted alkyl). In some embodiments, each of R^{S1}, R^{S2}, R^{S3}, and R is, independently, H, optionally substituted aliphatic, optionally substituted heteroaliphatic, optionally substituted aromatic, or optionally substituted heteroaromatic.

In some embodiments, the silane moiety (e.g., R^{B}) includes one, two, three, or more silane groups. In other embodiments, the silane moiety includes a terminal silane group (e.g., as —SiR^{S1}R^{S2}R^{S3}) and an internal silane group (e.g., as —SiR^{S1}R^{S2}—).

Non-limiting examples of silane moieties (e.g., R^{B}) include —SiR^{S1}R^{S2}R^{S3}, —Si(OR^{S1})(R^{S2})(R^{S3}), —Si(OR^{S1})(OR^{S2})(R^{S3}), —Si(OR^{S1})(OR^{S2})(OR^{S3}), -L-SiR^{S1}R^{S2}R^{S3}, -L-Si(OR^{S1})(R^{S2})(R^{S3}), -L-Si(OR^{S1})(OR^{S2})(R^{S3}), -L-Si(OR^{S1})(OR^{S2})(OR^{S3}), —SiR^{S4}R^{S5}-L-SiR^{S1}R^{S2}R^{S3} and —SiR^{S1}R^{S2}—NR^{N1}R^{N2}, in which each of R^{S1}, R^{S2}, R^{S3}, R^{N1}, and R^{N2} can be any described herein; in which each of R^{S4} and R^{S5} can be any described herein for R^{S1}, R^{S2}, and R^{S3}; and in which L is a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{S1}, R^{S2}, R^{S3}, R^{S4}, R^{S5}, R^{N1}, and R^{N2} is, independently, H, optionally substituted aliphatic, or optionally substituted alkyl.

In one non-limiting example, the aminosilane includes a structure having formula (IIa):

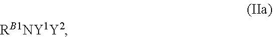

wherein R^{B1} is a silane moiety comprising at least one silane group; and each of Y¹ and Y2 is any described herein for Y (e.g., a side group, a reactive group, or a leaving group). R^{B1} can be any described herein for R^{B}.

In another non-limiting example, the aminosilane includes a structure having formula (IIb)-(IId):

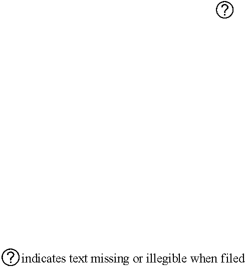

wherein each R^{B1} or R^{B2} is, independently, a silane moiety comprising at least one silane group; each of Y¹ and Y² is, independently, a side group, a reactive group, or a leaving group; each of R^{S1}, R^{S2}, and R^{S3} can be any described herein; and each of L1 and L² is a linker. Each of R^{B1}, R^{B2}, Y¹, Y², L¹, and L² can be any described herein for R^{B}, Y, and L, respectively.

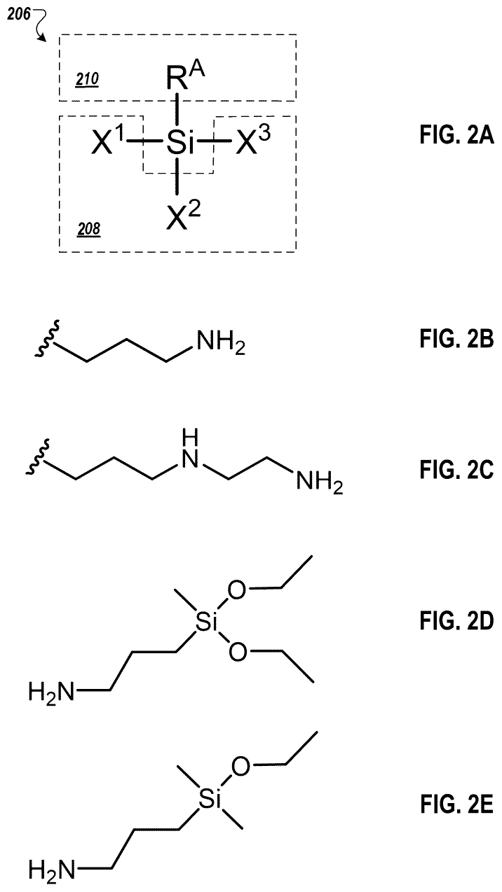

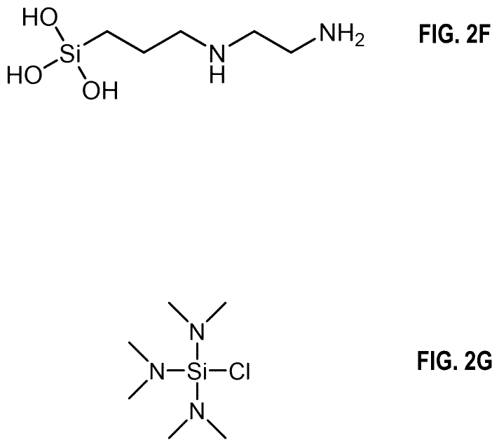

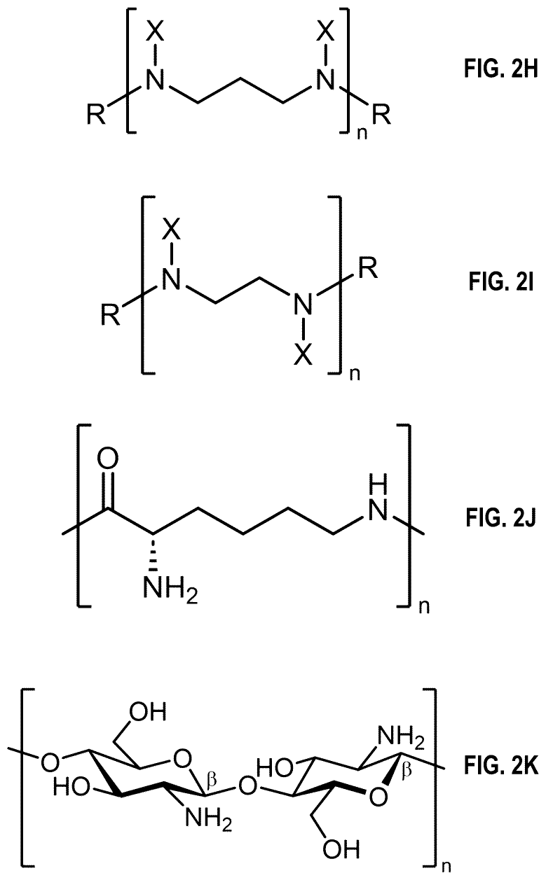

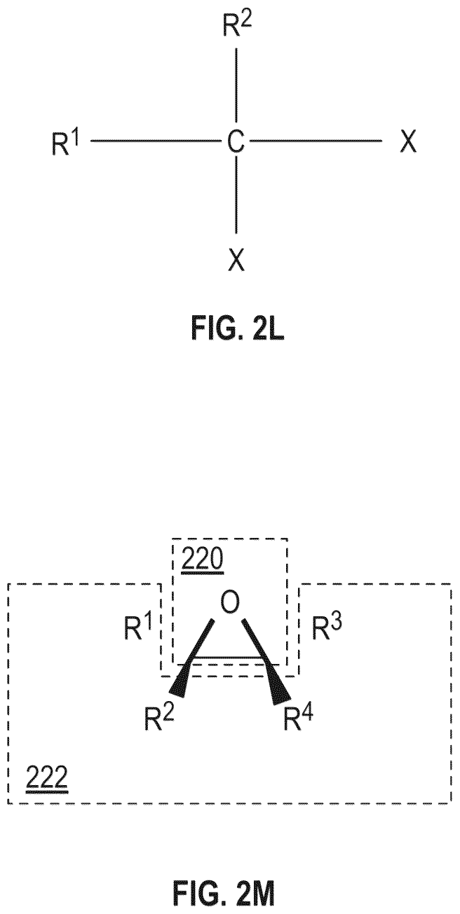

FIG. 2A depicts an example of an aminosilane 206 having an amine moiety 210 (denoted as R^{A}) and a non-limiting silane moiety 208 having three potential interaction sites or side groups (denoted as X¹, X², and X³). Side groups X¹—X³ are occupied by functional groups which include, but are not limited to, a methoxy group (—OMe), an ethoxy group (—OEt), a chloro (—Cl), a hydroxy group (—OH), a hydrogen (—H), or an alkyl group (e.g., a linear alkyl group such as —(CH2)n(CH3), in which n is an integer from 010; or a branched alkyl group). Yet other examples of functional groups can include any reactive or leaving group described herein. Non-limiting examples of functional groups for X can include halo, as well as optionally substituted aliphatic, alkyl, alkoxy, alkanoyloxy, heteroaliphatic, heteroalkyl, aromatic, aryl, aryloxy, and the like.

In some embodiments, the amine moieties 210 (e.g., which can be amine groups) of one aminosilane can interact with one or more of the side groups 208 of a neighboring aminosilane. Alternatively, amine moieties 210 may not interact with other side groups. In yet another embodiment, the amine moieties 201 may interact with other groups, moieties, or compounds (e.g., present in another compound, such as a polyamine or another type of aminosilane). In some embodiments, the amine moieties 210 (e.g., which can be amine groups) of aminosilane 208 can interact with a polyamine.

Optionally, a further linker can be present between the amine moiety and the silane moiety of the aminosilane compound. For example, a linker can be present between the amine moiety 210 and the silane moiety 208. In some embodiments, an aminosilane can include R^{A}-L-SiX¹X²X³, in which R^{A} is an amine moiety (e.g., any described herein), L is a linker (e.g., any described herein), and each of X¹, X², and X3 is a side group, a reactive group, or a leaving group (e.g., any described herein).

An aminosilane 206 can have any combination of these functional groups, e.g., amine moiety 210 and side groups 208 (e.g., which can include side group X¹, side group X², or side group X³), and must have at least one amine moiety 210 and at least one side group 208 (e.g., —OMe, —OEt, —Cl, —OH, —H, alkyl, or others described herein) capable of forming a siloxane bond (e.g., an Si-O or Si—O—Si linkage). FIG. 2B is a non-limiting example of a 3-aminopropyl group which, in some examples, serves as one or more side groups 208 (e.g., one or more of X¹, X², and X³) or amine moiety 210. FIG. 2C is an example of an N-(2-aminoethyl)-3-aminopropyl group which, in some examples, serves as one or more amine moieties 210.

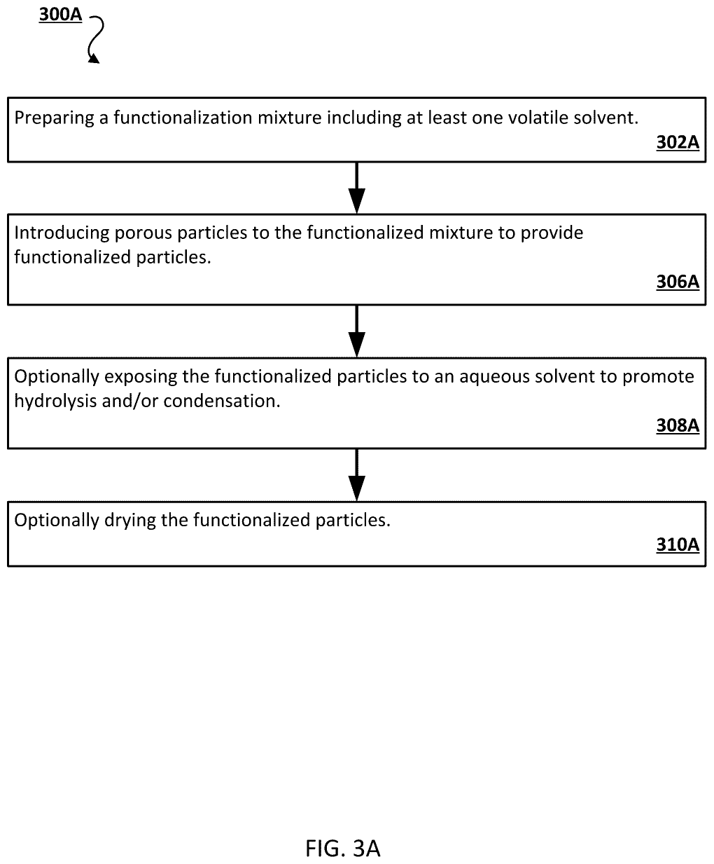

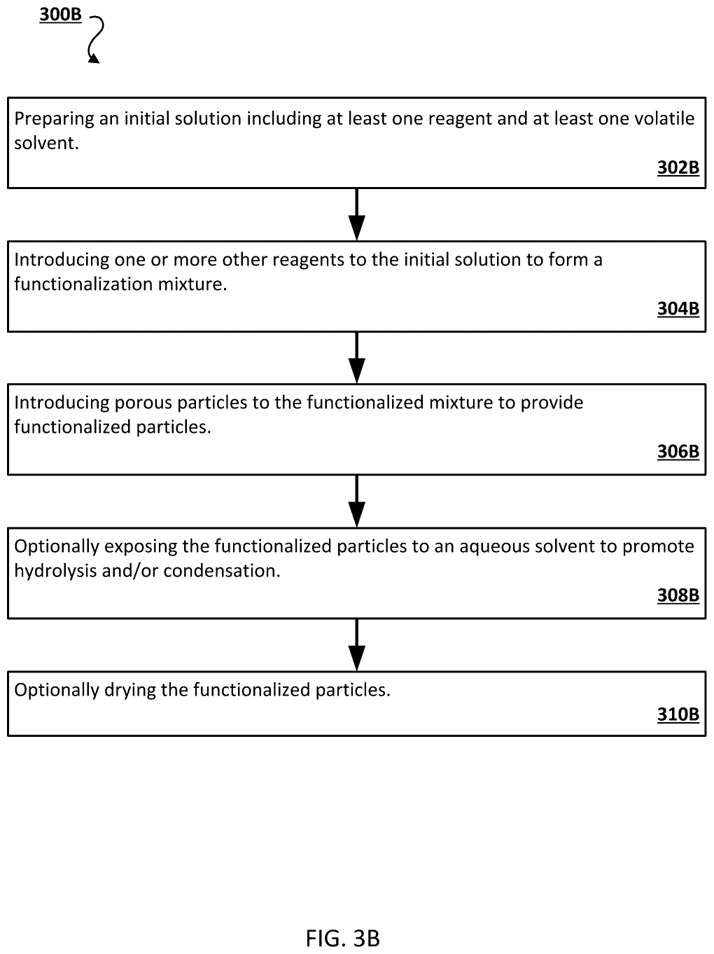

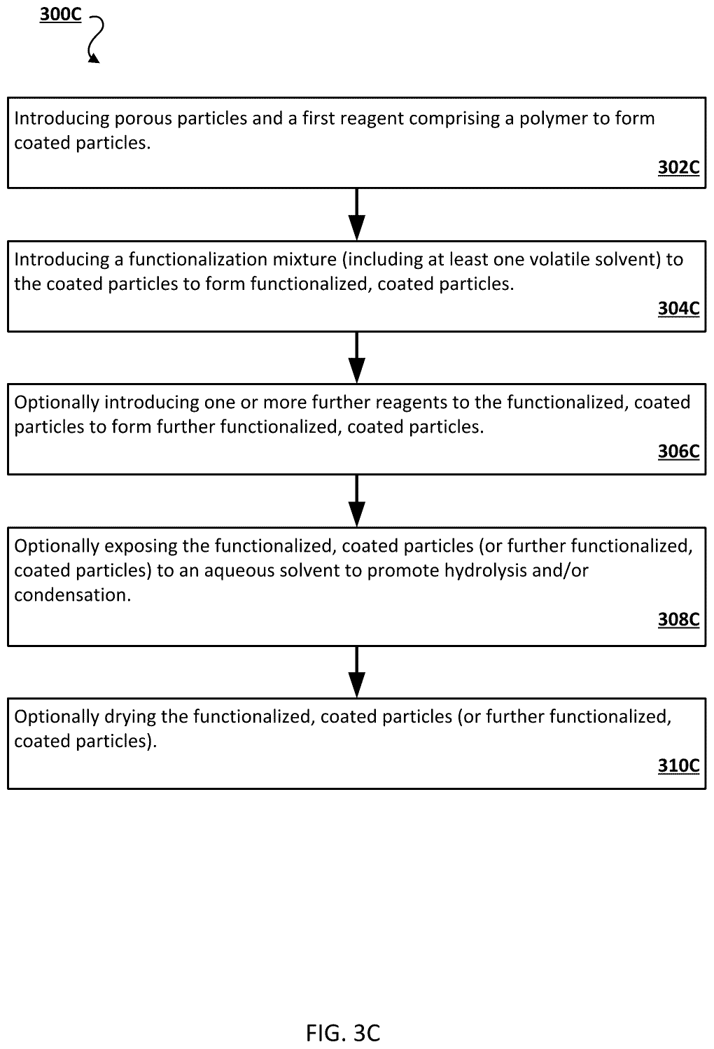

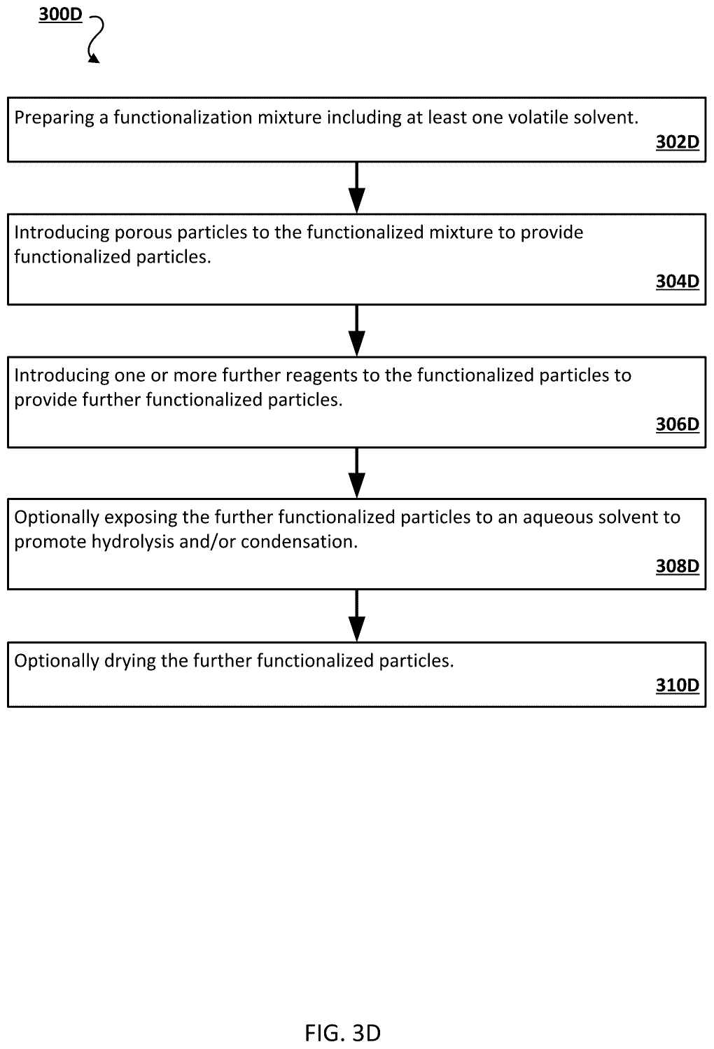

As non-limiting examples, FIGS. 2D-2G indicate examples of aminosilanes having side groups and amine moieties. In some embodiments, the aminosilane is an alkylalkoxyaminosilane having a formula of R^{A}(Ak)cSi(OAk)d, in which each of c and d can be 1 or 2; R^{A} is an amine moiety (e.g., any described herein); and each of Ak is, independently, an optionally substituted alkyl. Non-limiting examples of alkylalkoxyaminosilane include 3-aminopropyl(diethoxy)methylsilane (FIG. 2D) and 3-(ethoxydimethylsilyl)propylamine (FIG. 2E).

In some embodiments, the aminosilane is an aminosilanetriol having a formula of (HO)₃SiR^{A}, in which R^{A} is an amine moiety (e.g., any described herein). A non-limiting example of aminosilanetriol is (3-((2-aminoethyl)amino)propyl)silanetriol (FIG. 2F).

In some embodiments, the aminosilane is a haloaminosilane having a formula of (R^{A})₃SiX, in which each R^{A} is, independently, an amine moiety (e.g., any described herein) and X is halo (e.g., any described herein). Non-limiting examples of haloaminosilane include tris(dimethylamino)chlorosilane (FIG. 2G), tris(ethylmethylamino)chlorosilane, and the like.

Other non-limiting examples of aminosilanes include (3-aminopropyl) trimethoxysilane, (3-aminopropyl)triethoxysilane, 3-aminopropyl(diethoxy)methylsilane, [3-(2-aminoethylamino)propyl]trimethoxysilane, N-(2-aminoethyl)-3-aminopropyl silanetriol, N-[3-(trimethoxysilyl)propyl]ethylenediamine (N-3-TPE), N1-(3-trimethoxysilylpropyl)diethylenetriamine, 3-aminopropylsilanetriol, tris(ethylmethylamino) chlorosilane, tris(dimethylamino)chlorosilane, bis(3-(methylamino) propyl)trimethoxysilane, bis[3-(trimethoxysilyl)propyl]amine, N-[3-(trimethoxysilyl)propyl]aniline, (N,N-dimethylaminopropyl)trimethoxysilane, or an aminosilane oligomer (e.g., such as VPS SIVO 280, a modified organofunctional polysiloxane from Evonik Industries AG, Essen, Germany).

Further embodiments for functional portions contemplated for use in the present disclosure, including but not limited to aminosilanes, are further disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

b. Silanes

In some embodiments, a silane compound includes any compound having a —SiR^{S1}R^{S2}R^{S3} moiety or a —SiR^{S1}R^{S2}— moiety, in which each of R^{S1}, R^{S2}, and R^{S3} is any described herein. In some embodiments, each of R^{S1}, R^{S2}, and R^{S3} is, independently, H, optionally substituted aliphatic, alkyl, heteroaliphatic, heteroalkyl, aromatic, aryl, amine, or others described herein; or R^{S1} and R^{S2}, taken together with the silicon atom to which each are attached, form a heterocyclyl group. In some embodiments, each of R^{S1}, R^{S2}, and R^{S3} is, independently, hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl).

In some embodiments, the silane includes one or more amino moieties, such as in an aminosilane compound (e.g., any described herein).

In some embodiments, the silane does not include an amino moiety. In one non-limiting example, the silane includes a structure having formula (IV):

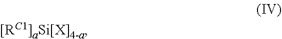

wherein each R^{C1} does not comprise amino; each X is, independently, a side group, a reactive group, or a leaving group (e.g., any described herein); and a is an integer from 1 to 4.

In some embodiments, R^{C1} is optionally substituted aliphatic, heteroaliphatic, alkyl, aromatic, heteroaromatic, or aryl, wherein the optional substituent is not amino (e.g., as defined herein). In some embodiments, R^{C1} is a branched, optionally substituted aliphatic, heteroaliphatic, alkyl, aromatic, heteroaromatic, or aryl. In some embodiments, R^{C1} is a hydrophobic group (e.g., optionally substituted C₄₋₃₀ aliphatic, heteroaliphatic, alkyl, perfluoroalkyl, cycloalkyl, aromatic, heteroaromatic, or aryl). Non-limiting examples of hydrophobic groups include optionally substituted C₄₋₂₄, C₆₋₂₄, C₈₋₂₄, C₄₋₁₈, C₆₋₁₈, C₈₋₁₈ alkyl, haloalkyl, perfluoroalkyl, cycloalkyl, and the like (e.g., hexyl, octyl, nonyl, decyl, dodecyl, perfluorohexyl, perfluorooctyl, cyclohexyl, and cyclopentyl).

In some embodiments, the silane includes a structure having formula (IVa):

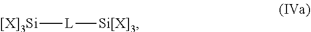

wherein L is a linker (e.g., any described herein) and each X is, independently, a side group, a reactive group, or a leaving group (e.g., any described herein).

Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. Other examples of linkers include any described herein (e.g., described herein for L, L¹, L², and L³).

The silane can include a reactive group, a leaving group, or another group (e.g., X). Non-limiting examples of such groups include hydrogen (H), halo (e.g., F, Cl, Br, or I), hydroxy (e.g., —OH), optionally substituted alkyl, optionally substituted aminoalkyl, optionally substituted hydroxyalkyl, optionally substituted alkoxy (e.g., —OR, in which R is an optionally substituted alkyl), optionally substituted aryl, optionally substituted aryloxy (e.g., —OR, in which R is an optionally substituted aryl), optionally substituted alkanoyloxy, trialkylsilyloxy (e.g., —OSi^{R3}, in which each R is independently an optionally substituted alkyl), or trialkoxylsilyloxy (e.g., —OSi[OR]₃, in which each R is independently an optionally substituted alkyl). In some embodiments, X is, independently, H, optionally substituted aliphatic, optionally substituted heteroaliphatic, optionally substituted aromatic, or optionally substituted heteroaromatic.

In some embodiments, a silane can be employed as a crosslinking agent or as an additive for any composition or use herein (e.g., for any coating, surface functionalization layer, functionalization mixture, pre-functionalization mixture, and the like). Non-limiting examples of silanes include 1,2-bis(triethoxysilyl)ethane (BTESE) and 1,2-bis(trimethoxysilyl)ethane (BTME).

Further embodiments for functional portions contemplated for use in the present disclosure, including but not limited to silanes and/or silane compounds, are further disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

c. Polyamines

As described herein, in some embodiments the functional portion is provided by any useful compound or combination of compounds. In some embodiments, the compound is a polyamine. In some embodiments, the polyamine includes any compound or moiety having two or more amine moieties. In some embodiments, the polyamine is a non-polymeric compound, in which the polyamine does not include repeating units. In some embodiments, the polyamine is a polymeric compound (e.g., as in a polymeric polyamine). In other embodiments, the polyamine is an oligomeric compound (e.g., as in an oligomeric polyamine). Unless otherwise specified, discussion related to “polymeric” and “oligomeric” forms of compounds is applied interchangeably. In some embodiments, the polyamine includes dimeric, trimeric, tetrameric, pentameric, hexameric, and higher order amines. In some embodiments, the polyamine is a small molecule polyamine (e.g., having a molecular weight between 100 g/mol and 800 g/mol). In some embodiments, the polyamine is a large molecule polyamine (e.g., having a MW greater than 800 g/mol).

Without wishing to be limited by mechanism, high MW amines may be useful for their lower volatility (e.g., as compared to low MW amines). Higher MW polyamines can be characterized by a higher viscosity, which may make handling more difficult. Higher MW polyamines are generally more expensive. In some non-limiting embodiments, polyamines with high relative concentrations of primary and secondary amine moieties can be employed. In some non-limiting embodiments, tertiary amine moieties may be characterized by lower performance for DAC applications and are less desired. Secondary amines have higher oxidation resistance equating to longer operational lifetimes. Primary amines have higher reactivity equating to higher performance at low CO₂ concentrations (DAC conditions).

The polyamine can have any useful structure. In one non-limiting example, the polyamine includes a structure having formula (IIIa) to (IIIi):

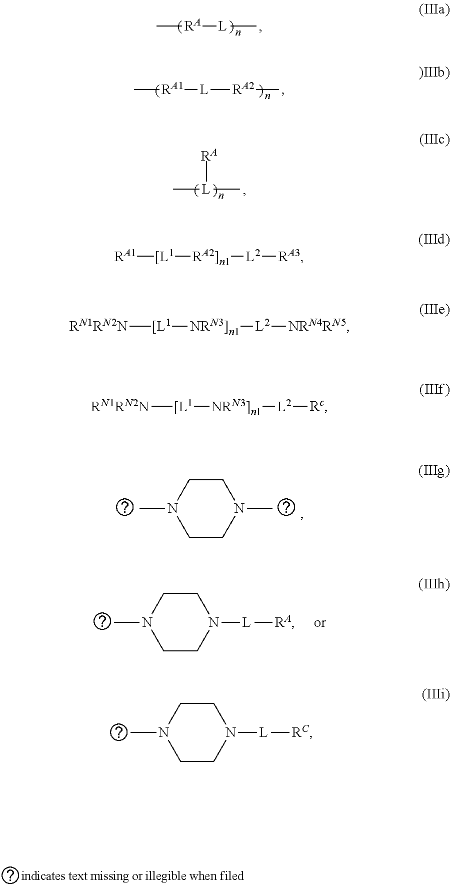

wherein each R^{A}, R^{A1}, R^{A2}, and R^{A3} is, independently, an amine moiety comprising at least one amine group; each L, L¹, or L² is, independently, a linker; each of R^{N1}, R^{N2}, R^{N3}, R^{N4}, and R^{N5} can be any described herein, optionally wherein R^{N1} and R^{N2}, taken together with the nitrogen atom to which each are attached, can form a heterocyclyl group, as defined herein or optionally wherein R^{N4} and R^{N}s, taken together with the nitrogen atom to which each are attached, can form a heterocyclyl group, as defined herein; R^{C} is hydrogen (H), halo, hydroxy, amino (e.g., —NR^{N1}R^{N2}), optionally substituted aliphatic, heteroaliphatic, alkyl, hydroxyalkyl, aromatic, heteroaromatic, or aryl; n is an integer greater than 1 (e.g., from 1-25000, 1-24000, 1-23000, 1-22000, 1-21000, 120000, 1-19000, 1-18000, 1-17000, 1-16000, 1-15000, 1-14000, 1-13000, 1-12000, 111000, 1-10000, 1-7500, 1-5000, 1-4000, 1-3000, 1-2000, 1-1000, 1-500, 1-100, 1-50, 1-20, 1-10, 1-5, 2-25000, 2-24000, 2-23000, 2-22000, 2-21000, 2-20000, 2-19000, 218000, 2-17000, 2-16000, 2-15000, 2-14000, 2-13000, 2-12000, 2-11000, 2-10000, 27500, 2-5000, 2-4000, 2-3000, 2-2000, 2-1000, 2-500, 2-100, 2-50, 2-20, 2-10, 2-5, 525000, 5-24000, 5-23000, 5-22000, 5-21000, 5-20000, 5-19000, 5-18000, 5-17000, 516000, 5-15000, 5-14000, 5-13000, 5-12000, 5-11000, 5-10000, 5-7500, 5-5000, 54000, 5-3000, 5-2000, 5-1000, 5-500, 5-100, 5-50, 5-20, 5-10, as well as ranges therebetween); and n1 is an integer of 1 or more (e.g., from 1-1000, 1-100, 1-50, 1-20, 1-10, 5-1000, 5-100, 5-50, 5-20, 5-10, as well as ranges therebetween). R^{A}, R^{A1}, and RA2 can be any amine moiety described herein; L, L¹, and L² can be any linker described herein; and each of R^{N1}, R^{N2}, R^{N3}, R^{N4}, and R^{N5} can be any described herein for R^{N1} or R^{N2}.

In some embodiments, R^{A}, R^{A1}, R^{A2}, or R^{A3} is or includes —NH—, —NR^{N1}—, —N(-L¹-NR^{N1}R^{N2}), —N(-L²-N(-L¹-NR^{N1}R^{N2})—, —N[-L²N(-L¹-NR^{N1}R^{N2})2], NH2, NR^{N1}R^{N2}, -L¹-NR^{N1}R^{N2}, —NR^{N3}-L¹-NR^{N1}R^{N2}, -L²-NR^{N3}-L¹-NR^{N1}R^{N2}, or —NR^{N4}-L²-NR^{N3}-L¹-NR^{N1}R^{N2}, in which each of R^{N1} and R^{N2} can be any described herein; each of R^{N3} and R^{N4} can be any described herein for R^{N1} and R^{N2}; and each of L¹ or L² is independently a linker.

Examples of linkers (e.g., for L¹, L², or L) include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some embodiments, the linker is a monomer or a polymer, which can be employed as a backbone to which an amine moiety R^{A} can be attached. Alternatively, the backbone of the polymer itself can also include an amine moiety. Non-limiting examples of monomers include a saccharide (e.g., glucosamine, N-acetyl-glucosamine, glucose, and the like), an amino acid (e.g., lysine), an alkylene, an alkenylene, an arylene, and the like. Non-limiting examples of polymers include a polysaccharide (e.g., chitosan, chitin, and the like), a polypeptide (e.g., poly(lysine)), a vinyl polymer, and the like.

Further non-limiting examples of polyamines include poly(lysine) (e.g., poly(L-lysine), poly(D-lysine), or poly(LD-lysine)), poly(ethyleneimine), poly(propyleneimine), poly(vinylamine), poly(N-methylvinylamine), poly(allylamine), poly(N-isopropyl acrylamide), poly(4-aminostyrene), chitosan, spermidine, spermine, norspermine, putrescine, cadaverine, tetraethylenepentamine (TEPA), triethylenetetramine (TETA), an ethylene amine/oligomeric mix (e.g., Amix 1000 having CAS No. 68910-05-4), diethylenetriamine (DETA), 2-(2-aminoethylamino)ethanol, ethylenediamine, piperazine, 2-piperazin-1-ylethylamine, 2-piperazin-1-ylethanol, pentaethylenehexamine, tetramethylethylenediamine, as well as salts thereof and/or copolymers thereof and/or mixtures thereof. In some embodiments, the polyamine includes spermidine, spermine, norspermine, putrescine, cadaverine, tetraethylenepentamine (TEPA), triethylenetetramine (TETA), ethanolamine, diethylenetriamine (DETA), piperazine, 2-piperazin-1-ylethylamine, 2-piperazin-1-ylethanol, pentaethylenehexamine, tetramethylethylenediamine, as well as polymeric forms thereof. In some embodiments, the ethylene amine/oligomeric mix includes one or more of the following: 2-(2-aminoethylamino)ethanol, trientine or TETA, 2,2′-iminodi(ethylamine) or DETA, 2-aminoethanol, ethylenediamine, piperazine, 2-piperazin-1-ylethylamine, and 2-piperazin-1-ylethanol.

FIGS. 2H-2K provide non-limiting, general examples of polyamine chains which can provide a polyamine. The polyamines of FIGS. 2H and 21 include repeating units composed of amine groups (e.g., —NH—, —NR^{N1}—, —NH2, or —NR^{N1}R^{N2}) and linkers. In some examples, the linker can be a carbon aliphatic —(CH₂)ₙ₋ spacer groups, in which n is an integer greater than one (e.g., an integer from 1 to 20, 1 to 10, 1 to 12, 1 to 6, etc.). FIG. 2H shows an n-propylene (—CH₂CH₂CH₂—) (C₃H₆) spacer group. FIG. 2I shows an ethylene (—CH₂CH₂—) (C₂H₄) spacer group. The polyamine has a repeating chain portion (bracketed) having a length of n active groups in the chain portion of the polymer (e.g., if n=2, there are two repeating groups in the chain portion). Other linkers can be used, such as any described herein (e.g., optionally substituted alkylene, as described herein), as well as linkers having peptidic bonds (e.g., —C(O)NH—) or glycosidic linkages. Linkers can include peptides, polysaccharides, and the like. Furthermore, the polyamine can include linear or branched structures, such as those present in linear polymers, branched polymers, block polymers, or dendrimers.

FIGS. 2H-2I depict a polyamine having a length of n active groups in the repeating chain portion. FIGS. 2H-2I also depict the repeating chain portion including two non-limiting amine groups (—N(X)—), separated by either C₃ (FIG. 2H) or C₂ (FIG. 2I) spacer groups. In NX, X can be any side group, reactive group, leaving group, or other group described herein. For example, X can be H, optionally substituted aliphatic, heteroaliphatic, aromatic, and the like. Furthermore, X can include further amine groups. Thus, in some non-limiting embodiments, X can include any R^{A} group described herein (e.g., an aminoalkyl group, an alkylaminoalkyl group, and the like). FIG. 2I depicts the amine groups extending in different orientations from the carbon chain, whereas FIG. 2H depicts the amine groups extending in similar orientations.

The polyamine can be derived from natural polymers having amine moieties. For example, FIG. 2J is an example of a poly(lysine), and FIG. 2K is an example of a natural chitosan.

d. Additional Compounds

In some embodiments, the compound is a crosslinking agent. In some embodiments, the crosslinking agent includes a structure having formula (V):

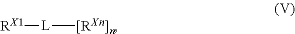

wherein each R^{X1} and R^{Xn} is, independently, a reactive group (e.g., any described herein); L is a linking moiety (e.g., any linker described herein, e.g., terephthalaldehyde); and n is an integer from 0 to 5. Upon reacting the reactive moieties with one or more amine groups in a functional material, a linking moiety L can be provided within the functional material. In some embodiments, one or more amine groups are present in the surface modification layer, and one or more linking moieties can be bound (e.g., covalently bound) to at least one of the one or more amine groups.

An example of the crosslinking agent is a dialdehyde. A dialdehyde is an organic chemical compound with two aldehyde groups. In some embodiments, the dialdehyde includes a structure having the formula (Va) or (Vb):

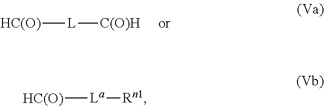

wherein L can be any described herein; Rⁿ¹ can be any described herein; and L^{a} is optionally substituted with a formyl group. In some embodiments, L^{a} is optionally substituted with one or more formyl groups. Non-limiting examples of aldehyde groups include formaldehyde, terephthalaldehyde, glutaraldehyde, and glyoxal.

Another example of the crosslinking agent is a diisocyanate. A diisocyanate is an organic chemical compound with two isocyanate groups. In some embodiments, the diisocyanate includes a structure having the formula (Vc) or (Vd):

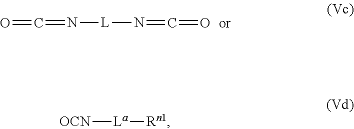

wherein L can be any described herein; Rⁿ¹ can be any described herein; and L^{a} is optionally substituted with an isocyanato group. In some embodiments, L^{a} is optionally substituted with one or more isocyanato groups. Non-limiting examples of diisocyanates include toluene diisocyanate (TDI), methylene diphenyl diisocyanate (MDI), and hexamethylene diisocyanate (HDI).

Another example of the crosslinking agent is a dihaloalkane. A dihaloalkane is an organic chemical compound with two haloalkane groups. In some embodiments, the halo groups can be provided at the terminus of the alkylene moiety. In some embodiments, the dihaloalkane includes a structure having the formula (Ve) or (Vf):

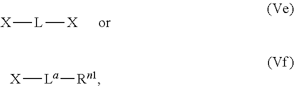

wherein L can be any described herein; each X is, independently, halo (e.g., fluorine, chlorine, bromine, or iodine); Rⁿ¹ can be any described herein; and L^{a} is optionally substituted with a halo groups. In some embodiments, L^{a} is optionally substituted with one or more halo groups. In some embodiments, L or L^{a} is optionally substituted alkylene. In some embodiments, L is unsubstituted alkylene. Non-limiting examples of dihaloalkanes include 1,4-dibromobutane, 1,2-dibromoethane, and 1,5-dibromopentane.

FIG. 2L depicts a non-limiting example of a dihaloalkane having two potential reactive groups (denoted as X) and two potential substituents (denoted as R¹ and R²).

Another example of the crosslinking agent is an epoxide, or a compound containing an optionally substituted oxiranyl functional group. An epoxide is a reactive cyclic ether. In some embodiments, the epoxide includes a structure having the formula (Vg):

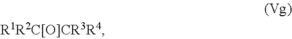

wherein each of R¹, R², R³, and R⁴ is, independently, any functional group described herein. In some embodiments, each of R¹, R², R³, and R⁴ is, independently, H, optionally substituted aliphatic, optionally substituted heteroaliphatic, optionally substituted aromatic, or optionally substituted heteroaromatic.

Another example of the crosslinking agent is a diepoxide, or a compound containing two optionally substituted oxiranyl functional groups. In some embodiments, the diepoxide includes a structure having the formula (Vh) or (Vi):

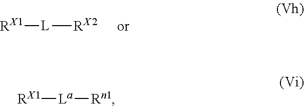

wherein L can be any described herein; each R^{X1} and R^{X2} is, optionally substituted oxiranyl; Rⁿ¹ can be any described herein; and L^{a} is optionally substituted with an optionally substituted oxiranyl group. In some embodiments, L^{a} is optionally substituted with one or more optionally substituted oxiranyl groups. Non-limiting examples of epoxides include 1,2-propylene oxide, epichlorohydrin, bisphenol A, and diglycidyl ether.

FIG. 2M depicts an example of an epoxide 220 having four potential reactive groups 222 (denoted as R¹-R⁴).

Another example of the crosslinking agent is a dianhydride. A dianhydride is an organic chemical compound with two anhydride groups. In some embodiments, each anhydride group includes two acyl groups bonded to the same oxygen atom. An example of a dianhydride is ethylenediaminetetraacetic (EDTA) dianhydride. In some embodiments, the dianhydride includes a structure having the formula (Vj) or (Vk):

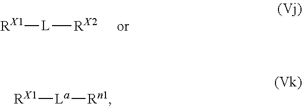

wherein L can be any described herein; each R^{X1} and R^{X2} is, an optionally substituted cyclic anhydride group; Rⁿ¹ can be any described herein; and L^{a} is optionally substituted with an optionally substituted cyclic anhydride group. In some embodiments, L^{a} is optionally substituted with one or more optionally substituted cyclic anhydride groups. Non-limiting examples of anhydrides include glutaric anhydride, succinic anhydride, and ethylenediaminetetraacetic dianhydride.

Another example of the crosslinking agent is a diacid chloride. A diacid chloride is an organic chemical compound with two chlorocarbonyl functional groups. In some embodiments, the diacid chloride includes a structure having the formula (Vi) or (Vm):

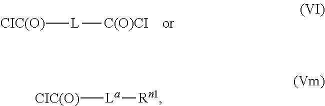

wherein L can be any described herein; Rⁿ¹ can be any described herein; and L^{a} is optionally substituted with a chlorocarbonyl group (e.g., —C(O)Cl). In some embodiments, L^{a} is optionally substituted with one or more optionally substituted chlorocarbonyl groups. Non-limiting examples of acid chlorides include succinyl chloride, glutaryl chloride, and terephthaloyl chloride.

Further non-limiting embodiments for functional portions contemplated for use in the present disclosure, including but not limited to polyamines, monoamines, and/or crosslinking agents, are disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

### II. Example Methods of Forming a Functionalized Material

Various methods can be employed to provide the functionalized materials described herein. In some embodiments, a material is produced using solution-based reaction methods in which a silane-containing compound (e.g., an aminosilane compound with an amine moiety and a silane moiety) is solvated (e.g., in one or more volatile solvents, such as any described herein), and a substrate (e.g., porous silica, MOF, or resin, which can include coated forms thereof including a polymer coating) is added. The silane moiety binds to the surface, and the amine moieties extend from the silane moiety. Optionally, one or more other compounds (e.g., one or more polyamines, polymers, crosslinking agents, chelating agents, and/or antioxidants) are present in the volatile solvent(s). The resultant substrate is optionally filtered from the solvent(s), optionally washed, optionally cured, and/or dried. If desired, such a material is further reacted with a polymeric/oligomeric amine compound. The mixture is stirred and then dried, thereby functionalizing the substrate with both the silane-containing compound and the polymeric/oligomeric amine.

In other embodiments, a functionalized material is produced using solvent-based reaction methods in which a polyamine (e.g., a compound with a plurality of amine moieties) or an oligomeric ethylene amine compound (e.g., a compound with a plurality of ethylene groups and amine moieties, as well as mixtures of such compounds, including any described herein) with an optional aminosilane compound (e.g., a compound with an amine moiety and a silane moiety) is solvated (e.g., in one or more volatile solvents, such as any described herein), and a substrate (e.g., porous silica, MOF, or resin, which can include coated forms thereof including a polymer coating) is added. When polyamine is used alone, in some embodiments, the polyamine has an increased number of amine moieties for increased carbon capture (e.g., >2 mol/kg) in the functionalized material. When both a polyamine and an aminosilane is employed, the polyamine and aminosilane compounds react to form a complex network, which in turn is bonded to a surface of the substrate. When the oligomeric ethylene amine compound or mixture thereof is used alone, in some embodiments, the oligomeric ethylene amine compound or a mixture thereof has an increased number of amine moieties for increased carbon capture (e.g., >1 mol/kg) in the functionalized material. Optionally, one or more other compounds (e.g., one or more aminosilanes, silanes, polymers, crosslinking agents, chelating agents, and/or antioxidants) are present in the volatile solvent(s). The resulting material is stirred, optionally filtered from the solvent(s), optionally washed, optionally cured, and/or dried.

In some embodiments, the functionalized material is obtained after being introduced to a functionalization mixture (e.g., any described herein, including one or more compounds selected from a reagent including an adsorbing moiety, a reagent including an interaction moiety, a reagent including a polymer, a crosslinking agent, a chelating agent, and/or an antioxidant) including at least one volatile solvent (e.g., any described herein). In some embodiments, the functionalized material is further processed. For example and without limitation, in some embodiments, the process includes exposing the functionalized material (e.g., plurality of functionalized particles, further functionalized particles, or functionalized, coated particles) to an aqueous solvent to promote hydrolysis and/or condensation. The aqueous solvent includes, e.g., water. In some embodiments, hydrolysis and/or condensation occurs at a temperature from about 25° C. to 80° C., e.g., 70° C. In some embodiments, hydrolysis and/or condensation occur in the presence of from about 10% to 30% (wt/wt) of the aqueous solvent to the functional material (e.g., plurality of functionalized particles, further functionalized particles, or functionalized, coated particles). In some embodiments, the hydration and temperature are maintained for a time period, e.g., from 30 to 120 minutes, e.g., 60 minutes. Hydrolysis facilitates condensation, though in some embodiments condensation is maximized upon the aqueous solvent being removed in drying.

In some embodiments, the hydrolysis and condensation occur as separate steps. In some embodiments, the condensation proceeds after aminosilane hydrolysis has occurred. In some embodiments, the hydrolysis step occurs at lower temperatures (e.g., 25° C. to 50° C.) in the presence of water. In some embodiments, the presence of organic solvent reduces the hydrolysis rate(e.g., ethanol or hexane). In some embodiments, the amount of aminosilane which completes hydrolysis varies by aminosilane based on type, molecular weight, and the leaving groups. In one example in which N-3-TPE is provided as the aminosilane, 25% wt/wt N-3-TPE to water provides complete hydrolysis.

Without being limited to any one theory of operation, in some embodiments, the presence of water after the hydrolysis step facilitates increased condensation, e.g., the aminosilane added at the condensation step is able to finish reacting once the organic solvents have been removed. The condensation step proceeds after the hydrolysis step. Without expressing limitation, in this process excess water condenses from the aminosilanes during oligomerization. The extent of the condensation reaction can depend on temperature and/or moisture content.

Without wishing to be limited by mechanism, hydrolysis and/or condensation ensures further reactions between the substrate and components of the surface modification layer, thereby reducing the formation of byproducts (e.g., methanol) that can occur upon exposure of partially reacted surface modification layers to air. In some embodiments, the material is configured to provide a methanol emission threshold of less than 10% (wt/wt) of methanol to the functionalized material (e.g., plurality of functionalized particles, further functionalized particles, or functionalized, coated particles). In some embodiments, the methanol emission threshold is less than 9%, 8%, 7%, 6%, 5%, 4%, 3%, 2%, 1%, 0.8%, 0.6%, 0.5%, 0.4%, or 0.3% (wt/wt) of methanol to the functionalized material (e.g., plurality of functionalized particles, further functionalized particles, or functionalized, coated particles).

In some embodiments, the final dry sorbent includes a low amount of volatile solvent. In some embodiments, the amount depends on the type of volatile solvent. One example of the volatile solvent is methanol. For example and without limitation, one method to measure methanol emission is headspace gas chromatography (GC). An amount of the final dry sorbent is collected (e.g., 1 g) and then water (e.g., 0.1 g) is added to facilitate hydrolysis completion. The amount of methanol released from the final sorbent is measured. In some embodiments, the methanol release is controlled to be equal to or less than 0.5% wt/wt compared to the dry sorbent. Such a threshold can produce a dry sorbent safe for shipping and usage. In general, in some embodiments, the solvant (e.g., the methanol) is ethanol, or IPA which capable of being controlled to 0.5% (wt/wt) or less. Another example of volatile solvent is hexane which is capable of being controlled to be 0.1% (wt/wt) or less.

For example and without limitation, in some embodiments, the process includes drying the functionalized material (e.g., plurality of functionalized particles, further functionalized particles, or functionalized, coated particles). In some embodiments, the material is configured to provide a hydration threshold of less than 10% (wt/wt) of water to the functionalized material (e.g., plurality of functionalized particles, further functionalized particles, or functionalized, coated particles). In some embodiments, the hydration threshold is less than 10%, 9%, 8%, 7%, 6%, 5%, 4%, 3%, 2%, 1%, or 0.5% (wt/wt) of water to the functionalized material (e.g., plurality of functionalized particles, further functionalized particles, or functionalized, coated particles). In some embodiments, the process includes exposing the plurality of functionalized particles to an aqueous solvent thereby causing hydrolysis or condensation, and/or drying the plurality of functionalized particles until a hydration threshold of less than 10% (wt/wt) of water to the plurality of functionalized particles is reached.

In some embodiments, any of the methods disclosed herein (e.g., such as the process in FIGS. 3A-3D) provides any functionalized material described herein (e.g., a functionalized material 100A-100G in FIGS. 1A-1G).

FIGS. 3A-3D are non-limiting flow chart diagrams showing examples of steps for producing a functionalized material. These diagrams are further described below.

As seen in FIG. 3A, a non-limiting process 300A for making functionalized material includes functionalizing a particle to provide a functionalized particle (e.g., for use in a reversible adsorbent material, such as a reversible CO₂ adsorbent). In some implementations, the process 300A is performed at large scale, e.g., producing 1 kilogram or more of functionalized material in a single process. In some implementations, process 300A includes preparing a functionalization mixture including at least one volatile solvent (step 302A).

In some embodiments, the functionalization mixture includes two or more volatile solvents. In some embodiments, volatile solvents include any described herein, such as, e.g., an alcohol, an alkane, other described herein, as well as combinations thereof.

In some embodiments, the process 300A further includes introducing porous particles (e.g., porous silica particles) to the functionalization mixture to provide functionalized particles (e.g., functionalized porous silica particles) (step 306A). In some embodiments, the porous particles are provided by particle 102A-G of FIG. 1A-1G. In some embodiments, the solvent(s) for the functionalization mixture solvate the reagents and provide the dissolved molecules to the porous particles. The dissolved molecules adsorb to the surfaces and pores of the particles to form functionalized particles.

In one non-limiting embodiment, creating the functionalization mixture includes introducing a reagent including a polyamine into a first volume including a first solvent (e.g., a first volatile solvent, such as an alcohol, an alkane, or others described herein); introducing a reagent comprising a silane moiety and an optional amine functional group (e.g., a silane and/or an aminosilane) into a second volume including a second solvent (e.g., a second volatile solvent, such as an alcohol, an alkane, or others described herein); and then combining the first and second volumes. In some embodiments, the first and second volatile solvents are the same or different. In one non-limiting embodiment, creating the functionalization mixture includes introducing a reagent including a polyamine into a first volume including a reagent comprising a silane moiety and an optional amine functional group (e.g., a silane and/or an aminosilane); then introducing a second volume including a first solvent (e.g., a first volatile solvent, such as an alcohol, an alkane, or others described herein) to the first volume; and then introducing a third volume including a second solvent (e.g., a second volatile solvent, such as an alcohol, an alkane, or others described herein) to the combined first and second volumes. In some embodiments, the first and second volatile solvents are the same or different.

In some embodiments, the first and second volatile solvents comprise an organic solvent for some cases. In some embodiments, the volatile solvent is selected such that the polymer used to coat the particles is not miscible in the volatile solvent, thereby minimizing removal of the protective polymer coating from the coated particles while introducing the polyamine and aminosilane. As used herein, a reagent and a compound can be used interchangeably. Depending on use, in some embodiments, a reagent optionally includes one or more solvents, salts, or other compounds. In one example, the first solvent is a volatile solvent (e.g., an alcohol, such as isopropanol), and the second solvent is another volatile solvent (e.g., an aliphatic hydrocarbon, such as an alkane, including hexane or others). While an example of a functionalization mixture includes a polyamine and an aminosilane, in some embodiments, any useful combination of compounds is employed (e.g., any combination of one or more of an aminosilane, a silane, a polyamine that can include non-polymeric or polymeric amines, a monoamine, and the like).

In some embodiments, the reagent(s) and solvent(s) are dispensed and mixed in any useful manner to form a functionalization mixture. In turn, the mixture is dispensed to entirely cover the substrate within the vessel, for example, by dispensing from 1 to 15 mL/g of the solvent to the substrate (e.g., 1 mL/g, 5 mL/g, 8 mL/g, 15 mL/g, 2 to 2 mL/g, 2 to 2.5 mL/g, or other ranges herein). The functionalization mixture comprises, in some implementations, any described herein.

In some embodiments, the functionalization mixture (e.g., a reagent of the one or more reagents) includes an adsorbing moiety material, including one or more adsorbing moieties (e.g., one or more amine moieties, such as any described herein, including an aminosilane or a polyamine). In some embodiments, the adsorbing moiety material is dispensed in a range between 20% (wt/wt) to 80% (wt/wt) of a loading material to the substrate to be functionalized in step 306A (e.g., 25% (wt/wt), 30% (wt/wt), 35% (wt/wt), 45% (wt/wt), 50% (wt/wt), or 60% (wt/wt)). In some embodiments, the at least one adsorbing moiety comprises an aminosilane having one of formulas (I), (Ia)-(If), (II), and (IIa)-(IId). In some embodiments, the at least one adsorbing moiety comprises an aminosilane having at least one amino moiety and at least one silane moiety, and the at least one silane moiety comprises an alkoxysilane moiety, a trihalosilane moiety, a dihalosilane moiety, a monohalosilane moiety, a silanetriol moiety, a dialkoxysilanol moiety, a monoalkoxysilanol moiety, or an aminosilane oligomer. In some embodiments, the at least one adsorbing moiety comprises a linear polyamine or a branched polyamine. In some embodiments, the at least one adsorbing moiety comprises a structure having one of formulas (IIIa)-(IIIi). In some embodiments, the reagent comprising the at least one adsorbing moiety is present in a range from 20% to 80% (wt/wt) of the reagent comprising the at least one adsorbing moiety to the functionalization mixture, and/or the reagent comprising the at least one adsorbing moiety is present in a range from 5% to 25% (wt/wt) of the reagent comprising the at least one adsorbing moiety to the plurality of porous particles.

In some embodiments, the functionalization mixture includes at least one interaction moiety. In some embodiments, the functionalization material comprises a silane coupling material, including a silane moiety (e.g., as in an aminosilane or a silane, such as any described herein). In some embodiments, the silane coupling material is dispensed in a range between 20% (wt/wt) to 80% (wt/wt) of a loading silane to the substrate to be functionalized in step 306A (e.g., 25% (wt/wt), 30% (wt/wt), 35% (wt/wt), 45% (wt/wt), 50% (wt/wt), or 60% (wt/wt)). In some embodiments, the interaction moiety comprises an aminosilane or a silane. In some embodiments, the interaction moiety comprises a structure having one of formulas (I), (Ia)-(If), (II), and (IIa)-(IId). In some embodiments, the interaction moiety comprises a structure having formula (IV) or (IVa). In some embodiments, the reagent comprising the at least one interaction moiety is present in a range from 20% to 80% (wt/wt) of the reagent comprising the at least one interaction moiety to the functionalization mixture, and/or the reagent comprising the at least one interaction moiety is present in a range from 20% to 80% (wt/wt) of the reagent comprising the at least one interaction moiety to the plurality of porous particles.

In some embodiments, the functionalization mixture includes a polyamine. For example, in some embodiments, the one or more solvent(s) is dispensed to fully suspend the polyamine, for example, by dispensing 20 mL/g of the solvent(s) to polyamine (e.g., 10 mL/g, 15 mL/g, or 25 mL/g). In some embodiments, the polyamine is added to the solvent(s) in a range from 5% (wt/wt) to 60% (wt/wt) of the substrate to be functionalized in step 306A (e.g., 6% (wt/wt), 8% (wt/wt), 10% (wt/wt), 12% (wt/wt), 14% (wt/wt), 16% (wt/wt), or 18% (wt/wt), 20% (wt/wt), 30% (wt/wt), 40% (wt/wt), or 50% (wt/wt)). Alternatively, the solvent(s) is dispensed to entirely cover the substrate within the vessel, for example, by dispensing from 1 to 15 mL/g of the solvent to the substrate (e.g., 1 mL/g, 5 mL/g, 8 mL/g, 15 mL/g, 2 to 2 mL/g, 2 to 2.5 mL/g, or other ranges herein). In some embodiments, the solvent comprises any described herein (e.g., a neutral aprotic organic solvent, such as toluene, hexane, cyclohexane, or tetrahydrofuran (THF), as well as combinations of any of these).

In some embodiments, the functionalization mixture includes about 1% to 20% (wt/wt) of a polyamine, about 20% to 80% (wt/wt) of an aminosilane, about 0.1% to 5% (wt/wt) of a HALS compound, and optionally about 0.1% to 5% (wt/wt) of a crosslinking agent to the substrate (e.g., plurality of porous particles). In some embodiments, the functionalization mixture includes about 5% to 20% (wt/wt) of a polyamine, about 20% to 80% (wt/wt) of an aminosilane, about 0.5% to 5% (wt/wt) of a HALS compound, and optionally about 0.5% to 5% (wt/wt) of a crosslinking agent to the substrate (e.g., plurality of porous particles).

In some embodiments, the functionalization mixture includes a wt:wt ratio in a range from 1:1 to 5:1 of solvent(s) to substrate (e.g., plurality of porous particles). In some embodiments, the wt:wt ratio is in a range from 1:1 to 1.5:1 of solvent(s) to substrate (e.g., plurality of porous particles). In some embodiments, the solvent(s) include one, two, three, four, or more volatile solvents. In some embodiments, the solvent(s) include two volatile solvents. In some embodiments, the solvent(s) includes an alcohol and/or an alkane (e.g., any described herein).

In some embodiments, process 300A can optionally further include exposing the functionalized particles (e.g., functionalized porous silica particles) to an aqueous solvent to promote hydrolysis and/or condensation (step 306A). The process 300A can optionally further include drying the functionalized particles (e.g., functionalized porous silica particles) (step 310A).

As seen in FIG. 3B, in some embodiments, the process 300B includes preparing an initial solution including at least one reagent (e.g., an initial reagent of the one or more reagents) and at least one volatile solvent (e.g., an initial solvent) (step 302B) at a first time. In some embodiments, the one or more reagents is a plurality of reagents, and the process 300B further comprises introducing one or more additional reagents of the plurality of reagents to the initial solution, at a second time after the first time, to form a functionalization mixture (step 304B). For example and without limitation, if the initial solution includes a first reagent, then one or more additional reagents (e.g., same or different than the first reagent) are introduced to the initial solution to form a functionalization mixture. In another example, if the initial solution includes a first reagent and a second reagent, then one or more additional reagents (e.g., same or different than the first and second reagents) are introduced to the initial solution to form a functionalization mixture. In some embodiments, the first, second, and/or additional reagents comprise any described herein (e.g., one or more compounds, such as aminosilanes, silanes, polyamines, monoamines, polymers, crosslinking agents, chelating agents, and/or antioxidants, etc.).

In some embodiments, the one or more reagents is a plurality of reagents, the at least one volatile solvent is a plurality of volatile solvents and the method further comprises introducing one or more additional reagents of the plurality of reagents and one or more additional volatile solvents of the plurality of volatile solvents to the initial solution, after the first time, to form the functionalization mixture. Without wishing to be limited by mechanism or theory, in some embodiments, the sequence of including certain reagent(s) and solvent(s), as well as the selection of the type of reagent(s) and solvent(s), are optimized to promote solvation of the reagent in that solvent (and/or solvent mixture).

In some embodiments, the method further includes introducing an additional aliquot of the initial reagent to the initial solution, at a second time after the first time, to form the functionalization mixture. In some embodiments, the method further includes introducing an additional aliquot of the initial solvent to the initial solution, at a second time after the first time, to form the functionalization mixture. In some embodiments, the method further includes introducing an additional aliquot of the initial reagent to the initial solution, at a second time after the first time, to form the functionalization mixture, and introducing an additional aliquot of the initial volatile solvent to the initial solution, at a second time after the first time, to form the functionalization mixture.

Without wishing to be bound by any one theory of operation, in some embodiments, the sequence of addition of one or more reagents and/or solvents, including the staged or sequential introduction of additional aliquots of the same reagent and/or solvent, can influence the extent and rate of solvation of the reagent within a given solvent system. Without wishing to be bound by any one theory of operation, in some implementations, controlling the order and timing of addition allows for more favorable intermolecular interactions, reduces local supersaturation or aggregation effects, and/or facilitates more homogeneous dispersion of the reagent throughout the solvent matrix. For example, in some embodiments, pre-dissolving a portion of the reagent in a small volume of solvent, followed by incremental additions of either the reagent or solvent, enhances dissolution kinetics by maintaining optimal concentration gradients and preventing precipitation or phase separation. In some embodiments, such controlled addition techniques are advantageous when working with poorly soluble reagents, multi-component solvent systems, or formulations sensitive to concentration-dependent behavior.

In some embodiments, the additional aliquot of the reagent is added after a period sufficient to allow partial or complete dissolution of the first aliquot in the solvent or solvent mixture. In certain embodiments, the additional aliquot is added between approximately 30 seconds and 30 minutes following the addition of the first aliquot, between approximately 1 minute and 10 minutes, or between approximately 30 minutes and 5 hours. In some embodiments, the second time is at least 10 seconds, at least 30 seconds, at least 1 minute, at least 5 minutes, at least 10 minutes, at least 30 minutes, at least 1 hour, or at least 6 hours after the first time. In some embodiments, the second time is no more than 12 hours, no more than 6 hours, no more than 1 hour, no more than 30 minutes, no more than 10 minutes, no more than 1 minute, or no more than 30 seconds after the first time. In some embodiments, the second time is from 10 seconds to 1 minute, from 30 seconds to 10 minutes, from 5 minutes to 1 hour, from 30 minutes to 6 hours, or from 1 hour to 12 hours after the first time. In some embodiments, the period of time between the first time and the second time falls within another range starting no lower than 10 seconds and ending no later than 12 hours. In some embodiments, the additional aliquot is added after a period of time depending on the solubility characteristics of the reagents and/or solvents and the efficiency of mixing. In some embodiments, staged or periodic addition of reagents and/or solvents facilitates more efficient solvation by minimizing localized reagent saturation, reducing the likelihood of precipitation, and allowing more complete molecular interaction between the solvent and reagent.

In some embodiments, the process 300B further includes introducing porous particles (e.g., porous silica particles) to the functionalization mixture to provide functionalized particles (e.g., functionalized porous silica particles) (step 306B). In some embodiments, the porous particles are provided by particle 102A-G of FIG. 1A-1G. In some embodiments, the dissolved molecules of the functionalization mixture adsorb to the surfaces and pores of the particles to form functionalized particles. In some embodiments, any introducing operations described herein (e.g., as described herein for step 304A) are implemented in step 306B. In some embodiments, the introducing operation includes a batch process, a spraying process, a wetting process, a dip coating process, or a combination of any of these.

In some embodiments, the process 300B optionally further includes exposing the functionalized particles (e.g., functionalized porous silica particles) to an aqueous solvent to promote hydrolysis and/or condensation (step 306B) and/or drying the functionalized particles (e.g., functionalized porous silica particles) (step 310B). Further details on hydrolysis, condensation, and drying operations are described herein.

In some embodiments, the method further includes, after the creating the plurality of functionalized particles: introducing one or more further reagents to the plurality of functionalized particles to provide further functionalized particles, where the one or more further reagents is same or different than the one or more reagents of the functionalization mixture. In some embodiments, each further reagent of the one or more further reagents is selected from the group consisting of: the at least one adsorbing moiety, the at least one interaction moiety, and one or more of the polymer, the crosslinking agent, the chelating agent, and the antioxidant.

In some embodiments, at least one of the plurality of porous particles comprises a coated particle. As seen in FIG. 3C, in some embodiments, the process 300C includes introducing porous particles (e.g., porous silica particles) to a first reagent including a polymer to provide a plurality of coated particles (step 302C). In some embodiments, the method further includes, prior to said introducing the plurality of porous particles to the functionalization mixture, introducing the plurality of porous particles to a polymer to form a plurality of coated particles, where the plurality of coated particles is employed as the plurality of porous particles during said introducing the plurality of porous particles to the functionalization mixture.

In some embodiments, the one or more reagents of the functionalization mixture comprises the polymer. In some embodiments, the polymer is poly(vinyl alcohol) (PVA). In some embodiments, the polymer is present in a range from 0% to 20% (wt/wt) of the polymer to the functionalization mixture, or wherein the polymer is present in a range from 0% to 20% (wt/wt) of the polymer to the plurality of porous particles.

In some embodiments, the porous particles can be provided by particle 102A-G of FIG. 1A-1G. A solvent into which the porous particles and the polymer are introduced can solvate the polymer and optional compounds (e.g., optional crosslinking agents, chelating agents, and/or antioxidants) into a coating liquid and provide the dissolved molecules to the porous particles. The dissolved molecules adsorb to the surfaces and pores of the particles to form coated particles.

In some embodiments, the solvent(s) for step 302C depends on the polymer to be suspended. Using the example polymer provided herein, PVA is water-soluble and therefore an example of the solvent is water. In some embodiments, other solvents are selected based on the criteria of the polymer which creates the protective coating.

In an example, the process 300C is a ‘wet’ method, such as dip-coating, in which the volume of solvent(s) is much larger than the volume of liquid the porous particles are capable of absorbing. In the example, the porous particles are introduced to the polymer in the solvent(s) such that the particles are fully submerged in the solvent and at a wt:wt ratio in a range from 1:1 to 4:1 of solvent(s) to substrate (e.g., porous particles). In some embodiments, such processes are employed during coating (e.g., step 302C) and/or functionalization (e.g., steps 304C-D, 306A-D).

In an example of a batch method, the polymer is introduced to the solvent(s) at a ratio sufficient that the polymer is fully dissolved in the solvent(s), e.g., no precipitation occurs, no precipitant is present. In some embodiments, the quantity of polymer introduced to the solvent is sufficient to coat the quantity of particles to be coated in the process 300C to achieve the desired characteristics described herein. In the example of PVA (or any other polymer), the polymer is introduced in a (wt/wt) percentage of up to 20% of the polymer to the substrate (e.g., porous particles), such as, e.g., up to 15% (wt/wt), up to 12% (wt/wt), up to 10% (wt/wt), up to 8% (wt/wt), less than 12% (wt/wt), or less than 9% (wt/wt). In some embodiments, the polymer is introduced (e.g., to a first solvent) in a (wt/wt) percentage from about 1% to 20% (wt/wt) of the polymer to the substrate (e.g., from about 1% to 5%, 1% to 10%, 1% to 15%, 3% to 5%, 3% to 10%, 3% to 15%, 3% to 20%, 5% to 10%, 5% to 15%, 5% to 20%, 7% to 10%, 7% to 15%, 7% to 20%, 10% to 15%, 10% to 20%, 13% to 15%, 13% to 20%, or 15% to 20% (wt/wt)). In some embodiments, such processes are employed during coating (e.g., step 302C) and/or functionalization (e.g., steps 304C-D, 306A-D).

In some embodiments, the introducing the plurality of porous particles to the functionalization mixture comprises spraying the functionalization mixture over the plurality of porous particles. In some embodiments, for example, the process 300C is a spray method in which the volume of solvent(s) is similar to the volume of liquid the porous particles are capable of absorbing. In such an example, the solvent(s) is introduced to the particles such that the particles are ‘wetted’ by the solvent(s) and at a wt:wt ratio in a range from 0.2:1 to 15:1 of solvent(s) to substrate (e.g., porous particles). In examples in which a spray method is used, the solvent(s) and/or other additives (e.g., polymer materials, crosslinking agent, chelating agents, antioxidants) are sprayed in single, or multiple steps, alone, or in combinations in which the solubility and/or reactivity of the agents/solvents are compatible. In one example, PVA and other additives, if present, are sprayed on in a first step. Then, the sorbent is dried and subsequently sprayed with one or more additives (e.g., PEI, aminosilane, antioxidant, and crosslinking agent) in the same, or different, solvent (e.g., any described herein, such as one or more volatile solvents). In some embodiments, such processes are employed during coating (e.g., step 302C) and/or functionalization (e.g., steps 304C-D, 306A-D).

In some embodiments, the process 300C includes introducing an optional crosslinking agent, an optional chelating agent, and an optional antioxidant. Such optional reagents can be provided with the polymer (e.g., in step 302C), with the functionalization mixture (e.g., in step 304C), or within the functionalization mixture (e.g., in step 304C). In some embodiments, the process 300C includes introducing a functionalization mixture to the coated particles (e.g., coated silica particles), thereby providing a plurality of functionalized, coated particles (step 304C).

In some embodiments, the one or more reagents of the functionalization mixture comprises the crosslinking agent. In some embodiments, the crosslinking agent is a multivalent crosslinking agent. In some embodiments, the multivalent crosslinking agent comprises a structure of formula (V). In some embodiments, the multivalent crosslinking agent is a bivalent crosslinking agent comprising a structure having one of formulas (Va)-(Vm). In some embodiments, the crosslinking agent is present in a range of at least 15% (wt/wt) of the crosslinking agent to the functionalization mixture, and/or the crosslinking agent is present in a range of at least 15% (wt/wt) of the crosslinking agent to the plurality of porous particles. In some embodiments, the one or more reagents of the functionalization mixture comprises the chelating agent. In some embodiments, the chelating agent comprises a phosphate-based chelator or a phosphonate-based chelator. In some embodiments, the chelating agent is present in a range of at least 5% (wt/wt) of the chelating agent to the functionalization mixture, and/or the chelating agent is present in a range of at least 5% (wt/wt) of the chelating agent to the plurality of porous particles. In some embodiments, the one or more reagents of the functionalization mixture comprises the antioxidant. In some embodiments, the antioxidant comprises a cyclic antioxidant, a hindered amine light stabilizer, and/or an organic sulfur-containing compound. In some embodiments, the antioxidant is present in a range of at least 5% (wt/wt) of the antioxidant to the functionalization mixture, and/or the antioxidant is present in a range of at least 5% (wt/wt) of the antioxidant to the plurality of porous particles. In some embodiments, the one or more reagents of the functionalization mixture further comprises additive, a hydrophobic silane compound, or a hydrophobic polymer.

In some embodiments, introducing the reagent including at least one adsorbing moiety (e.g., an aminosilane, a polyamine, a monoamine, etc.) and the reagent including at least one interaction moiety (e.g., an aminosilane, a silane, etc.) functionalizes the surfaces and pores of the coated particles with an adsorbing moiety (e.g., one or more amine moieties provided by a compound, such as an amine, an aminosilane, a polyamine, a monoamine, and the like) and an interaction moiety (e.g., a silane moiety provided by a compound, such as a silane, an aminosilane, and the like). In some embodiments, use of one or more volatile solvents allows for removal of residual solvent after such moieties are provided to the surface of the substrate. When a coated substrate is employed, this also generates the plurality of functionalized, coated particles for adsorbing CO₂. In some embodiments, one or more reagents including at least one adsorbing moiety (e.g., an aminosilane, a polyamine, a monoamine, etc.) and/or one or more reagents including at least one interaction moiety (e.g., an aminosilane, a silane, etc.) are provided during preparation of an initial solution (e.g., step 302B), preparation of a functionalization mixture (e.g., step 302A, 302D, 304B), coating (e.g., step 302C), or functionalization (e.g., steps 304C-D, 306A-D).

In some embodiments, introducing the crosslinking agent reacts with one or more amine functional groups to turn primary amine groups to secondary amine groups, and secondary amine groups to tertiary amine groups. For antioxidant resistance, a tertiary amine has higher resistance to oxidation than a secondary amine, which has higher resistance to oxidation than a primary amine. Therefore, in some embodiments, crosslinking turns crosslinked amine groups into more oxidization-resistant species of amine groups, thus increasing the chemical lifetime of the functionalized material. Examples of crosslinking agents include, but are not limited to, diisocyanates, formaldehyde, dialdehydes, boric acid, isocyanates, dihaloalkanes, diepoxides, dianhydrides (EDTA), dianhydride, or diacid chlorides. In some embodiments, one or more crosslinking agents are provided during preparation of an initial solution (e.g., step 302B), preparation of a functionalization mixture (e.g., step 302A, 302D, 304B), coating (e.g., step 302C), or functionalization (e.g., steps 304C-D, 306A-D).

In examples in which PEI is present on the functionalized material, crosslinking binds the amine groups on PEI which increases the stability of PEI binding and reduces evaporation during the adsorption/desorption processes, thus reducing the chance of amine loss during use and increasing the functional lifetime of the functionalized material.

In some embodiments, introducing the chelating agent(s) provides compounds to interact with metals present on the surface or pores of the substrate, which in turn can reduce potential oxidation of the functionalized particles, thereby increasing the chemical lifetime for the functionalized particles to adsorb CO₂. In some embodiments, one or more chelating agent(s) are provided during preparation of an initial solution (e.g., step 302B), preparation of a functionalization mixture (e.g., step 302A, 302D, 304B), coating (e.g., step 302C), or functionalization (e.g., steps 304C-D, 306A-D).

In some embodiments, introducing the antioxidant(s) provides compounds to scavenge oxygen or other oxidative species, which in turn results in reduced oxidation of amine-containing functional groups of the adsorbing species. In some embodiments, one or more antioxidants are provided during preparation of an initial solution (e.g., step 302B), preparation of a functionalization mixture (e.g., step 302A, 302D, 304B), coating (e.g., step 302C), or functionalization (e.g., steps 304C-D, 306A-D).

In some embodiments, the reagent(s) and solvent(s) are dispensed and mixed in any useful manner to form a coating liquid (e.g., including a polymer used to form the coated particles) or to form a functionalization mixture (e.g., including reagents used to form the surface modification layer of the functionalized particles). For example, in some embodiments, one or more solvent(s) are dispensed to fully suspend the polyamine, for example, by dispensing 20 mL/g of the solvent(s) to polyamine (e.g., 10 mL/g, 15 mL/g, or 25 mL/g). In some embodiments, the polyamine is added to the solvent(s) in a range from 5% (wt/wt) to 60% (wt/wt) of the substrate to be functionalized in step 304C (e.g., 6% (wt/wt), 8% (wt/wt), 10% (wt/wt), 12% (wt/wt), 14% (wt/wt), 16% (wt/wt), or 18% (wt/wt), 20% (wt/wt), 30% (wt/wt), 40% (wt/wt), or 50% (wt/wt)). Alternatively, in some embodiments, the solvent(s) is dispensed to entirely cover the substrate within the vessel, for example, by dispensing from 1 to 15 mL/g of the solvent to the substrate (e.g., 1 mL/g, 5 mL/g, 8 mL/g, 15 mL/g, 2 to 2 mL/g, 2 to 2.5 mL/g, or other ranges herein). In some embodiments, the solvent is any described herein (e.g., a neutral aprotic organic solvent, such as toluene, hexane, cyclohexane, or tetrahydrofuran (THF), as well as combinations of any of these).

In some embodiments, the coating liquid includes about 1% to 20% (wt/wt) of a polymer and about 0.1% to 5% (wt/wt) of a chelating agent to the substrate (e.g., plurality of porous particles). In some embodiments, the functionalization mixture includes about 5% to 20% (wt/wt) of a polymer and about 0.5% to 5% (wt/wt) of a chelating agent to the substrate (e.g., plurality of porous particles).

In some embodiments, the coating liquid includes a wt:wt ratio in a range from 1:1 to 5:1 of solvent(s) to substrate (e.g., plurality of porous particles). In some embodiments, the wt:wt ratio is in a range from 1:1 to 2:1 of solvent(s) to substrate (e.g., plurality of porous particles). In some embodiments, the solvent(s) include one, two, three, four, or more volatile solvents. In some embodiments, the solvent(s) include one volatile solvent. In some embodiments, the solvent(s) includes water and/or an alcohol (e.g., any described herein).

In some embodiments, a reagent can be an adsorbing moiety material, including but not limited to one or more adsorbing moieties (e.g., one or more amine moieties, such as any described herein, including an aminosilane or a polyamine). In some embodiments, the adsorbing moiety material is dispensed in a range between 20% (wt/wt) to 80% (wt/wt) of a loading material to the substrate to be functionalized in step 304C (e.g., 25% (wt/wt), 30% (wt/wt), 35% (wt/wt), 45% (wt/wt), 50% (wt/wt), or 60% (wt/wt)).

In some embodiments, a reagent is a silane coupling material, including but not limited to a silane moiety (e.g., as in an aminosilane or a silane, such as any described herein). In some embodiments, the silane coupling material is dispensed in a range between 20% (wt/wt) to 80% (wt/wt) of a loading silane to the substrate to be functionalized in step 304C (e.g., 25% (wt/wt), 30% (wt/wt), 35% (wt/wt), 45% (wt/wt), 50% (wt/wt), or 60% (wt/wt)).

In some embodiments, the functionalization mixture includes about 1% to 20% (wt/wt) of a polyamine, about 20% to 80% (wt/wt) of an aminosilane, about 0.1% to 5% (wt/wt) of a HALS compound, and optionally about 0.1% to 5% (wt/wt) of a crosslinking agent to the substrate (e.g., plurality of porous particles). In some embodiments, the functionalization mixture includes about 5% to 20% (wt/wt) of a polyamine, about 20% to 80% (wt/wt) of an aminosilane, about 0.5% to 5% (wt/wt) of a HALS compound, and optionally about 0.5% to 5% (wt/wt) of a crosslinking agent to the substrate (e.g., plurality of porous particles).

In some embodiments, the functionalization mixture includes a wt:wt ratio in a range from 1:1 to 5:1 of solvent(s) to substrate (e.g., plurality of porous particles). In some embodiments, the wt:wt ratio is in a range from 1:1 to 1.5:1 of solvent(s) to substrate (e.g., plurality of porous particles). In some embodiments, the solvent(s) include one, two, three, four, or more volatile solvents. In some embodiments, the solvent(s) include two volatile solvents. In some embodiments, the solvent(s) includes an alcohol and/or an alkane (e.g., any described herein).

In some embodiments, further reagents are employed with functionalized particles. As seen in FIG. 3C, the process 300C optionally includes introducing one or more further reagents to the functionalized, coated particles to form further functionalized, coated particles (step 306C). For example and without limitation, further reagents are used to treat or otherwise process the surface modification layer provided on the functionalized, coated particles. In one non-limiting example, the surface modification layer provided on the functionalized, coated particles is further modified with a crosslinking agent to provide linking moieties within the surface modification layer. Non-limiting further reagents to form further functionalized, coated particles (e.g., as in step 306C) include the use of one or more reagents including an adsorbing moiety, reagents including an interaction moiety, a polymer, a crosslinking agent, a chelating agent, and/or an antioxidant. In some embodiments, the further reagent(s) are different or same as the reagent(s) present in the functionalization mixture (e.g., employed in step 304C).

In some embodiments, the process 300C further includes exposing the functionalized particles (e.g., functionalized porous silica particles) to an aqueous solvent to promote hydrolysis and/or condensation (step 308C) and/or drying the functionalized particles (e.g., functionalized porous silica particles) (step 310C). Further details on hydrolysis, condensation, and drying operations are described herein.

In some embodiments, further reagents are employed with functionalized particles. As seen in FIG. 3D, in some embodiments, the process 300D includes preparing a functionalization mixture including at least one volatile solvent (step 302D), introducing porous particles (e.g., porous silica particles) to the functionalized mixture to provide functionalized particles (e.g., functionalized porous silica particles) (step 304D), and introducing one or more further reagents to the functionalized particles to provide further functionalized particles (e.g., further functionalized porous silica particles) (step 306D). Further details on functionalization mixtures and preparing and using such mixtures are described herein.

As also described herein, in some embodiments, further reagents are used to treat or otherwise process the surface modification layer provided on the functionalized, coated particles. In one non-limiting example, the surface modification layer provided on the functionalized, coated particles is further modified with a crosslinking agent to provide linking moieties within the surface modification layer. In another non-limiting example, the surface modification layer provided on the functionalized, coated particles is further modified with a chelating agent to chelate the one or more metals present on the surfaces and pores of the particles to reduce oxidation of the adsorbing moieties. Non-limiting further reagents to form further functionalized, coated particles (e.g., as in step 306D) include the use of one or more reagents including an adsorbing moiety, reagents including an interaction moiety, a polymer, a crosslinking agent, a chelating agent, and/or an antioxidant. In some embodiments, the further reagent(s) are different or same as the reagent(s) present in the functionalization mixture (e.g., employed in step 304D).

In some embodiments, the process 300D further includes exposing the functionalized particles (e.g., functionalized porous silica particles) to an aqueous solvent to promote hydrolysis and/or condensation (step 308D) and/or drying the functionalized particles (e.g., functionalized porous silica particles) (step 310D). Further details on hydrolysis, condensation, and drying operations are described herein.

For any processes herein, in some embodiments, the reagent is added directly to a liquid, mixture, or suspension; or the reagent is first introduced to a solvent and then this volume can be added to a liquid, mixture, or suspension. In some embodiments, for any reagent, a solvent is selected to sufficiently dissolve the reagent. In some embodiments, the solvent is selected to sufficiently dissolve the reagent but is not miscible with components present on the substrate, thereby minimizing removal of such components from the substrate. In some embodiments, the solvent is a volatile solvent (e.g., any described herein, such as an alcohol, aliphatic hydrocarbon, alkane, etc.).

Depending on the reagent, any other optional operations may be performed. For example and without limitation, in the functionalization mixture, any useful crosslinking agent is introduced. In some embodiments, the crosslinking agent is introduced at a weight ratio of 5% or less (wt/wt) to another reagent present in the functionalization mixture (e.g., 4% or less, 3% or less, 2% or less, or 1% or less). In some embodiments, the crosslinking agent is present in an amount of about 0.1 mol % to 10 mol % of the crosslinking agent to the number of moles of amines present. In some examples, optional activation steps are performed to cause the crosslinking agent to be reactive and form the crosslinking network on the substrate and/or the surface modification layer. In some embodiments, optional steps include modulating a temperature, a pressure, an acidity, a humidity of one or more of the coating liquid, the porous particles, a reagent, or a functionalization mixture. In some embodiments, optional activation steps are specific to the crosslinking agent of the material.

In some embodiments, in processes in which the optional activation steps are performed, the crosslinking agent is brought to (or below) the gelation point, e.g., the gel point. In some embodiments, the gel point is a specific characteristic of crosslinker polymerizations that forms networks over the surface of the substrate. In some embodiments, the gel point and coating parameters to achieve the gel point, are specific to respective crosslinking agents. In some embodiments, the gel point describes the point at which the network formation is substantially complete e.g., the majority of the components have been converted to a network.

In one embodiment, the crosslinking agent is terephthalaldehyde and the crosslinking agent is applied to the substrate and dried. Then the amine-containing materials are applied to the substrate and the amines react with the terephthalaldehyde as it is heated and dried to form the crosslinked sorbent. If the crosslinked sorbent is exposed to water, less amines are removed compared to un-crosslinked sorbents as the amines are crosslinked into a network and are less soluble.

In one embodiment, the crosslinking agent is terephthalaldehyde and the crosslinking agent and the solvent is a mixture of hexane/IPA. The amine-containing materials and the crosslinking agent are mixed in the solvent. In some embodiments, some crosslinking occurs in the mixture, e.g., the mixture does not fully crosslink, though additional steps of heating and/or drying the mixture on the substrate surface completes the crosslinking reaction.

In another non-limiting example, a polymer is employed in the process. In some embodiments, the quantity of polymer introduced to the solvent(s) is sufficient to coat the quantity of particles to achieve the desired characteristics described herein. In some embodiments, if a chelating agent is desired within the polymer coating, then any useful chelating agent (e.g., any described herein) is included with the polymer.

In some embodiments, the steps of the process 300A-300D, e.g., steps 302A-C, 304B-D, 306A-D, 308A-D, and 310A-D are performed in useful combination to obtain a desired functionalized material.

In some embodiments, the process 300A-D includes one or more steps (e.g., a separate step or a step combined with another step present in the process) for introducing a crosslinking agent. In some examples, more than one crosslinking agent is introduced. In some embodiments, the crosslinking agent(s) is added during steps 302A-D, 304B-D, or 306A-D of the process 300A-D, or beforehand, or afterward.

In some embodiments, the process 300A-D includes one or more steps (e.g., a separate step or a step combined with another step present in the process) for introducing a chelating agent. In some examples, more than one chelating agent is introduced. In some embodiments, the chelating agent(s) is added during steps 302A-D, 304B-D, or 306A-D of the process 300A-D, or beforehand, or afterward.

In some embodiments, the process 300A-D includes one or more steps (e.g., a separate step or a step combined with another step present in the process) for introducing an antioxidant. Examples of antioxidants for use in the method include sacrificial antioxidants and cyclic antioxidants. In some examples, more than one antioxidant is introduced. In some embodiments, the antioxidant(s) is added during steps 302A-D, 304B-D, or 306A-D of the process 300A-D, or beforehand, or afterward.

In some embodiments, the process 300A-D includes one or more steps for washing a surface of the porous particles to minimize the presence of one or more metals. In some embodiments, washing includes the use of an acid (e.g., a dilute acid).

In some embodiments, the process 300A-D includes one or more steps for oxidizing metals present in porous particles by raising the temperature of the particles above a threshold for a duration before one or more reagents (e.g., in the functionalization mixture) are introduced. In some embodiments, metals found on the surfaces and pores of porous particles are available for oxygenation during the lifetime of the functionalized particles. In some embodiments, by raising the temperature of the porous particles, the metals are completely- or near-completely oxidized thereby reducing the effects of oxidation on the functionalized particles during carbon capture processes when the functionalized particles are exposed to atmospheric oxygen. In some embodiments, the complete oxidation of the metals present on the surface of the porous substrate help passivate the substrate to catalyzing the oxidation of the amines during operation. One non-limiting example of the temperature threshold is 300° C. (e.g., 400° C. or 500° C.). One non-limiting example of the duration is at least one hour (e.g., at least two hours, at least three hours).

In some embodiments, the temperature to which the porous silica particles are raised depends on the composition of metals which are determined to be present in the porous silica particles. Iron and copper are examples of metal contaminants which can be oxidized by raising the temperature of the porous silica particles in the presence of an oxygen-containing gas, e.g., air.

In some embodiments, the process 300A-D includes one or more steps for filtering the coated particles, functionalized particles, or both. In some embodiments, filtering is performed using methods known in the art for separating a solid phase from a liquid phase. This can include, but is not limited to, vacuum filtration, centrifugation, vacuum evaporation, or a combination of these or other methods. In some embodiments, the volume of solvent separated from the coated particles or functionalized particles is discarded, stored, or recycled.

In some embodiments, the process 300A-D includes washing the substrate, coated particles, and/or functionalized particles in at least one wash volume of fresh (e.g., a new volume) solvent medium. For example, in some embodiments, the functionalized material is immersed in a wash volume of fresh solvent medium (e.g., 40 mL of solvent for 4 g of functionalized material), in which a single wash or a plurality of washes is performed. In some embodiments, the wash solvent dissolves the silane moiety to remove moieties coated on the surface of functionalized substrate but not reacted.

In some embodiments, the process 300A-D includes exposing the coated particles and/or functionalized particles to an aqueous solvent. In some embodiments, the presence of an aqueous solvent promotes hydrolysis and/or condensation reactions within the surface modification layer or between the surface modification layer and the surface of the substrate. In some embodiments, such reactions, in turn, ensure sufficient completion of reactions, such that emission of possible byproducts (e.g., methanol) can be reduced.

In some embodiments, the process 300A-D includes one or more steps for drying the coated particles, functionalized particles, or both. In some embodiments, drying the particles includes increasing the temperature, reducing the atmospheric pressure, passing an inert dry gas over the sample, passing a heated dry gas over the sample, or a combination of these. In some embodiments, drying occurs after the particles are introduced to the coating mixture, after the particles are introduced to the functionalization mixture, or both, in order to remove substantially all of the solvent(s) entrained in or on the particles. In some embodiments, in the case of drying the enhanced particles, the coating and/or the surface modification layer are strengthened during drying.

For example, in some implementations, the functionalized material is dried in an oven (e.g., a vacuum oven) at 50° C. for 12 hours, e.g., overnight, or at 70° C. for between 5 min and 20 min. In some embodiments, drying times longer than 60 min at elevated temperatures reduce the adsorption capacity of the final product. However, the drying time is, in some implementations, scale- or condition(s)-dependent. For example, in an example implementation comprising drying under N2 or vacuum, the drying time is longer. In some examples in which batch drying is performed, even with N2 or vacuum, drying times are longer than 60 min, depending on the scale of the functionalized particles which are being dried. Alternatively, in some embodiments, the functionalized material is dried until a hydration threshold is reached. As non-limiting examples, the drying threshold is a weight lost by the sample of 15% (e.g., weight lost to solvent removal) or having minimal weight loss (e.g., a weight loss of less than about 5% over a period of about 2 hours at 100° C.) with an inert gas flow (e.g., 50 mL/min of N2 flow) through the sample (e.g., as measured on TGA)). In some implementations, the functionalized material is dried until a hydration threshold is reached, e.g., such as less than 10%, 9%, 8%, 7%, 6%, or 5% (wt/wt) solvent to material (e.g., to the plurality of porous particles, functionalized particles, further functionalized particles, coated particles, or functionalized, coated particles) remains. In some embodiments, the functionalized material is be prepared for use as a reversible sorbent material. In some implementations, drying can include use of a vacuum oven at 80° C. until a desired hydration threshold (e.g., any described herein) is reached.

In some embodiments, the sorbent particles are reused through the desorption process. For example, in some embodiments, the adsorbent is reused 100 times or more (e.g., 1000 times or more, 10000 times or more). For the desorption process, in some embodiments, the samples are heated to 70° C. or higher under vacuum for 30 min (the duration may change based on temperature and/or vacuum level). Without wishing to be limited by theory, this can facilitate release of CO₂ captured during the adsorption process, in which release CO₂ can be collected for further sequestration, described with reference to the systems for direct air capture herein. A non-limiting aspect of the desorption process includes maintaining the sorbent heated under a water vapor filled vacuum environment (e.g., >10% relative humidity). Without wishing to be limited by mechanism, this can reduce sorbent degradation.

Another aspect of the present disclosure provides a composition comprising a plurality of porous particles modified according to any of the methods disclosed herein. Another aspect of the present disclosure provides a composition comprising a plurality of functionalized particles modified according to any of the methods disclosed herein. Another aspect of the present disclosure provides a composition comprising a plurality of functionalized, coated particles modified according to any of the methods disclosed herein.

In some embodiments, the composition adsorbs carbon dioxide. In some embodiments, the composition adsorbs CO₂ per dry kilogram in a range from 0.1 mol to 2.5 mol of the composition. In some embodiments, the composition desorbs CO₂ in a temperature range between about 65° C. to 90° C. In some embodiments, the composition adsorbs CO₂ at a relative humidity in a range from 5% to 95% relative humidity.

In some embodiments, the composition has a 50% strain crush strength of at least 1.5 MPa. In some embodiments, a functionalized material as disclosed herein comprises one or more target characteristics under mechanical stresses, such as abrasion and/or crush strength. In some embodiments, the functionalized material comprises a polymer coating disposed on a surface of one or more sorbent particles and/or a substrate thereof. In some embodiments, the polymer coating decreases the attrition and/or increases a crush strength of the functionalized material according to one or more standardized testing requirements. Briefly, attrition is the propensity of a product to produce fines in the course of transportation, handling, and use. In some embodiments, the polymer coating reduces the attrition such that an attrition loss of the particles is 1% or less (e.g., 0.9% or less, 0.8% or less) as measured by ASTM D4058-96 or comparable standards by which attrition, or attrition loss, is quantified.

In some embodiments, the functionalized material is characterized by mechanical properties that include compressive strength. As used interchangeably herein, the term “X % crush strength” or “X % strain crush strength” refers to the force required to compress a solid article, such as a granule, pellet, tablet, or particulate material, to X % of its original height under a set of conditions, where X is a positive value. For instance, in some embodiments, the term “50% crush strength” refers to the force required to compress the functionalized material to 50% of its original height under controlled conditions. Without being limited to any one theory of operation, the 50% crush strength is a measure of the mechanical integrity or compressive resistance of the solid form and is indicative of its ability to withstand physical stresses during handling, transport, or processing. In some embodiments, the measurement is performed using a texture analyzer, force gauge, or mechanical testing apparatus equipped with a flat platen or compression probe.

In a standard method, a single particle or formed article is positioned on a rigid base, and a perpendicular compressive force is applied at a constant rate (e.g., 0.5 mm/s to 5 mm/s) until the height of the article is reduced by 50% relative to its initial, uncompressed height. In some embodiments, the 50% crush strength is expressed in units of force such as Newtons (N) and/or in units of force per area such as Pascals (e.g., Pa, kPa, mPA, etc.). In some embodiments, measurements are repeated on multiple samples to obtain an average value. In certain embodiments, the 50% crush strength is used as a quality control parameter or design criterion for optimizing the balance between mechanical stability and disintegration performance.

In some embodiments, the functionalized material has a 50% strain crush strength of at least 0.1 megapascals (MPa), at least 0.5 MPa, at least 1 MPa, at least 1.5 MPa, at least 2 MPa, at least 3 MPa, or at least 5 MPa. In some embodiments, the functionalized material has a 50% crush strength of no more than 10 MPa, no more than 5 MPa, no more than 3 MPa, no more than 2 MPa, no more than 1.5 MPa, no more than 1 MPa, or no more than 0.5 MPa. In some embodiments, the functionalized material has a 50% strain crush strength in a range from 0.1 to 1 MPa, from 0.5 to 3 MPa, from 1 to 5 MPa, or from 3 to 10 MPa. In some embodiments, the functionalized material has a 50% strain crush strength that falls within another range starting no lower than 0.1 MPa and ending no higher than 10 MPa. In some embodiments, the functionalized material has a 50% strain crush strength in a range from 1.5 to 3.5 MPa. In some embodiments, the functionalized material has a crush strength of at least 100 N/mm (e.g., at least 150 N/mm, at least 200 N/mm, or at least 300 N/mm).

Advantageously, in some embodiments, the functionalized material has increased mechanical durability compared to non-enhanced sorbents such as increased crush strength and resistance to abrasion, thus increasing the useful lifespan of the sorbent and reducing the production of fines and sorbent particulates.

In some embodiments, the composition further comprises a hydrophobic compound. In some embodiments, the hydrophobic compound is a hydrophobic silane compound or a hydrophobic polymer. In some embodiments, the hydrophobic compound is a hydrophobic silane compound that comprises a silane moiety and one, two, or three alkyl chains bound to the silane moiety. In some embodiments, the hydrophobic compound is polydimethylsiloxane, silicone oil, polyethylene, polytetrafluoroethylene, or polyurethane.

As used herein, the term “hydrophobic compound” refers to any chemical species that exhibits limited or negligible solubility in water or aqueous media, typically due to the absence of polar functional groups or the predominance of nonpolar hydrocarbon regions. In some embodiments, a hydrophobic compound possesses a water solubility of less than about 5 mg/mL, less than about 1 mg/mL, or less than about 0.5 mg/mL at 25° C., or a log P (octanol-water partition coefficient) greater than approximately 1.0, greater than approximately 2.0, or greater than approximately 5.0, indicating preferential solubility in nonpolar or lipophilic environments. In some embodiments, a hydrophobic compound resists hydrogen bonding with water and exhibits a characteristic of aggregation or partitioning into organic phases, emulsions, and/or lipid bilayers. Examples of hydrophobic compounds include, but are not limited to, long-chain hydrocarbons (e.g., hexadecane, squalane), fatty acids and esters (e.g., oleic acid, isopropyl myristate), steroids (e.g., cholesterol, testosterone), aromatic hydrocarbons (e.g., toluene, naphthalene), lipophilic drugs or active agents (e.g., cyclosporine, curcumin, paclitaxel), silicone oils (e.g., polydimethylsiloxane), and/or fluorinated compounds (e.g., perfluorooctane, polytetrafluoroethylene). In some embodiments, a hydrophobic compound is present in a formulation comprising one or more of emulsions, micelles, lipid-based carriers, and/or hydrophobic coatings.

In some embodiments, the functionalized material comprises one or more hydrophobic silanes and/or hydrophobic polymers. In some embodiments, the hydrophobic silane can include one, two, or three alkyl chains. In particular embodiments, the hydrophobic silane includes R¹R²R³SiX¹ or [R¹]aSi[X¹]4−a, in which each of R¹, R², and R³ is independently an optionally substituted aliphatic, alkyl, aromatic, or aryl; X¹ is a side group, a reactive group, or a leaving group (e.g., any described herein for X); and a is 1, 2, or 3. Without wishing to be limited by theory, in some embodiments, alkyl chains on the silane molecule increase the hydrophobicity of the silane molecule. When the silane molecule is bonded to the substrate, the hydrophobicity of the functionalized material is increased. Thus, the water adsorption capacity of the functionalized material is reduced, which is beneficial for some cases such as when using the sorbent in high humidity conditions.

As used herein, the term “hydrophobic polymer” refers to a polymeric material comprising nonpolar repeating units or side chains that exhibit low affinity for water and resist interaction with aqueous environments. In some embodiments, a hydrophobic polymer comprises a water uptake of less than about 20% by weight, less than about 10% by weight, less than about 5% by weight, or less than about 1% by weight, a water contact angle greater than approximately 50 degrees, greater than approximately 70 degrees, greater than approximately 90 degrees, or greater than approximately 110 degrees, or a solubility parameter indicating poor miscibility with polar solvents such as water (e.g., Hansen distance (Ra) greater than about 8 to 10 (MPa)^{1/2} and/or Hildebrand solubility parameter (Δδ) greater than about 4 (MPa)^{1/2}). In some embodiments, and without wishing to be limited to any one theory of operation, hydrophobic polymers do not readily absorb or swell in water and exhibit minimal hydrogen bonding capacity with aqueous media. Non-limiting examples of hydrophobic polymers contemplated for use include polydimethylsiloxane (PDMS), silicone oil, polyethylene, polypropylene, poly(tetrafluorethylene), and polyurethane to coat the outer surface of the functionalized silica to reduce water adsorption for high humidity applications.

Yet another aspect of the present disclosure provides a functionalized material including a plurality of porous particles. In some embodiments, the plurality of porous particles is characterized by (i) a distribution of porosities within a range of between 100 nanometers and 200 nanometers, and (ii) a distribution of diameters within a range of 0.8 millimeters and 3 millimeters. In some embodiments, the functionalized material further includes a surface modification layer disposed on at least a portion of a surface of the at least one porous particle, where the surface modification layer comprises at least one adsorbing moiety, at least one interaction moiety, and a polymer, a crosslinking agent, a chelating agent, and/or an antioxidant. In some embodiments, the at least one adsorbing moiety comprises polyethylenimine. In some embodiments, the at least one interaction moiety comprises a silane moiety. In some embodiments, the functionalized material adsorbs atmospheric CO₂ under a first condition and reversibly desorbs adsorbed CO₂ under a second condition. In some embodiments, the functionalized material has a methanol emission threshold of less than 0.5% (wt/wt) of methanol to the plurality of functionalized particles. Alternatively or additionally, in some embodiments, the functionalized material has a hydration threshold of less than 10% (wt/wt) of water to the plurality of functionalized particles.

Yet another aspect of the present disclosure provides a functionalized material including a plurality of porous particles and a surface modification layer disposed on at least a portion of a surface of the at least one porous particle. In some embodiments, the surface modification layer comprises at least one adsorbing moiety, at least one interaction moiety, and a polymer, a crosslinking agent, a chelating agent, and/or an antioxidant; the at least one adsorbing moiety comprises polyethylenimine; and the at least one interaction moiety comprises a silane moiety. In some embodiments, the functionalized material adsorbs atmospheric CO₂ under a first condition and reversibly desorbs adsorbed CO₂ under a second condition. In some embodiments, the functionalized material has a methanol emission threshold of less than 0.5% (wt/wt) of methanol to the plurality of functionalized particles, or the functionalized material has a hydration threshold of less than 10% (wt/wt) of water to the plurality of functionalized particles.

In some embodiments, the plurality of porous particles comprises a distribution of diameters comprising any of the embodiments disclosed elsewhere herein, and/or any subrange thereof (see, for example, the section entitled “Substrate,” above). In some embodiments, the plurality of porous particles comprises a distribution of porosities comprising any of the embodiments disclosed elsewhere herein, and/or any subrange thereof (see, for example, the section entitled “Substrate,” above).

In certain embodiments, a stated range of values (e.g., a particle diameter distribution and/or a pore size distribution) is intended to encompass distributions in which the actual measured values fall within a subset of the stated range, without necessarily extending to the recited lower and upper boundaries. For example, in some embodiments, a distribution in which pore sizes range from approximately 120 to 180 nanometers is still be considered to fall within a recited range of 100 to 200 units.

It is to be understood that, unless otherwise specified, a reference to a range (e.g., “from X to Y”) includes all values and subranges therebetween, and does not require the presence of measured data points precisely at the minimum or maximum values. In certain embodiments, the distribution is continuous or multimodal and includes statistically representative subsets (e.g., D10, D50, D90) that fall within the defined limits. Accordingly, in some embodiments, the term “within a range” or “falling within a range” is to be construed to include values that occupy any portion of the specified interval, even if the distribution does not reach the stated endpoints.

In some embodiments, the plurality of porous particles comprises a plurality of porous silica particles, a plurality of porous metal-organic framework (MOF) particles, or a plurality of ion-exchange resin particles. In some embodiments, the plurality of porous particles comprises a porous silica or silicate, a porous ceramic, a porous metal-organic substrate, a porous polymeric substrate, a porous ceramic/metal oxide together with porous silica, a porous alumina, a metal-organic framework (MOF), or a resin. In some embodiments, the plurality of porous particles comprises a porous particle having a plurality of pores. In some embodiments, the plurality of pores comprises a volume greater than about 0.5 mL/g or from 0.1 to 5 mL/g. In some embodiments, the surface modification layer comprises 5% to 25% (wt/wt) of a polyamine to a subset of the plurality of porous particles lacking the surface modification layer; and/or wherein the surface modification layer comprises 20% to 80% (wt/wt) of an aminosilane to the subset of the plurality of porous particles lacking the surface modification layer. In some embodiments, the plurality of porous particles comprises a total surface area greater than about 100 m² per dry gram.

In some embodiments, the functionalized material adsorbs greater than about 0.8 mol of CO₂ per dry kilogram of the functionalized material or from about 0.1 to 2.5 mol of CO₂ per dry kilogram of the functionalized material. In some embodiments, the functionalized material adsorbs CO₂ at a relative humidity in a range from about 5% to 95%.

In some embodiments, the surface modification layer comprises (i) an amine moiety and a silane moiety, (ii) a plurality of amine moieties, (iii) a linking moiety, (vi) both (i) and (iii), (vi) both (ii) and (iii), or (vii) each of (i), (ii), and (iii). In some embodiments, the surface modification layer comprises an aminosilane having a structure of any one of formulas (I), (Ia)-(If), (II), and (IIa)-(IId). In some embodiments, the surface modification layer comprises a polyamine having a structure of anyone of formulas (IIIa)-(IIIi); and the crosslinking agent comprises a structure having one of formulas (V) and (Va)-(Vm). In some embodiments, the functionalized material further includes a chelating agent or an antioxidant. In some embodiments, the functionalized material further includes a phosphate-based chelator, a metal salt, or a phosphonate-based chelator. In some embodiments, the functionalized material further includes a cyclic antioxidant, a hindered amine light stabilizer, or an organic sulfur-containing compound. In some embodiments, the functionalized material further includes an additive, a hydrophobic silane compound, or a hydrophobic polymer. In some embodiments, the functionalized material further includes 1% to 20% (wt/wt) of a polymer, 0.1% to 5% (wt/wt) of a chelating agent acid, 1% to 20% (wt/wt) of a polyamine, 20% to 80% (wt/wt) of an aminosilane, 0.1% to 5% (wt/wt) of a hindered amine light stabilizer compound, and 0.1% to 5% (wt/wt) of a crosslinking agent to the plurality of porous particles.

As used herein, hindered amine light stabilizers (HALS) refer to antioxidant compounds containing an amine functional group and, in some non-limiting embodiments, constitute optionally substituted piperidine compounds. In some embodiments, HALS are used at low concentrations and neutralize many oxidizing radicals and are continually regenerated by heat from the air, CO₂ adsorption, desorber heat. In some embodiments, HALS are used extend the lifetime of the sorbent longer than sacrificial antioxidants.

Non-limiting examples of HALS compounds include: (1) condensate of N,N′-bis(2,2,6,6-tetramethylpiperidin-4-yl)hexane-1,6-diamine, 2,4,6-trichloro-1,3,5-triazine, and 2,4,4-trimethylpentan-2-amine or poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]](CAS Nos. 70624-18-9 and 71878-19-8; Chimassorb® 944); (2) 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine (CAS No. 192268-64-7; Chimassorb® 2020); (3) 6-N-[3-[[4,6-bis[butyl-(1,2,2,6,6-pentamethylpiperidin-4-yl)amino]-1,3,5-triazin-2-yl]-[2-[[4,6-bis[butyl-(1,2,2,6,6-pentamethylpiperidin-4-yl)amino]-1,3,5-triazin-2-yl]-[3-[[4,6-bis[butyl-(1,2,2,6,6-pentamethylpiperidin-4-yl)amino]-1,3,5-triazin-2-yl]amino]propyl]amino]ethyl]amino]propyl]-2-N,4-N-dibutyl-2-N,4-N-bis(1,2,2,6,6-pentamethylpiperidin-4-yl)-1,3,5-triazine-2,4,6-triamine (CAS No. 106990-43-6; Chimassorb® 119); (4) condensate of N,N′-bis(2,2,6,6-tetramethylpiperidin-4-yl)hexane-1,6-diamine and 4-(4,6-dichloro-1,3,5-triazin-2-yl)morpholine (CAS Nos. 82451-48-7 and 196696-80-7; Cyasorb® UV-3346); (5) condensate (including methylated forms) of N1,N6-bis(2,2,6,6-tetramethyl-4-piperidinyl)-1,6-hexanediamine and morpholine-2,4,6-trichloro-1,3,5-triazine (CAS No. 193098-40-7; Cyasorb® UV-3529); (6) 2,2,6,6-tetramethyl-4-piperidinyl stearate (CAS No. 167078-06-0; Cyasorb® UV-3853); (7) bis(2,2,6,6-tetramethyl-4-piperidyl) sebacate (CAS No. 52829-07-9; TINUVIN® 770); (8)N-[6-[formyl-(2,2,6,6-tetramethylpiperidin-4-yl)amino]hexyl]-N-(2,2,6,6-tetramethylpiperidin-4-yl)formamide (CAS No. 124172-53-8; UVINUL® 4050); (9) alpha-alkenes C20-24 polymers with maleic anhydride reaction products with 2,2,6,6-tetramethyl-4-piperidinamine (CAS No. 152261-33-1; UVINUL® 5050H); or a combination of any of these. Yet other non-limiting examples of HALS compounds include one or more of the following: N,N′-bis-formyl-N,N′-bis(2,2,6,6-tetramethyl-4-piperidyl)hexamethylenediamine; 1-(2-hydroxy-2-methylpropoxy)-4-octadecanoyloxy-2,2,6,6-tetramethyl-piperidine; (2,2,6,6-tetramethylpiperidin-4-yl)octadecanoate; a condensate of N,N′-bis-(2,2,6,6-tetramethyl-4-piperidyl)hexamethylenediamine and 4-morpholino-2,6-dichloro-1,3,5-triazine; a condensate of N,N′-bis-(1,2,2,6,6-pentamethyl-4-piperidyl)hexamethylenediamine and 4-morpholino-2,6-dichloro-1,3,5-triazine; a condensate of N,N′-bis(2,2,6,6-tetramethyl-4-piperidyl)-hexamethylenediamine and 4-tert-octylamino-2,6-dichloro-1,3,5-triazine; an oligomeric compound condensate of 4,4′-hexa-methylenebis(amino-2,2,6,6-tetramethylpiperidine) and 2,4-dichloro-6-[(2,2,6,6-tetramethyl-piperidin-4-yl)butylamino]-s-triazine end-capped with 2-chloro-4,6-bis(dibutylamino)-s-triazine; an oligomeric compound condensate of 4,4′-hexamethylenebis(amino-1-propoxy-2,2,6,6-tetra-methylpiperidine) and 2,4-dichloro-6-[(1-propoxy-2,2,6,6-tetramethylpiperidin-4-yl)butyl-amino]-s-triazine end-capped with 2-chloro-4,6-bis(dibutylamino)-s-triazine; a reaction product of maleic acid anhydride-C18-C22-α-olefin-copolymer with 2,2,6,6-tetramethyl-4-aminopiperidine; and combinations of any of these. Also included are sterically hindered N—H, N-methyl, N-methoxy, N-hydroxy, N-propoxy, N-octyloxy, N-cyclohexyloxy, N-acyloxy, and/or N-(2-hydroxy-2-methyl-propoxy) analogues of any compounds described herein. For example, in some embodiments, replacing an N—H hindered amine with an N-methyl hindered amine would employ the N-methyl analogue in place of the N—H. In some embodiments, more than one antioxidant is introduced. In some embodiments, the antioxidants introduced exhibit synergism, e.g., one antioxidant is regenerated by the second, one antioxidant protects the other by sacrificial oxidation, and/or the antioxidants exhibit different antioxidant mechanisms.

In some embodiments, the functionalized material comprises 15% (wt/wt) of a polymer, 1% (wt/wt) of a chelating agent acid, 10% (wt/wt) of a polyamine, 45% (wt/wt) of an aminosilane, 1% (wt/wt) of a HALS compound, and 1% (wt/wt) of a crosslinking agent to the plurality of porous particles. In some embodiments, the functionalized material comprises 15% (wt/wt) polyvinyl alcohol, 1% (wt/wt) etidronic acid, 10% (wt/wt) polyethylenimine, 45% (wt/wt)N-[3-(trimethoxysilyl)propyl]ethylenediamine, 1% (wt/wt) hindered amine light stabilizer compound, and 1% (wt/wt) terephthalaldehyde to the plurality of porous particles.

Another aspect of the present disclosure provides a method comprising using any of the compositions and/or functionalized materials disclosed herein to remove atmospheric CO₂ from air by direct air capture.

Further non-limiting embodiments for functionalized materials and methods of forming thereof contemplated for use in the present disclosure are disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

### III. Example Production Systems

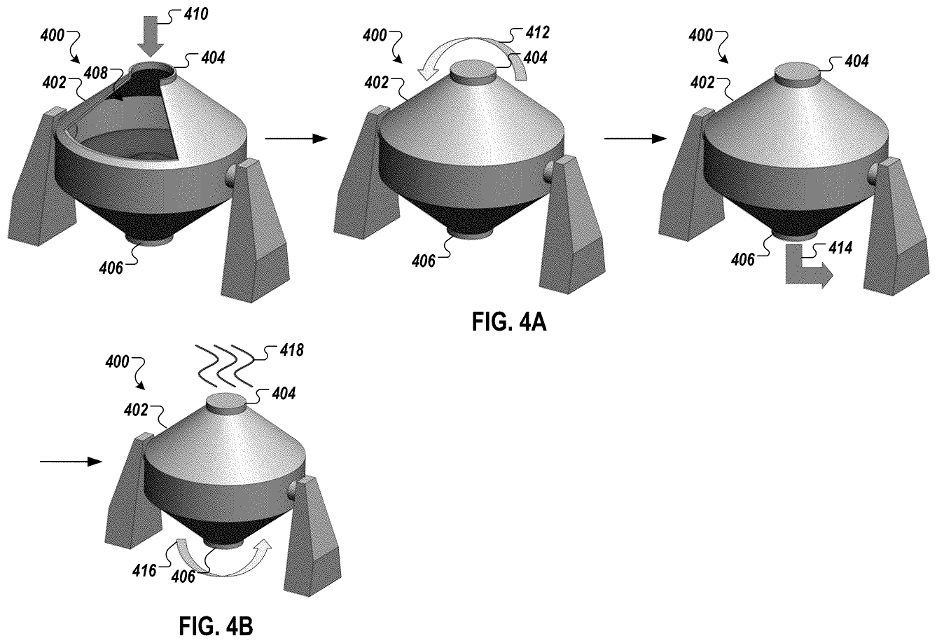

In some embodiments, any useful component is used to form a functionalized material. In some embodiments, one or more components are employed in a spray coating system or a dip coating system. FIGS. 4-9 illustrate example systems by which a functionalized material is produced in functionalization methods, such as process 300A-D, described herein.

FIGS. 4A-4B shows a double cone tumble mixing system 400 which includes a tumbler 402 having an inlet 404, outlet 406, and an inner volume 408. The double cone mixing system 400 results in a high degree of particle mobility during mixing when the substrate is added to the inner volume 408 through the inlet 404. In general, the contents of the tumbler 402 are mixed by rotating the tumbler 402 around a central horizontal axis.

The double cone tumble mixing system 400 is an efficient machine for mixing of dry powders and granules homogeneously. All of the surfaces which contact the contents can be manufactured from non-reactive metal, such as stainless steel, glass, or glass-coated interior, to prevent interaction with the polymer for coating, silane compounds, the polyamines, or the substrate (e.g., silica particles). In general and without wishing to be bound by theory, the effective volume for optimum homogeneity is between 35-70% of the inner volume 408 of the tumbler 402. The double cone tumble mixing system 400 is advantageous for use with fragile substrates (e.g., fragile silica particles) as the cone-shapes and smooth inner walls of the tumbler 402 reduce attrition of the substrate during agitation.

In general, the coating liquid components (e.g., including a polymer to provide a polymer coating) and/or functionalization mixture components are poured into the inlet 404 and allowed to form the coating liquid/functionalization mixture. In other words, the reagent(s) (e.g., one or more of aminosilanes, silanes, polyamines, monoamines, polymers, crosslinking agents, chelating agents, or antioxidants) and/or a volume of solvent (e.g., any herein, including one or more volatile solvents) are sprayed into the inner volume 408 of the mixing system 400, shown in the left-most image of FIG. 4A. Spraying can be conducted within components in a single step (e.g., in which the functionalization mixture is provided therein) or in multiple steps (e.g., in which the polymer coating liquid is first formed and then functionalization mixture components are provided; or in which the functionalization mixture is first formed and then the polymer for coating is provided). If necessary, the inlet 404 is sealed and the components agitated within the mixing system 400 to form, or hasten the formation of, the polymer coating liquid/functionalization mixture. In some examples, the spraying is conducted in a range from 20 lbs to 60 lbs per minute of functionalization mixture (e.g., 40 lbs/min). In some examples, the polymer coating liquid and/or the functionalization mixture is sprayed at an elevated temperature, e.g., above 28 degrees C., e.g., 40 degrees C.

The substrate (e.g., porous silica particles) are added through the inlet 404. The coating liquid/functionalization mixture is then added through the inlet 404 or pumped/sprayed into the inner volume 408 containing the substrate. The tumbler 402 is sealed and agitated, shown in the central image of FIG. 4A. In some examples, the tumbler 402 is agitated, e.g., rotated, at 2 revolutions per minute (RPM).

In some examples, the mixing system 400 is used to optionally coat, functionalize, and dry the particles. In FIG. 4B, the mixing system 400 applies heat 418 to the inner volume 408 of the tumbler 402 which causes excess solvent used coating liquid/functionalization mixture absorbed by the coated and/or functionalized material to evaporate. The tumbler 402 is rotated to agitate the coated and/or functionalized material, which increases the evaporation rate of the absorbed coating liquid/functionalization mixture during heating.

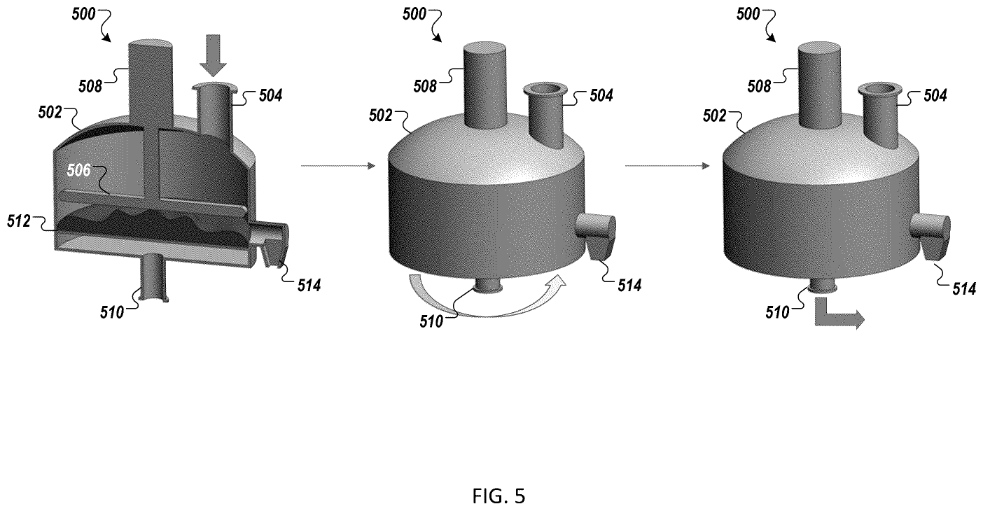

FIG. 5 is three images of an example Nutsche filter mixing system 500 which effectively performs the separation of solid matter from a liquid under pressure or vacuum in a closed system. The left-most image of FIG. 5 shows a cut-away view of the mixing system 500. The mixing system 500 includes a vessel 502 having an inlet 504, filter discharge 510, and outlet 514. Some examples of the vessel 502 are jacketed for temperature control. An agitator 506 is rotatable within the vessel 502 by a drive motor 508 around the drive motor 508 shaft. The inlet 504 receives the coating liquid (e.g., including a polymer to provide a polymer coating), functionalization mixture components including the silane compounds, polyamines, volume of solvent (e.g., any described herein, including one or more volatile solvents), and/or substrate (e.g., particles).

The drive motor 508 rotates the agitator 506 such that the mixture is stirred and shear forces are applied to the substrate and functionalization mixture. The substrate is mobilized within the coating liquid/functionalization mixture. The vessel 502 includes a filter 512 sized to separate the solid particles and the coating liquid/functionalization mixture during agitation, coating, and/or functionalization. When the discharge 510 and outlet 514 are open, the liquids are removed from the vessel 502 and discarded while the filter 512 separates the coated and/or functionalized material. The filter 512 can be wire mesh, a cloth layer, or a perforated metal layer.

Some examples of the mixing system 500 include a heating mechanism integrated into the filter 512 such that, following decanting of the coating liquid/functionalization mixture in the right-most image of FIG. 5, the separated coated and/or functionalized material can be dried within the vessel 502.

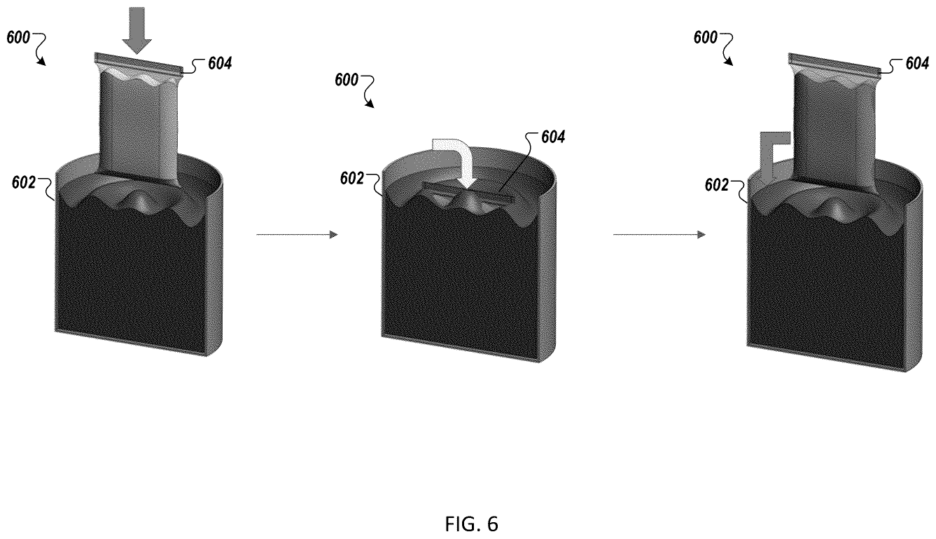

FIG. 6 is three images of a filtration bag dip-coating method used to produce a functionalized material. An open-topped container 602, e.g., a vat, is filled with the liquid components of the coating liquid/functionalization mixture and allowed to produce a homogeneous mixture. In some examples, the liquid components are agitated to produce the homogeneous mixture. In the left-most image, a mesh filtration bag 604 is filled with the substrate (e.g., silica particles) to be coated and/or functionalized. The mesh of the filtration bag 604 is sufficiently small to permit liquid ingress while withholding the substrate (e.g., particulates of the silica particles). In some cases, the mesh is large enough to permit fine dust to be separated from the substrate when the filtration bag 604 is submerged.

In the central image of FIG. 6, the filtration bag 604 is submerged within the liquid components and rested for a duration. The filtration bag 604 can be moved within the container 602 to facilitate uniform contact between the coating liquid/functionalization mixture and the substrate contained within the filtration bag 604. The uniform contact produces homogenous coated and/or functionalized material when the filtration bag 604 is withdrawn and the coated and/or functionalized material is dried.

In the right-most image of FIG. 6, the filtration bag 604 is withdrawn from the container 602 and the excess coating liquid/functionalization mixture decanted, e.g., drained, such that the coated and/or functionalized material is maintained in the filtration bag 604. The coated and/or functionalized material (e.g., functionalized silica particles) can then be removed from the filtration bag 604 and dried to complete the coating and/or functionalization process.

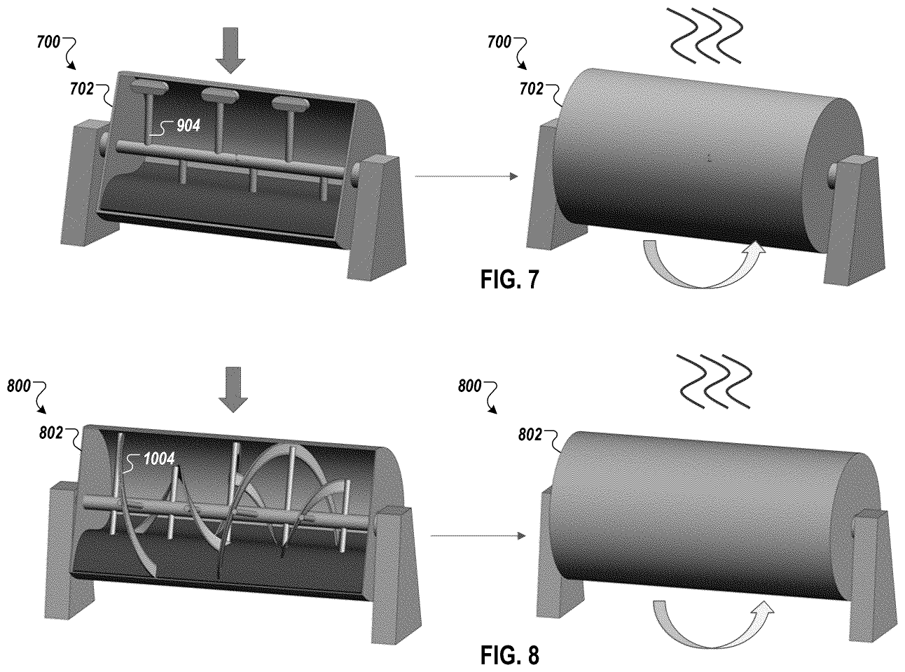

FIGS. 7 and 8 show two different examples of drum mixers which can be used for mixing the coating liquid/functionalization mixture, exposing the particles to the coating liquid/functionalization mixture thereby coating and/or functionalizing the particles, and/or drying of the coated and/or functionalized particles. In the left image of FIG. 7, a paddle mixer 700 includes a cylindrical drum 702 in which mixing occurs. A paddle agitator 704 rotates independently of the drum 702 to mix the coating liquid/functionalization mixture with the substrate. The substrate is dispensed into the drum 702, and the paddle agitator 704 rotates to agitate the substrate (e.g., silica particles) in the coating liquid/functionalization mixture.

In the left image of FIG. 8, a ribbon mixer 800 includes cylindrical drum 802 in which mixing occurs by a ribbon agitator 804, which rotates independently of the drum 802. The substrate (e.g., silica particles) is dispensed into the drum 802, and the ribbon agitator 804 rotates to agitate the substrate (e.g., silica particles) in the coating liquid/functionalization mixture.

Examples of the paddle mixer 700 and ribbon mixer 800 can include heating mechanisms, such as jacketed drums 702 and 802, or forced gas venting to flow heated gas over the coated and/or functionalized material after separating the solid substrate from the coating liquid/functionalization mixture. In some examples, the heated gas can be air, or an inert gas (e.g., nitrogen, N₂). If a heat carrier is flown through a jacket of the paddle mixer 700 or ribbon mixer 800, the heat carrier can be heated oil, steam, or hot water. If the heat carrier is flown inside the vessel (e.g., forced gas venting), an inert gas such as N₂ can be used. However, in examples of forced gas venting air should be avoided to prevent oxidation. In this way, the paddle mixer 700 and ribbon mixer 800 can be used to coat/functionalize and dry the coated and/or functionalized material. The mixers 700 and 800 apply heat to the inner volume of the mixers, which causes excess solvent from the coating liquid/functionalization mixture absorbed by the functionalized material to evaporate. As the agitators 704 and 804 are rotated to agitate the coated and/or functionalized material, the evaporation rate of the absorbed coating liquid/functionalization mixture increases during heating.

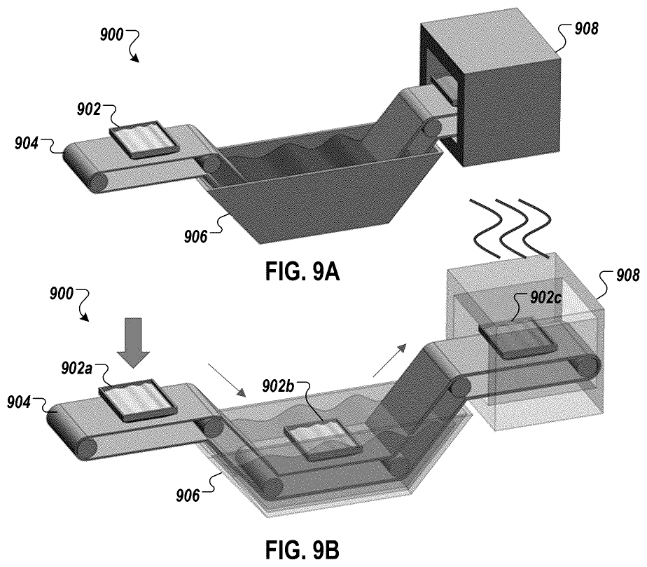

FIGS. 9A-9B illustrate an example dip-coating conveyor system 900 in which silica particles to be functionalized are placed in a container 902 and conveyed through the dip-coating process by a conveyor 904. The container 902 shown is an open-top vessel, though in other examples a mesh bag containing the substrate is functional with the conveyor system 900. The container 902 can be solid or perforated to facilitate rapid and complete absorption of the coating liquid/functionalization mixture by the substrate.

FIG. 9A illustrates the container 902 arranged on the conveyor 904. The conveyor is operated by a controller, which causes the container 902 to enter a dip tank 906. The dip tank 906 contains the coating liquid/functionalization mixture including the polymer for the polymer coating, aminosilanes, and/or polyamines to coat and/or functionalize the substrate (e.g., silica particles). Some examples of the dip tank 906 include agitation elements, such as mixing or stirring blades, or pumps.

FIG. 9B illustrates the conveyor system 900 operating in a continuous mode in which multiple containers 902 are transported by the conveyor 904 concurrently. FIG. 9B illustrates containers 902a, 902b, and 902c each at different stages of the dip-coating process. In this manner, the conveyor system 900 can be operated efficiently to dip-coat and dry batches of the silica particles sequentially.

Further non-limiting embodiments for methods of producing functionalized materials contemplated for use in the present disclosure, including but not limited to example production systems, are disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

### IV. Example Methods of Using or Testing a Functionalized Material

In some embodiments, the functionalized material is used as a sorbent. Described herein are methods and systems to test such materials.

The present disclosure encompasses methods of using a functionalized material to remove atmospheric CO₂ from air by direct air capture. In some embodiments, in addition to air, the functionalized material is used to remove CO₂ from a fluid.

Methods of use include providing a functionalized material for capturing (e.g., reversibly capturing) CO₂. In general, the functionalized material is a layer of conventional or uniform beads, granules, pellets, fibers, membranes, or powders over which gaseous mixtures including CO₂ are flowed. Gas exiting the layer of functionalized material has a lower concentration of CO₂ than the entering gas.

In some embodiments, capture of CO₂ is achieved by using a reactor or a sample holder, e.g., such as any described herein. Accordingly, in some embodiments, methods of use include: providing air to a reactor (e.g., any described herein) or a sample holder (e.g., any described herein) comprising a sorbent, wherein the sorbent can include a functionalized material (e.g., any described herein); and exposing the sorbent to conditions to adsorb CO₂ from the air to form CO₂-reduced air. In some embodiments, the sorbent is provided as a fluidized bed.

In some embodiments, methods of use further include: releasing adsorbed CO₂ under certain conditions to desorb CO₂ from the sorbent to form CO₂-enriched air. In some embodiments, non-limiting conditions include, e.g., a temperature swing adsorption process, a pressure swing adsorption, a vacuum swing adsorption process, or a combination of any of these.

In some embodiments, the method includes: providing ambient air comprising CO₂ to a reactor (e.g., any described herein) comprising one or more air chambers; blowing the ambient air so that it travels from the one or more air chambers into a reaction chamber; delivering a powdered sorbent material to the reaction chamber through an inlet; creating a fluidized bed of the powdered sorbent material and the air under conditions in which the powdered sorbent material adsorbs the CO₂ from the air to form CO₂-reduced air and used powdered sorbent material; continuously removing used powdered sorbent material from the reaction chamber; and continuously removing CO₂-reduced air from the reaction chamber through one or more exhaust ports.

Further non-limiting embodiments for using functionalized materials contemplated for use in the present disclosure, including but not limited to sample holders, reactors, and/or direct air capture systems, are disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

### i. Example Sample Holders

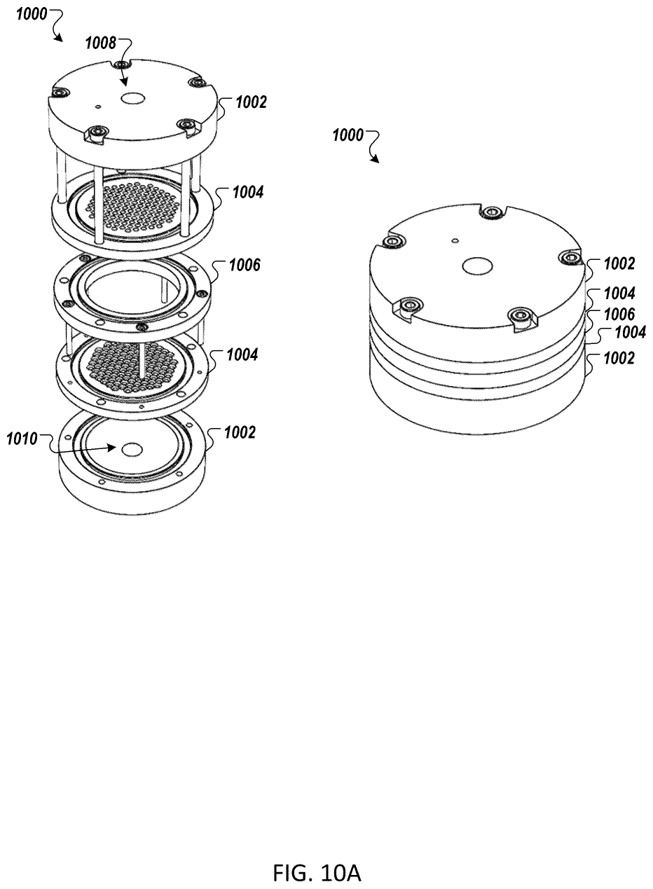

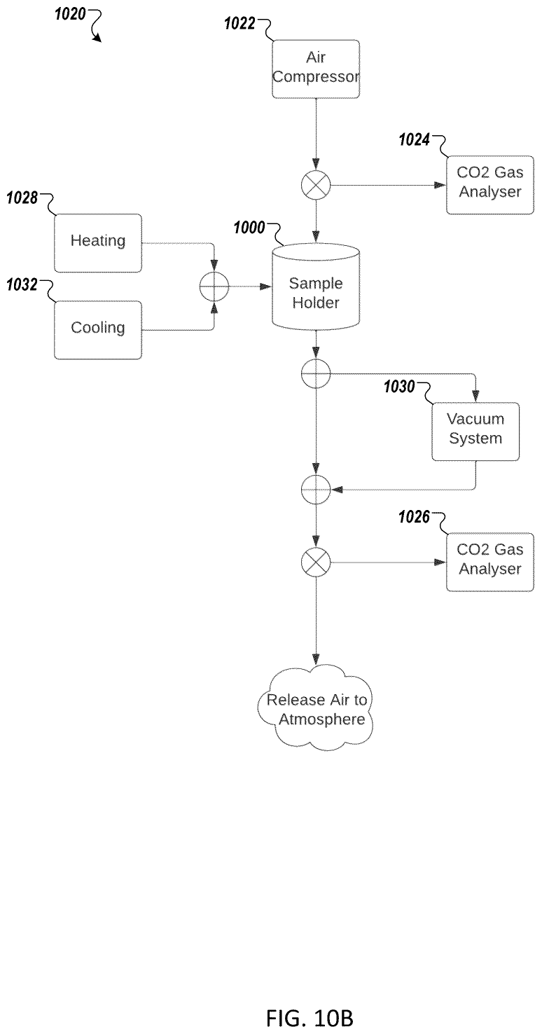

In some embodiments, the functionalized material is provided in a sample holder for testing and/or during use as a sorbent. FIG. 10A schematically illustrates an exploded view (left) and an assembled view (right) of a non-limiting sample holder 1000 for the sorbent. In some embodiments, functionalized material is placed in a sample space 1006 arranged between two layers of filter 1004 (e.g., such as glass wool) in a sample holder 1000. In some embodiments, the sealing ends 1002 of the sample holder 1000 include an inlet 1008 and an outlet 1010 permissive to gas flow. In some embodiments, the sealing ends 1002 include reversible screw connections to assemble the sample holder 1000. When assembled (right), the sample holder 1000 was otherwise sealed against gaseous inflow.

In FIG. 10B, a schematic diagram of the experimental setup 1020 is shown. Referring now to FIGS. 10A and 10B, a gas source, e.g., air compressor 1022, provided compressed environmental air to the inlet 1008 of the testing sample holder 1000. The air passes through the filters 1004, thereby exposing the functionalized material to the environmental air. Air is exhausted from the outlet 1010. The concentration of CO₂ in the compressed environmental air is measured by a gas analyzer, e.g., CO₂ gas analyzers 1024 and 1026, prior to entering the inlet 1008 and subsequent to exiting the outlet 1010.

The samples of functionalized material were treated with an activation process before data collection. Samples were heated in a vacuum drier (e.g., vacuum heater 1028) to 70° C. for 30 minutes under vacuum (e.g., at 0.3 psi) to activate the sorbent, e.g., as the activation process. Alternatively, and as shown in FIG. 10B, the heating element 1028 and the vacuum system 1030 are separate elements of the setup 1020 and work in concert to heat and apply vacuum to the sample holder 1000. In some implementations, a cooling element 1032 is included in the setup 1020 to further control the temperature of the environment in the sample holder 1000. Both the heating element 1028 and the cooling element 1032 are integrated into the sample holder 1000 in the experimental setup 1020 to apply temperature control directly to the sorbent sample. In some embodiments, the activation process facilitates removal, e.g., evaporation, of residual solvent medium in the pores of the functionalized silica and desorbs CO₂ molecules bonded during the synthesis process (e.g., processes 300A-C) for venting to the atmosphere.

### ii. Example Direct Air Capture Systems

Disclosed herein are systems for employing a functionalized material. In some embodiments, the functionalized material is used as a sorbent in a fluidized bed reactor for use in direct air capture (DAC).

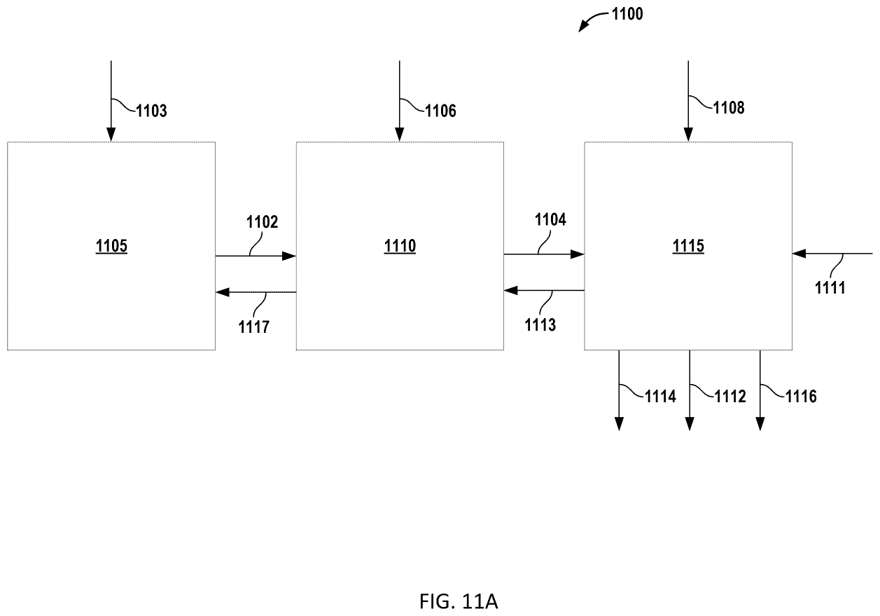

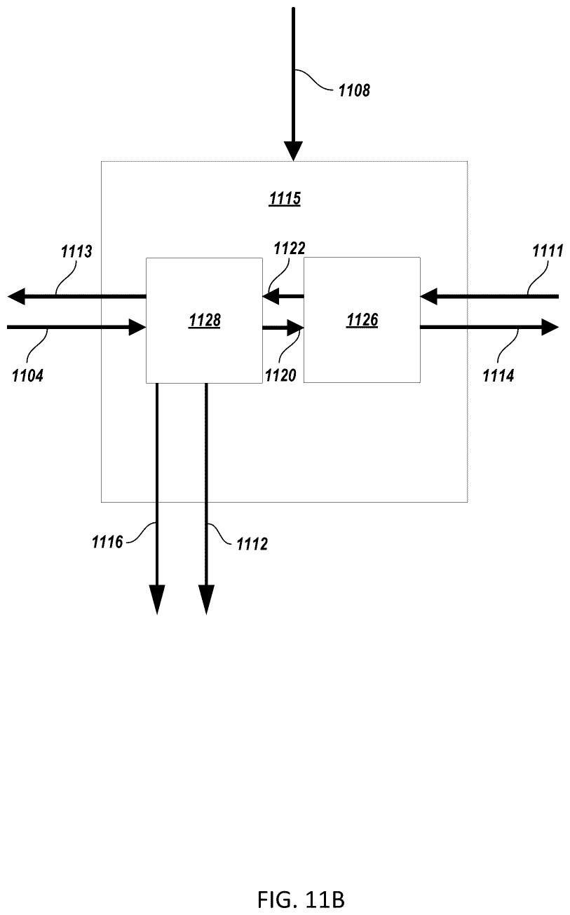

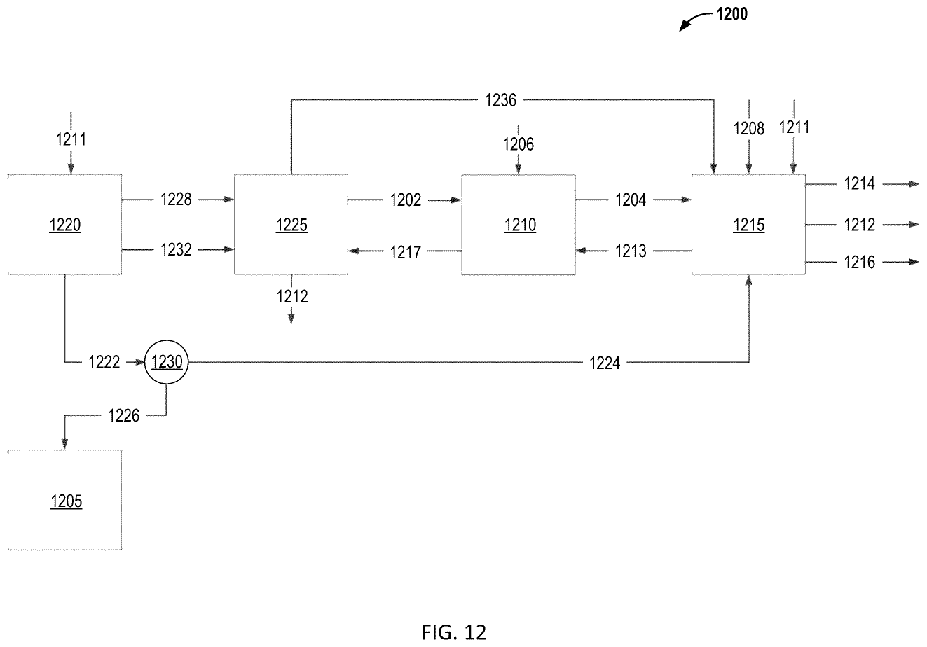

Examples of DAC systems of CO₂ using the sorbent of the present disclosure are described with reference to FIG. 11A-11B and FIG. 12, examples of which are described in U.S. Pat. Pub. No. 2021/0300765 or Int. Pub. No. WO 2021/202499, the disclosure of which are hereby incorporated by reference in their entirety.

FIG. 11A is a schematic illustration of an example implementation of a carbon dioxide extraction system 1100 that uses waste heat to provide energy for a carbon dioxide direct air capture (DAC) system 1115. As illustrated, the carbon dioxide extraction system 1100 includes an industrial process 1105 that generates waste heat 1102. In some implementations, the industrial process utilizes a power input 1103. The waste heat 1102 is supplied, in this example, to a thermal heat-reuse system 1110 that also utilizes a power input 1106.

The thermal heat-reuse system 1110 provides a heated fluid 1104 to a carbon dioxide DAC system 1115. The carbon dioxide DAC system 1115 also receives a power input 1108 and an ambient airflow input 1111. The carbon dioxide DAC system 1115 outputs a carbon dioxide supply stream 1112, a carbon dioxide-reduced airflow output stream 1114, and demineralized water 1116. As will be discussed in greater detail herein, DAC system 1115 includes an adsorber system (e.g., that may optionally comprise a fluidized bed reactor or a silo adsorber) and a desorber system (e.g., that may optionally comprise a gravity fed desorption system).

Generally, the carbon dioxide extraction system 1100 operates to utilize the heated fluid 1104 as thermal energy that is generated from the waste heat 1102 by the thermal heat-reuse system 1110. The thermal energy in the heated fluid 1104 is used by the carbon dioxide DAC system to separate carbon dioxide captured from the ambient airflow input 1111 and supply the separated carbon dioxide as the carbon dioxide supply stream 1112. The heated fluid 1104 is then returned via heated fluid return 1113 to the thermal heat-reuse system 1110, and the waste heat 1102 is returned to the industrial process 1105 via waste heat return 1117. In some aspects, the carbon dioxide supply stream 1112 is provided as an injectant into a subterranean formation during hydrocarbon production operations. In some aspects, the injected carbon dioxide is sequestered in the subterranean formation (with or without assisting in the hydrocarbon production operations).

In some embodiments, the industrial process 1105 is any process that generates, as an output, thermal energy in the form of waste heat, e.g., energy, that, unless captured, that otherwise would be lost to, e.g., the ambient environment. As an example, in some embodiments, the industrial process 1105 is a computer data center that, generally, houses computer systems and associated components, such as telecommunications and storage systems. In some aspects, a data center includes tens, hundreds, thousands, or even more server devices that generate heat, such as hardware processors, voltage regulators, memory modules, switches, and other devices that operate to provide a particular amount of information technology (IT) power.

Such devices, typically, utilize electrical power to operate and output heat during operation. In some embodiments, in order for such devices to operate correctly, the output heat is captured in a cooling fluid flow (e.g., air, water, refrigerant) and expelled from the data center. For instance, in some embodiments, air handling systems (e.g., fans, cooling coils) operate to capture the output heat in an airflow circulated over the heat-generating components. The output heat now within the airflow is transferred to a cooling liquid, e.g., within a cooling coil. The heat transferred to the cooling liquid is then typically rejected to the ambient environment as waste heat, such as through evaporative cooling systems, chiller/cooling tower systems, or otherwise. In this example, this waste heat takes the form of waste heat 1102.

The example thermal heat-reuse system 1110 utilizes the waste heat 1102 and power input 1108 to provide the heated fluid 1104. The thermal heat reuse system 1110 comprises a bank of heat pumps and a bank of heat exchangers to provide the heated fluid 1104. By balancing the use of passive and active heating, power is saved to provide the carbon dioxide DAC system with the required temperatures of heated fluid 1104. Generally, the thermal heat-reuse system 1110 includes one or more vapor-compression cycles (“heat pumps”) to add thermal energy in the form of heat of compression to the waste heat 1102 and transfer the sum of such energy to a fluid to generate the heated fluid 1104 (e.g., a heated liquid). Generally, each heat pump and heat exchanger within the thermal heat-reuse system 1110 operates to transfer thermal energy from a heat sink to a heat source, e.g., in an opposite direction of spontaneous heat transfer. The one or more heat pumps of the thermal heat-reuse system 1110 use the power input 1106 to accomplish the work of transferring energy from the heat source to the heat sink. Each heat pump in the thermal heat-reuse system 1110 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components is fluidly coupled within a closed-loop refrigerant circuit in the heat pump.

The carbon dioxide DAC system 1115, generally, operates to pass the ambient airflow input 1111 (which includes low concentrations of gaseous carbon dioxide) over or through one or more media (e.g., “filters”). In some aspects, one or more fans (not shown) utilize the power input 1108 to circulate the ambient airflow input 1111. The media or filter, in some aspects, includes a solid sorbent to which the atmospheric carbon dioxide in the airflow input 1111 bonds. In some embodiments, the sorbent that is saturated with carbon dioxide is referred to as “rich sorbent.”

In the case of a solid sorbent, such as the sorbent described in the present disclosure, as the airflow input 1111 passes over the solid media or filter, atmospheric carbon dioxide within the airflow input 1111 bonds to the media or filter. In some embodiments, when the media or filter is saturated with carbon dioxide, it is heated (e.g., to 600-620° C. or to 60-100° C.) to release the carbon dioxide for collection (as described herein).

Using thermal energy from the heated fluid 1104, heat is applied to the solid or liquid sorbent, which breaks the bonds between the carbon dioxide and the sorbent. The separated carbon dioxide is provided as the carbon dioxide supply stream 1112 from the carbon dioxide DAC system 1115. The now-“lean adsorbent” that is carbon dioxide free (e.g., the solid or liquid) is recycled back to capture more carbon dioxide from the ambient airflow input 1111. The airflow output 1114, typically, contains little to no carbon dioxide.

FIG. 11B shows an example carbon dioxide DAC system 1115. The carbon dioxide DAC system 1115 includes an adsorber system 1126 and a desorber system 1128.

The adsorber system 1126 generally operates to pass the ambient airflow input 1111 (which includes gaseous carbon dioxide) over or through one or more sorbents (e.g., in media or filters) under conditions at which the sorbent adsorbs CO₂ from the air. In some embodiments, the sorbent is provided within a fluidized bed reactor, where air flows through an air inlet into a reaction chamber and will diffuse through a distribution plate to make contact with the sorbent. In some embodiments, the adsorber system includes any useful adsorber. In other embodiments, air flows through one or more filter panels of a silo adsorber.

The desorber system 1128 generally operates to remove adsorbed carbon dioxide from sorbent material. In some embodiments, the desorber system includes, for example, any useful desorption system.

In some aspects, one or more fans (not shown) utilize the power input 1108 to circulate the ambient airflow input 1111. For example, in some embodiments, a blower uses the power input 1108 to circulate airflow input to a chamber of a silo adsorber.

The media, filter, or sorbent, in some aspects, includes a solid sorbent to which the atmospheric carbon dioxide in the airflow input 1111 bonds. For example, in some embodiments, the solid sorbent is in a pelletized or powdered form. Alternatively, in some embodiments, a liquid sorbent is also passed over the media or filter to which the atmospheric carbon dioxide in the airflow input 1111 bonds. In some embodiments, the sorbent that is saturated with carbon dioxide is referred to as “rich sorbent.” Rich sorbent 1122 exits the adsorber system 1126 and enters the desorber system 1128. Carbon dioxide-reduced air exits the adsorber system 1126 through the airflow output 1114.

The desorber system 1128 uses thermal energy from the heated fluid 1104 to apply heat to solid or liquid rich sorbent 1122. The heat dissolves the bonds between the carbon dioxide and the rich sorbent 1122. The heated fluid return 1113 exits the desorber system 1128 in order to collect more heat from a process outside of the carbon dioxide DAC system. The separated carbon dioxide is provided as the carbon dioxide supply stream 1112 from the carbon dioxide DAC system 1115. The heat also dissolves bonds between water molecules and the rich sorbent 1122, which exits the system as demineralized water output 1116. The sorbent exiting the desorber system 1128 may be referred to as “lean sorbent,” e.g., sorbent that is carbon dioxide free and, optionally, moisture free. Lean sorbent 1120 (e.g., as a solid or liquid) exits the desorber system 1128 and is recycled back to the adsorber system 1126. The lean sorbent 1120, in the filters of the adsorber system 1126, captures more atmospheric carbon dioxide from the ambient airflow input 1111. The demineralized water output 1116, typically, contains little to no carbon dioxide.

FIG. 12 is a schematic illustration of an example implementation of an integrated power and carbon dioxide DAC system (“integrated system”) 1200. As illustrated, the integrated system 1200 includes a natural gas plant 1220 attached to a CCS flue gas carbon dioxide scrubber 1225 that generates waste heat 1202. The waste heat 1202 is supplied, in this example, to a thermal heat-reuse system 1210 that also utilizes a power input 1206. The thermal heat-reuse system 1210 provides a heated fluid 1204 to a carbon dioxide direct air capture (DAC) system 1215.

A natural gas plant 1220 generates flue gas containing carbon dioxide and electrical power 1228 that is sent to the CCS flue gas carbon dioxide scrubber system 1225. The scrubber system 1225 separates out the carbon dioxide from the flue gas. The scrubber system 1225 provides waste heat 1202 to a carbon dioxide direct air capture (DAC) system 1215. The carbon dioxide DAC system 1215 also receives a power input 1208 and an ambient airflow input 1211. The carbon dioxide DAC system 1215 outputs a carbon dioxide supply stream 1212 and a carbon dioxide-reduced airflow output stream 1214.

Generally, the integrated system 1200 operates to capture the waste heat 1202, generate the heated fluid 1204 that has a thermal energy that includes the waste heat 1202, as well as heat of compression from the thermal heat-reuse system 1210, and utilize such thermal energy in the heated fluid 1204 to separate carbon dioxide captured from the ambient airflow input 1211 to supply the separated carbon dioxide as the carbon dioxide supply stream 1212. In some aspects, the carbon dioxide supply stream 1212 is provided as an injectant into a subterranean formation during hydrocarbon production operations. In some aspects, the injected carbon dioxide is sequestered in the subterranean formation (with or without assisting in the hydrocarbon production operations).

In this implementation, the industrial process 1205 is powered by the natural gas plant 1220 rather than the electrical power grid since the electrical power 1226 would be considered carbon negative electricity.

In the case of a solid sorbent, such as the sorbent described in the present disclosure, as the airflow input 1211 passes over the solid media or filter, atmospheric carbon dioxide within the input 1211 bonds to the media or filter. In some embodiments, when the media or filter is saturated with carbon dioxide, it is heated (e.g., to 100-120° C., to 60-100° C.) to release the carbon dioxide for collection (as described herein).

Using thermal energy from the heated fluid 1204, heat is applied to the solid sorbent, which breaks the bonds between the carbon dioxide and the sorbent. The separated carbon dioxide is provided as the carbon dioxide output stream 1212 from the carbon dioxide DAC system 1215. The now-“lean adsorbent” that is carbon dioxide free (i.e., the solid or liquid) is recycled back to capture more carbon dioxide from the ambient airflow input 1211. The airflow output 1214, typically, contains little to no carbon dioxide. The carbon dioxide DAC system 1215 outputs carbon dioxide 1212 and demineralized water 1216.

As further shown in the example embodiment of FIG. 12, the integrated system 1200 includes a power plant 1220 (e.g., a natural gas power plant 1220) and a scrubbing system 1225 (e.g., a CCS Flue Gas CO₂ scrubbing system 1225). As shown in this example, in some embodiments, the power plant 1220 provides waste heat 1202 (e.g., as generated through the generation of electrical power by the power plant 1220) to the DAC system 1215. In this example, the power plant 1220 also generates electrical power 1222 and 1228. In some aspects, as shown, the electrical power 1222 goes through one or more switches 1230 (shown here as one, but more are possible) to provide electrical power 1224 to the DAC system 1215 and backup electrical power 1226 to the industrial process 1205.

In some implementations, embodiments of the subject matter and the operations described in this specification (e.g., for any system herein, such as a DAC system, a fluidized bed reactor, a silo adsorber, a gravity fed desorption system, as well as combinations and subcombinations thereof) are implemented, in part, by digital electronic circuitry, or in computer software, firmware, or hardware, including the structures disclosed in this specification and their structural equivalents, or in combinations of one or more of them, in additional to the structures described herein. Further non-limiting embodiments for using functionalized materials contemplated for use in the present disclosure, including but not limited to sample holders, reactors, and/or direct air capture systems, are disclosed in International Publication No. WO2024006521A2, published Jan. 4, 2024; U.S. patent application Ser. No. 19/000,606, filed Dec. 23, 2024; International Application No. PCT/US2024/061805, filed Dec. 23, 2024; U.S. patent application Ser. No. 19/000,591, filed Dec. 23, 2024; International Application No. PCT/US2024/061804, filed Dec. 23, 2024; U.S. patent application Ser. No. 19/000,613, filed Dec. 23, 2024; and International Application No. PCT/US2024/061806, filed Dec. 23, 2024, each of which is hereby incorporated by reference in its entirety.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing.

The separation of various system modules and components in the embodiments described herein (e.g., for any system herein) should not be understood as requiring such separation in all embodiments, and it should be understood that the described program components and systems can generally be integrated together in a single software product or packaged into multiple software products. In certain circumstances, multitasking and parallel processing may be advantageous.

### EXAMPLES

### Example 1—Silane and Polymeric Amine Functionalized Porous Substrate for Carbon Capture

Examples 1.1 to 1.3 generally relate to a functionalized porous silica and more specifically, to a functionalized porous silica for reversibly capturing carbon dioxide.

### Example 1.1—N1-(3-Trimethoxysilylpropyl)diethylenetriamine and PEI Grafting

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hrs. N1-(3-trimethoxysilylpropyl)diethylenetriamine, having the chemical formula:

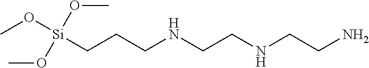 [SMILES: CO[Si](CCCNCCNCCN)(OC)OC]

was added into the above solution at a molar ratio in a range from 2.3 g to 4.7 g (e.g., 8 mmol to 16 mmol, e.g., a silica particle to amine material molar ratio in a range from 5:1 to 10:1). The mixture was heated and stirred at 60° C. or above (e.g., up to 90° C.). The temperature depends on the chosen solvent. The mixture was stirred for 18 hours (in some cases, the mixing continued for 24 hours). The mixture was cooled to room temperature. The functionalized silica particles were filtered from the solvent and washed twice while stirring with a 40 mL volume of solvent each time. The functionalized silica particles were dried in a vacuum oven at 50° C. for 12 hours. Alternatively, [3-(2-aminoethylamino)propyl]trimethoxysilane, having the chemical formula:

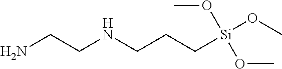

was added to the solution at 2.2 g to 4.5 g (e.g., 8 mmol to 16 mmol, e.g., a silica particle to amine material molar ratio in a range from 5:1 to 10:1).

In a second round bottom flask, 30 mL of methanol or solvent mixture (e.g., cyclohexane:ethanol=2:1), 5 g of silane-treated silica from the above step, and 1.5 g polyethylenimine (PEI) or other second amine (30 wt % to silica) was added, according to the method of Example 5. The mixture was stirred for 1 hour. The solvent was dried from the functionalized silica through evaporation, such as on a rotovap, to recover the functionalized silica. The functionalized silica particles were dried in a vacuum oven at 50° C. for 12 hours. The second step can be performed as a large scale process such as using vacuum drying together with an amine/solvent mixture spraying process.

### Example 1.2—Bis[3-(trimethoxysilyl)propyl]amine grafting

Using a silane compound having two or more silane moieties (e.g., two trimethoxysilane or triethoxysilane functional groups) in the same molecule, such as for example bis[3-(trimethoxysilyl)propyl]amine, can facilitate a plurality of interactions between silane groups and silica, potentially improving binding stability of the silane bond to the silica surface.

To add bis[3-(trimethoxysilyl)propyl]amine), having the chemical formula:

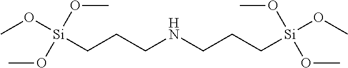

to the reaction, the same procedure as for [3-(2-aminoethylamino)propyl]trimethoxysilane grafting was followed.

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hours. [3-(2-aminoethylamino)propyl]trimethoxysilane, having the chemical formula:

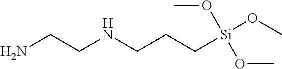

was added into the above solution at 2.2 g to 4.5 g (e.g., 8 mmol to 16 mmol, e.g., a silica particle to amine material molar ratio in a range from 5:1 to 10:1). Bis[3-(trimethoxysilyl)propyl]amine) was added into the above solution at 0.68 g (e.g., 2 mmol, a silica particle to bisamine material ratio of 40:1), according to the method of Example 5. The mixture was heated and stirred at 60° C. or above (e.g., up to 90° C.). The temperature depends on the chosen solvent. The mixture was stirred for 18 hours. The mixture was cooled to room temperature. The functionalized silica particles were filtered from the solvent and washed twice while stirring with a 40 mL volume of solvent each time. The functionalized silica particles were dried in a vacuum oven at 50° C. for 12 hours.

### Example 1.3—Experimental Results

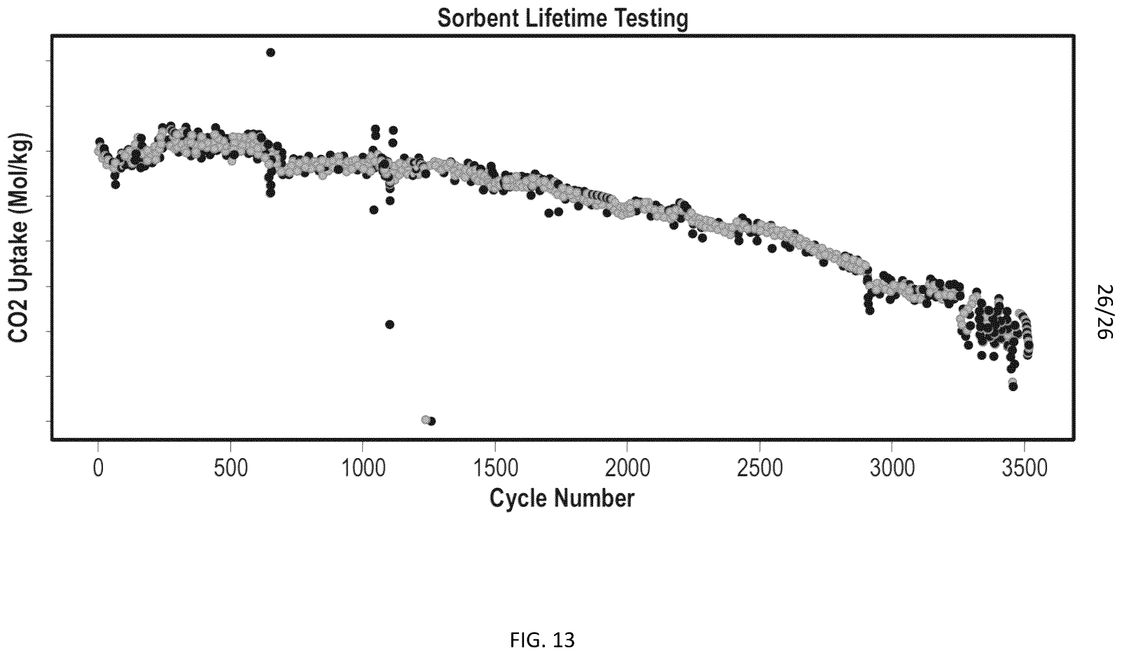

Functionalized silica produced using the processes described herein (e.g., in FIG. 3) was characterized by a CO₂ uptake measurement (e.g., using a sample holder as illustrated in FIGS. 10A-B). FIG. 13 is a line chart depicting CO₂ uptake in mol CO₂/kg (left y-axis) and against cycle number, e.g., the number of absorption and desorption cycles, (x-axis). The total CO₂ uptake of the functionalized silica sample during a single desorption is indicated.

### Example 2—CO₂ Uptake Measurements for Functionalized Material

Functionalized silica produced using the processes described herein (e.g., process 300 illustrated in FIG. 3) were characterized by a CO₂ uptake measurement. FIG. 10A schematically illustrates an exploded view (left) and an assembled view (right) of the sample holder 1000 for a sorbent. Functionalized silica particles or granules were placed in a sample space 1006 arranged between two layers of filter 1004 (e.g., such as glass wool) in a sample holder 1000. The sealing ends 1002 of the sample holder 1000 included an inlet 1008 and an outlet 1010 permissive to gas flow. The sealing ends 1002 included reversible screw connections to assemble the sample holder 1000. When assembled (right), the sample holder 1000 were otherwise sealed against gaseous inflow.

In FIG. 10B, a schematic diagram of the experimental setup 1020 is shown. Referring now to FIGS. 10A and 10B, a gas source, e.g., air compressor 1022, provided compressed environmental air to the inlet 1008 of a testing sample holder 1000, which was then passed through the filters 1004 and exposed the functionalized silica to environmental air. Optionally, air was exhausted from the outlet 1010. The concentration of CO₂ in the compressed environmental air was measured by a gas analyzer, e.g., CO₂ gas analyzers 1024 and 1026, prior to entering the inlet 1008 and/or subsequent to exiting the outlet 1010.

The samples of functionalized silica were treated with an activation process before data collection. Samples were heated in a vacuum drier (e.g., vacuum heater 1028) to 70° C. for 30 minutes under vacuum (e.g., 0.3 psi) to activate the adsorbent, e.g., as the activation process. Alternatively, and as shown in FIG. 10B, the heating element and the vacuum system 1030 were separate elements of the setup 1020 and worked in concert to heat and apply vacuum to the sample holder 1000. In some implementations, a cooling element 1032 was included in the setup 1020 to further control the temperature of the environment in the sample holder 1000. The activation process facilitated removal, e.g., evaporation, of residual solvent medium in the pores of the functionalized silica and facilitated desorption of CO₂ molecules bonded during a synthesis process (e.g., process 300) for venting to the atmosphere.

For the adsorption procedure, samples of functionalized silica in a range between 0.5 g and 10 g were placed in between two layers of glass fiber filters 1004 in the testing sample holder 1000. Compressed environmental air (e.g., input air) from gas source 1022 were continuously fed through the testing sample holder 1000 at a rate 1 to 10 standard liters per minute (slpm), thereby exposing the activated functionalized silica. The activated functionalized silica was exposed for time periods 30 to 60 minutes. The humidity of the input air was controlled to be 15% to 50% RH at 21° C. The same sample holder was then brought to vacuum by vacuum system 1030 and heated by vacuum heater 1028 to extract the carbon dioxide from the sample.

The amount of carbon dioxide extracted was measured by gas analyzer 1026. The humidity was controlled through blending of “dry air” and “wet air” with a flow meter (not shown). As an example, to produce input air having 50% RH at a flow rate of 5 slpm, dry air (e.g., <10% RH) at 2.5 slpm and wet air (e.g., >95% RH, 100% RH) was blended at 2.5 slpm each. The dry air and wet air flow control was performed using a closed loop controller.

The compressed environmental air including CO₂ concentration was monitored by gas analyzers 1024 and 1026 at the input and output of the testing sample holder 1000 during the experimental time period in units of mol CO₂/kg of adsorbent.

### Example 3—Example Functionalization Mixture (Second Reagent and Third Reagent)

In one non-limiting embodiment, creating the plurality of functionalized particles includes introducing a second reagent including the polymeric amine (e.g., polyamine) polyethyleneimine (PEI) and a third reagent comprising the aminosilane aminopropyltrimethoxysilane (DAMO) having the structure:

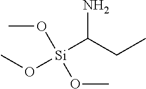

into a volume of the second solvent ethanol to form the functionalization mixture, according to the method of Example 5. A total of 45 g of aminopropyltrimethoxysilane (DAMO) and 10 g of polyethyleneimine PEI were charged into a 200 mL beaker and stirred till a homogenous mixture was obtained. 190 mL ethanol was charged into the DAMO-PEI mixture and stirred till a homogeneous mixture was obtained. The PEI-DAMO-ethanol solution was decanted over 100 grams of porous silica particles in a 500 mL beaker. The beaker was placed in a vacuum oven at 80° C. and 50 mbar for 12 hours till a dry product (coated particles) was obtained.

### Example 4—Two-Step Procedure for Sorbent Formation

This example provides a method comprising forming a plurality of coated particles by introducing at least a portion of a plurality of porous particles and a first reagent comprising a polymer to a solvent, according to the method of Example 5. The method further comprises forming a plurality of functionalized coated particles by introducing a second reagent comprising a polymeric amine and a third reagent comprising a silane-functionalized amine or an amino-functionalized silane (aminosilane) to at least a portion of the plurality of coated particles.

In this example the plurality of porous particles were silica particles. In this example the polymer in the first reagent is 13K-23K MW polyvinylalcohol (PVA). In this example the polymeric amine of the second reagent is the polyamine poly(ethyleneimine) (PEI). In this example the silane-functionalized amine or the amino-functionalized silane (aminosilane) of the third reagent is the aminosilane aminopropyltrimethoxysilane (DAMO). In this example the plurality of functionalized coated particles is formed in the presence of a crosslinker that is incorporated into the plurality of functionalized coated particles, where the crosslinker is the dialdehyde terephthalaldehyde (TALD).

Step 1 for a 100 g batch of coated particles.

### Formation of First Reagent.

Slowly, 15 g of 13-23K Mw PVA was charged into 60 mL of rapidly stirring cold water in a 500 mL flask with a condenser. The mixture was heated to 70-80° C. and stirred until a homogeneous solution was obtained, approximately 30 minutes. The solution was cooled to 60-70° C. under constant stirring. Slowly, 140 mL of hot ethanol (−60° C.) was charged into the flask and mixed thoroughly until a uniform solution was obtained. 1.67 g of 60% etidronic acid (ETDA) solution was charged into the warm solution (50-60° C.) and mixed thoroughly until a uniform solution was obtained.

### Forming a Plurality of Coated Particles by Introducing a Plurality of Porous Particles to a First Reagent Comprising a Polymer.

The warm PVA-ethanol-water solution was decanted over 100 g of silica in a 1 L rotary evaporation flask with mixing. The flask was placed on the rotary evaporator and set to 20 rotations per minute (rpm) until the mixture was observed to be homogenous with no dry particles. Once a uniform mixture was obtained the rotary evaporator was set to 70° C., 50 mbar, and 10 rpm. The mixture was dried until the sorbent (plurality of coated particles) contained 20-30 wt % volatiles as measured by a Mettler Toledo Halogen Moisture Analyzer HE73.

Step 2 for a 100 g (starting silica) batch.

### the Plurality of Coated Particles.

The PVA-coated silica product from the first step (141 g) was left in the 1 L rotary evaporator flask.

### Form the Second and Third Reagent.

10 g of the polyamine poly(ethyleneimine) (PEI) (second reagent and 45 g of the aminosilane aminopropyltrimethoxysilane (DAMO) (third reagent) was charged into a 500 mL beaker followed by 10 mL isopropyl alcohol (IPA). The PEI, DAMO, and IPA were mixed until a uniform DAMO-PEI-IPA solution was obtained.

1.1 g of the crosslinker terephthalaldehyde (TALD), having the chemical structure:

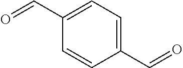

was charged into a 250 mL beaker followed by 141 mL of hexane and 19 mL of IPA. 1 g Chimassorb 944 FDL (C944) (Poly[[6-[(1,1,3,3-tetramethylbutyl)amino]-1,3,5-triazine-2,4-diyl][imino(2,2,6,6-tetramethyl-4-piperidinyl)]-1,6-hexanediylimino(2,2,6,6-tetramethyl-4-piperidinyl)]]; BASF, Ludwigshafen am Rhein, 67056 Germany) was charged into the same 250 mL beaker and mixed until a uniform solution was obtained. TALD-C944-Hexane-IPA was warmed to 60° C. with mixing until a uniform solution was obtained.

The DAMO-PEI-IPA solution (second and third reagents) was warmed to 40° C. with mixing. The warm TALD-C944-hexane-IPA solution (crosslinker) was charged into the 500 mL beaker of DAMO-PEI-IPA. The temperature was maintained at 60° C. and mixed until a homogeneous solution was obtained.

Forming a Plurality of Functionalized Coated Particles by Introducing the Second Reagent Comprising the Polymeric Amine and the Third Reagent Comprising a Silane-Functionalized Amine or the Amino-Functionalized Silane (Aminosilane) to at Least a Portion of the Plurality of Coated Particles.

The warm PEI-DAMO-TALD-C944-Hexane-IPA solution was decanted over the 141 g of PVA-EDTA-coated silica product from step 1 (plurality of coated particles) in the 1 L rotary evaporation flask with mixing. The flask was placed on the rotary evaporator and spun at 20 rpm until the mixture was observed to be uniform. Once a uniform mixture was obtained, the rotary evaporator was set to 70° C., 50 mbar, and 10 rpm. The mixture was dried until the sorbent contained <5 wt % volatiles as measured by a Mettler Toledo Halogen Moisture Analyzer HE73.

In an embodiment, the polymer in the first reagent is 200K MW polyvinylalcohol (PVA). In an embodiment, the polymer in the first reagent is 30-50K MW polyvinylalcohol (PVA). In an embodiment, the polymer in the first reagent is 10K MW polyvinylalcohol (PVA). In an embodiment, the substrate particles were not introduced to the first reagent comprising the polymer.

### Example 5—Functionalized Porous Silica for Carbon Capture

A method in accordance with the present disclosure was performed to generate a plurality of functionalized particles.

### Plurality of Porous Particles.

About 650 kg of silica (porous silica particles) was loaded into a 200 ft² double cone dryer. The dryer was jacketed and equipped with a circulating heated oil system.

### Preparation of a Coating Mixture and Formation of Coated Particles.

A coating mixture (e.g., coating liquid) was prepared. About 97.5 kg of polyvinyl alcohol (PVA) was dissolved in 380 kg of 80° C. water in a heated mix tank. About 718 kg of ethanol (at 60° C.) was slowly added to the PVA solution. Then, about 11 kg of 60% etidronic acid (ETDA) solution was added to the hot mixture (having a temperature of about 60° C. to 70° C.).

The homogeneous solution including PVA and ETDA was then sprayed over the silica for approximately 1 hr while the double cone spun at a rate of about 2 rpm. The oil jacket was set to about 180° C., and the coated wet silica was tumbled at a rate of about 1.25 rpm under a vacuum of 1.5-2 psi absolute for about 8-10 hours (hr).

The coated silica was then dried until it reaches about 20-30% volatiles (mostly water). During the drying process, the sorbent temperature was optionally controlled to below 90° C. The pressure was optionally controlled to 2 psi or less. Optionally, the drying process was under a flow of inert gas (e.g., a nitrogen gas flow). The drying process was less than 12 hrs to reduce total attrition.

### Preparation of a Functionalized Mixture Comprising at Least One Volatile Solvent.

The functionalization mixture including one or more reagents was prepared, where the one or more reagents included a first reagent comprising at least one adsorbing moiety (e.g., an aminosilane or a polyamine), a second reagent comprising at least one interaction moiety (e.g., an aminosilane or a silane), a third reagent comprising a polymer, a crosslinking agent, a chelating agent, an antioxidant, or a combination of any of these.

A functionalization mixture was prepared including about 65 kg of polyethylenimine (PEI), about 293 kg of N-[3-(trimethoxysilyl)propyl]ethylenediamine (N-3-TPE), and about 6.5 kg of Chimassorb 944 FDL (granular form of poly[[6-[(1,1,3,3-tetramethylbutyl) amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]], CAS Nos. 71878-19-8 and 70624-18-9) was dissolved in 393 kg of isopropanol, followed by 400 kg hexane.

### Introduction of the Functionalization Mixture to the Plurality of Porous Particles.

The functionalization mixture was sprayed over the partially dried, coated silica over about 1 hr while the double cone spun at a rate of 2 rpm. The oil jacket was optionally set to 120° C., and the mixture was tumbled at a rate of 1.25 rpm under a vacuum of 1.5-2 psi absolute for about 8 hrs. The sorbent was optionally dried until it reaches about 5% volatiles with <0.5% hexanes remaining. The dried product was then loaded out into 1 m³ supersacks.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of implementations have been described. Nevertheless, it will be understood that various modifications may be made without departing from the spirit and scope of the invention. Accordingly, other implementations are within the scope of the following claims.

1. A method comprising:
introducing a plurality of porous particles to a functionalization mixture comprising at least one volatile solvent, wherein:
the functionalization mixture comprises one or more reagents, wherein the one or more reagents is selected from the group consisting of: a first reagent comprising at least one adsorbing moiety, a second reagent comprising at least one interaction moiety, and a third reagent comprising one or more of a polymer, a crosslinking agent, a chelating agent, and an antioxidant,
the at least one adsorbing moiety comprises an amine moiety,
the at least one interaction moiety comprises a silane moiety, and
the plurality of porous particles is characterized by (i) a distribution of porosities and (ii) a distribution of diameters; and
creating a plurality of functionalized particles through deposition of the functionalization mixture on at least a portion of a surface of at least one porous particle in the plurality of porous particles to form a surface modification layer on the surface of the at least one porous particle in the plurality of porous particles.

2. The method of claim 1, wherein the at least one volatile solvent is an alcohol selected from the group consisting of methanol, ethanol, 1-propanol, isopropanol, 1-butanol, 2-butanol, isobutanol, and tert-butanol, or wherein the at least one volatile solvent is an alkane selected from the group consisting of n-butane, isobutane (methylpropane), n-pentane, cyclopentane, 2-methtylbutane, 2,2-dimethylpropane, n-hexane, cyclohexane, 2-methylpentane, 3-methylpentane, 2,3-dimethylbutane, 2,2-dimethylbutane, n-heptane, cyclopentane, 2-methylhexane, 3-methylhexane, 2,2-dimethylpentane, 2,3-dimethylpentane, 2,4-dimethylpentane, 3,3-dimethylpentane, 3-ethylpentane, 2,2,3-trimethylbutane, n-octane, cyclooctane, 2-methylheptane, 3-methylheptane, 4-methylheptane, 3-ethylhexane, 2,2-dimethylhexane, 2,3-dimethylhexane, 2,4-dimethylhexane, 2,5-dimethylhexane, 3,3-dimethylhexane, 3,4-dimethylhexane, 3-ethyl-2-methylpentane, 3-ethyl-3-methylpentane, 2,2,3-trimethylpentane, 2,2,4-trimethylpentane, 2,3,3-trimethylpentane, 2,3,4-trimethylpentane, and 2,2,3,3-tetramethylbutane.

3-5. (canceled)

6. The method of claim 1, wherein the at least one volatile solvent comprises a solvent mixture.

7. The method of claim 6, wherein the solvent mixture comprises at least one alcohol and at least one alkane.

8. The method of claim 6, wherein the solvent mixture is from about 10:1 to about 1:10 of a polar volatile solvent to a nonpolar volatile solvent.

9-10. (canceled)

11. The method of claim 1, wherein the one or more reagents is a plurality of reagents and the method further comprises:
preparing an initial solution comprising an initial reagent of the plurality of reagents and an initial volatile solvent of the at least one volatile solvent at a first time; and
introducing one or more additional reagents of the plurality of reagents to the initial solution, at a second time after the first time, to form the functionalization mixture.

12. The method of claim 1, wherein the one or more reagents is a plurality of reagents, the at least one volatile solvent is a plurality of volatile solvents and the method further comprises:
preparing an initial solution comprising an initial reagent of the plurality of reagents and an initial volatile solvent of the plurality of volatile solvents at a first time; and
introducing one or more additional reagents of the plurality of reagents and one or more additional volatile solvents of the plurality of volatile solvents to the initial solution, after the first time, to form the functionalization mixture.

13-16. (canceled)

17. The method of claim 1, wherein the introducing the plurality of porous particles to the functionalization mixture comprises spraying the functionalization mixture over the plurality of porous particles.

18. The method of claim 1, the method further comprising:
exposing the plurality of functionalized particles to an aqueous solvent thereby causing hydrolysis or condensation, or
drying the plurality of functionalized particles until a hydration threshold of less than 10% (wt/wt) of water to the plurality of functionalized particles is reached.

19. (canceled)

20. The method of claim 1, wherein the at least one adsorbing moiety comprises an aminosilane or a polyamine.

21-26. (canceled)

27. The method of claim 1, wherein the at least one interaction moiety comprises an aminosilane or a silane.

28-30. (canceled)

31. The method of claim 1, wherein the one or more reagents of the functionalization mixture comprises the polymer, wherein the polymer is poly(vinyl alcohol).

32.-44. (canceled)

45. The method of claim 1, wherein the one or more reagents of the functionalization mixture further comprises additive, a hydrophobic silane compound, or a hydrophobic polymer.

46. The method of claim 1, the method further comprising:
preparing an initial solution comprising an initial reagent of the one or more reagents and an initial volatile solvent of the at least one volatile solvent at a first time; and
introducing an additional aliquot of the initial reagent to the initial solution, at a second time after the first time, to form the functionalization mixture.

47. The method of claim 1, the method further comprising:
preparing an initial solution comprising an initial reagent of the one or more reagents and an initial volatile solvent of the at least one volatile solvent at a first time; and
introducing an additional aliquot of the initial reagent to the initial solution, at a second time after the first time, to form the functionalization mixture, and
introducing an additional aliquot of the initial volatile solvent to the initial solution, at the second time after the first time, to form the functionalization mixture.

48-59. (canceled)

60. The method of claim 1, further comprising using the plurality of functionalized particles to remove atmospheric CO₂ from air by direct air capture.

61. A functionalized material comprising:
a plurality of porous particles characterized by (i) a distribution of porosities, and (ii) a distribution of diameters; and
a surface modification layer disposed on at least a portion of a surface of the at least one porous particle, wherein:
the surface modification layer comprises at least one adsorbing moiety, at least one interaction moiety, a polymer, a crosslinking agent, a chelating agent, or an antioxidant,
the at least one adsorbing moiety comprises an amine moiety, and
the at least one interaction moiety comprises a silane moiety;
wherein the material adsorbs atmospheric CO₂ under a first condition and reversibly desorbs adsorbed CO₂ under a second condition, and
wherein the functionalized material has a methanol emission threshold of less than 0.5% (wt/wt) of methanol to the plurality of functionalized particles, or wherein the functionalized material has a hydration threshold of less than 10% (wt/wt) of water to the plurality of functionalized particles.

62. The method of claim 1, wherein the plurality of porous particles comprises a plurality of porous silica particles, a plurality of porous metal-organic framework (MOF) particles, a plurality of ion-exchange resin particles, a porous polymeric substrate, a porous ceramic and metal oxide together with porous silica, or porous alumina.

63.-76. (canceled)

77. The functionalized material of claim 61, wherein the functionalized material comprises 1% to 20% (wt/wt) of a polymer, 0.1% to 5% (wt/wt) of a chelating agent acid, 1% to 20% (wt/wt) of a polyamine, 20% to 80% (wt/wt) of an aminosilane, 0.1% to 5% (wt/wt) of a hindered amine light stabilizer compound, and 0.1% to 5% (wt/wt) of a crosslinking agent to the plurality of porous particles.

78.-79. (canceled)

80. The method of claim 1, wherein the distribution of porosities falls within a range of between 100 nanometers and 200 nanometers, the distribution of diameters falls within a range of between 0.8 millimeters and 3 millimeters, and the at least one adsorbing moiety comprises polyethylenimine.
